(19) United States
(12) Patent Application Publication
(10) Pub. No.: US 2019/0328170 A1
(43) Pub. Date: Oct. 31, 2019

(54) Device and method to deliver a fluid to make a single serve brew or treatment

(71) Applicant: Edward Z. Cai, Camas, WA (US)

(72) Inventor: Edward Z. Cai, Camas, WA (US)

(21) Appl. No.: 15/932,809

(22) Filed: Apr. 27, 2018

(51) Int. Cl. A47J 31/40; B65D 85/804; A23L 2/54; B01F 3/04; A47J 31/52

(52) U.S. Cl. CPC A47J 31/407; B65D 85/8046; A23L 2/54; A23V 2002/00; A47J 31/52; B01F 2003/049; B01F 2215/0022; B01F 3/04787

(57) ABSTRACT

A method and device for cold or hot brewing a beverage, soup, and meal using a pod containing corresponding brew material and serving the brew in a cup, bowl or directly in the pod. A brew catalyzer may be activated to catalyze the cold brewing to achieve a rich cold brew in a minute. A needle for piercing the pod may be provided with a shield for preventing injury to children and for sealing to the surface to be pierced. A holder may have an access opening movable up and down to accommodate differently sized/shaped pods and an energy emitter to cooperate with a hot fluid injected into an interior of the brew material via the needle to cook from both outside in and inside out. A bit group may be provided to determine a set of brewing conditions for the pod and allow customization and modification for the set of brewing conditions via Internet.

### FIELD OF THE INVENTION

The present invention relates generally to a device and method to deliver a fluid to make a single serve brew or treatment.

### BACKGROUND OF THE INVENTION

Consumers desire the convenience, speed and freshness of single serve drinks made to their liking. For coffee, such desires have been partially met by the devices taught by Favre in U.S. Pat. No. 4,136,202 commercialized under Nespresso®, by Sylvan et al in U.S. Pat. No. 5,325,765 under Keurig®, and by the present inventor in U.S. Pat. No. 6,840,158 and Knitel et al in U.S. Pat. No. 8,039,036 under Senseo®.

To minimize the harsh acrid taste of coffee caused by bitter oils and acids, Schwinger in U.S. Pat. No. 2,878,746, Leung et al in U.S. Pat. No. 7,231,142, Neace et al in U.S. Pat. No. 8,720,321 and Adam et al in U.S. Pat. No. 9,629,493 disclosed devices to extract coarse coffee grinds in cold water for 12 to 24 hours.

The slowness, however, has limited the popularity of cold brew. To speed up, Remo in U.S. Pat. No. 9,125,522 and Licare in U.S. Pat. No. 9,357,874 disclosed devices to cool hot coffee in a cooling device; Buchholz et al. in U.S. Pat. No. 8,635,944 disclosed a device to brew a concentrate and dilute the concentrate in a dispenser with cold water. Such devices are complex and the resulting coffee lacks some of the qualities of the cold brew resulting from direct interaction of cold water with ground coffee beans.

### SUMMARY OF THE INVENTION

Therefore, it is an object of the present invention to provide an improved device and method to brew a cold brew in about a minute without compromising the quality and strength of the cold brew.

A further object is to provide a portable device to quickly brew a cold brew using a car cigarette lighter.

A further object is to provide an improved device capable of brewing not only a hot brew but also a cold brew.

A further object is to provide an improved device and method capable of brewing a traditional drink such as coffee or tea, a non-traditional drink like soup or bubble tea containing chewables, as well as a meal such as oatmeal, spaghetti or sandwich using an eco-friendly pod.

A further object is to provide an improved device and method capable of using differently sized and shaped pods to brew drinks and meals without cross-contamination.

A further object is to provide a child-safe device to brew single serve drink or meal in a home or hotel room.

Finally, it is an objective of the present invention to provide an improved pod and method to allow local roasters, farmers or producers to quickly produce single serve pods with their perishable ingredients on demand, thereby preventing spoilage loss as well as allowing consumers to enjoy the freshest beverages, soups and meals manufactured locally. These and other objectives of the present invention will become better understood with reference to the appended claims and description.

### DESCRIPTION OF THE DRAWINGS

The accompanying drawing illustrates diagrammatically non-limitative embodiment of the invention, as follows:

FIG. 1 is a partially schematic diagram and partially sectional view of an apparatus for making cold and/or hot brews;

FIG. 1A is a partially schematic diagram and partially sectional view of the brew station of the apparatus of FIG. 1 right prior to brewing a cold brew with a cold brew coffee pod;

FIG. 1B is a sectional view of a prior-art pod during its brewing in a prior-art brewer;

FIG. 1C is a sectional view of the pod of FIGS. 1 and 1A during its brewing in a prior-art brewer;

FIG. 1D is a sectional view along a cross-section D-D of FIG. 1B omitting the brew material for simplicity;

FIG. 1E is a sectional view along a horizontal cross-section E-E of FIG. 1C omitting the brew material for simplicity;

FIG. F is a sectional view of the tandem pleating for the cup-shaped filter of the pod of FIG. 1;

FIG. 1G is a sectional view of the tandem pleating for the cup-shaped filter of the pod of FIG. 1 according to an alternative tandem pleating process;

FIG. 1Ga is a sectional view along a horizontal cross-section a-a of FIG. 1G showing a pod hinge;

FIG. 1H is a partially schematic diagram and partially sectional view of the brew station of the apparatus of FIG. 1 when brewing a tall cold brew coffee pod;

FIG. 1I is a sectional view of the pod for a drink such as soup, oatmeal, baby formula or Turkish coffee;

FIG. 1J is a partially schematic diagram and partially sectional view of the brew station of the apparatus of FIG. 1 when brewing the pod of FIG. 1I;

FIG. 1K is a sectional view of the tall pod for a drink such as soup, breakfast or baby formula;

FIG. 1L is a partially schematic diagram and partially sectional view of the brew station of the apparatus of FIG. 1 when brewing the tall pod of FIG. 1K;

FIG. 1M is a sectional view for the upper parts of the pod and holder of FIG. 1;

FIG. 1N is a sectional view of the pod holder along a cross-section N-N of FIG. 1M omitting the bottom and shield of the holder for simplicity;

FIG. 1O is a sectional view of the pod along a cross-section O-O of FIG. 1M omitting the coffee;

FIG. 1P is a partially schematic and partially sectional view of a cold brew espresso pod;

FIG. 1Q is a sectional view of only the holder along a cross-section Q-Q of FIG. 1;

FIG. 1R is a partially schematic and partially sectional view of the flow-deflecting needle or inlet of FIG. 1A showing the water streams during the brewing;

FIG. 1S is a sectional view of the flow-deflecting inlet along a cross section S-S of FIG. 1R;

FIG. 1T is a sectional view of the flow-deflecting inlet along a cross section T-T of FIG. 1S;

FIG. 1U is a partially schematic and partially sectional view of the needle of FIG. 1R having an imbedded filter;

FIG. 1V is a partially schematic and partially sectional view of an alternative to the needle of FIG. 1U;

FIG. 1W is a sectional view of the metering filter along a cross section W-W of FIG. 1;

FIG. 2 is a schematic diagram of the steps of using the apparatus of FIG. 1 to brew a cold brew;

FIG. 3 is a partially schematic diagram and partially sectional view for an improved version of the cold brew catalyzer of FIG. 1;

FIG. 3A is a sectional view of the catalyzer along a cross-section A-A of FIG. 3;

FIG. 4 is a partially schematic diagram and partially sectional view of an improved brew station of FIG. 1 with a bowl-shaped pod above the holder;

FIG. 4A is a sectional view of the holder along a cross-section A-A of FIG. 4;

FIG. 4B is a partially schematic diagram and partially sectional view of the improved brew station of FIG. 4 with the bowl-shaped pod inside the holder prior to brewing;

FIG. 4C is a sectional view of a reusable bowl-shaped pod for the holder of FIG. 4;

FIG. 4D is a partially schematic diagram and partially sectional view of the improved brew station of FIG. 4 with a tall large pod inside the holder prior to brewing;

FIG. 4E is a partially schematic diagram and partially sectional view of the improved brew station of FIG. 4 with a tall small hot or cold brew coffee pod inside the holder prior to brewing;

FIG. 4F is a partially schematic diagram and partially sectional view of the improved brew station of FIG. 4 with a short small hot or cold brew coffee pod inside the holder prior to brewing;

FIG. 4G is a partially schematic diagram and partially sectional view of the improved brew station of FIG. 4 with a tall pod having coffee filling station inside the holder prior to brewing;

FIG. 5 is a partially schematic diagram and partially sectional view of a first improved version for the apparatus of FIG. 1;

FIG. 5A is a partially schematic diagram and partially sectional view of the brew station of FIG. 5 when the brew cover is in its closed position;

FIG. 5B is a partially schematic diagram and partially sectional view of an alternative embodiment of the apparatus of FIG. 5;

FIG. 6 is a schematic diagram of a second improved version for the apparatus of FIG. 1;

FIG. 7 is a partially schematic diagram and partially sectional view of a third improved version for the apparatus of FIG. 1.

FIG. 7A is a partially schematic diagram and partially sectional view of the flow actuator for the air outlet of the heating tank of the system of FIG. 7.

### DESCRIPTION OF THE PREFERRED EMBODIMENTS

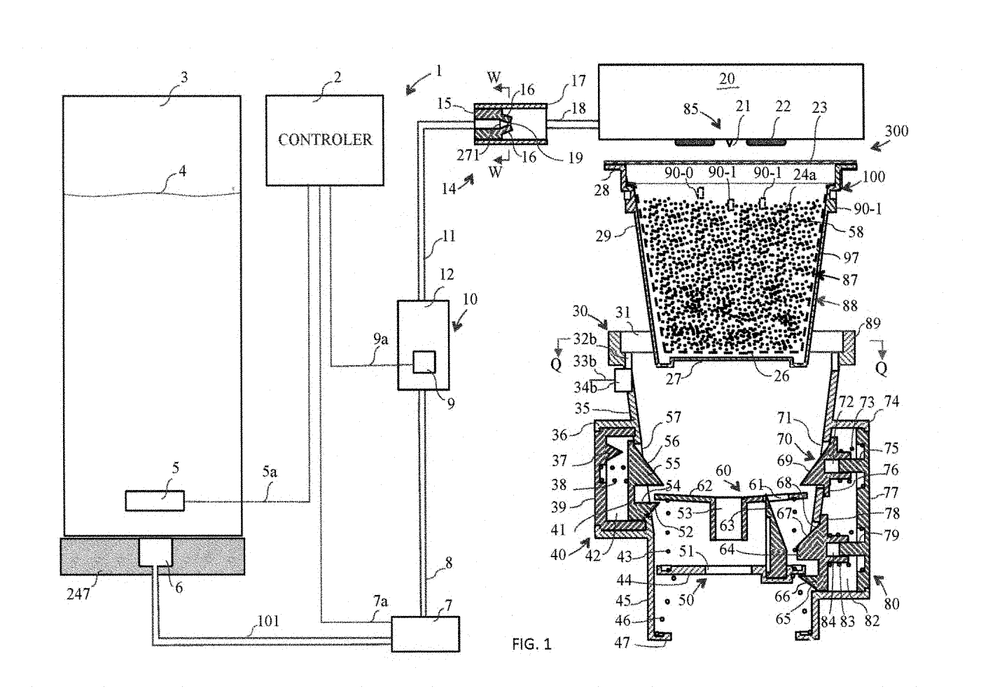

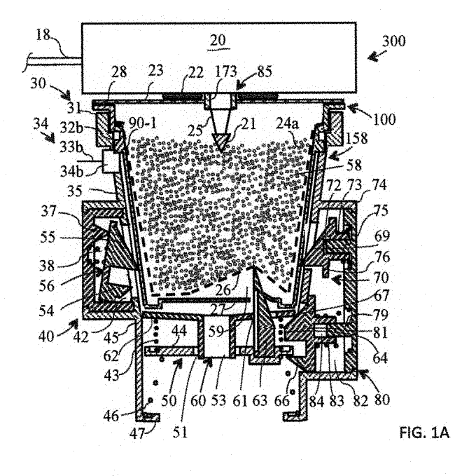

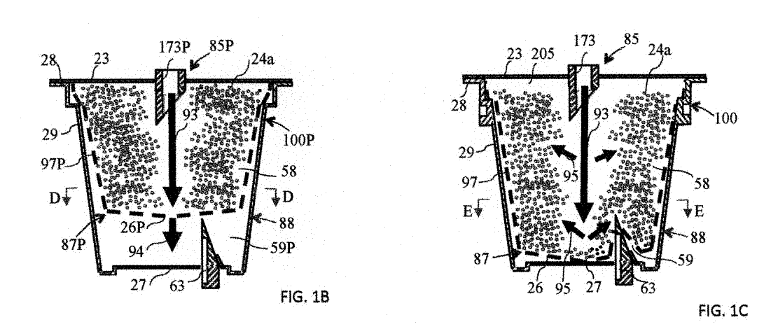

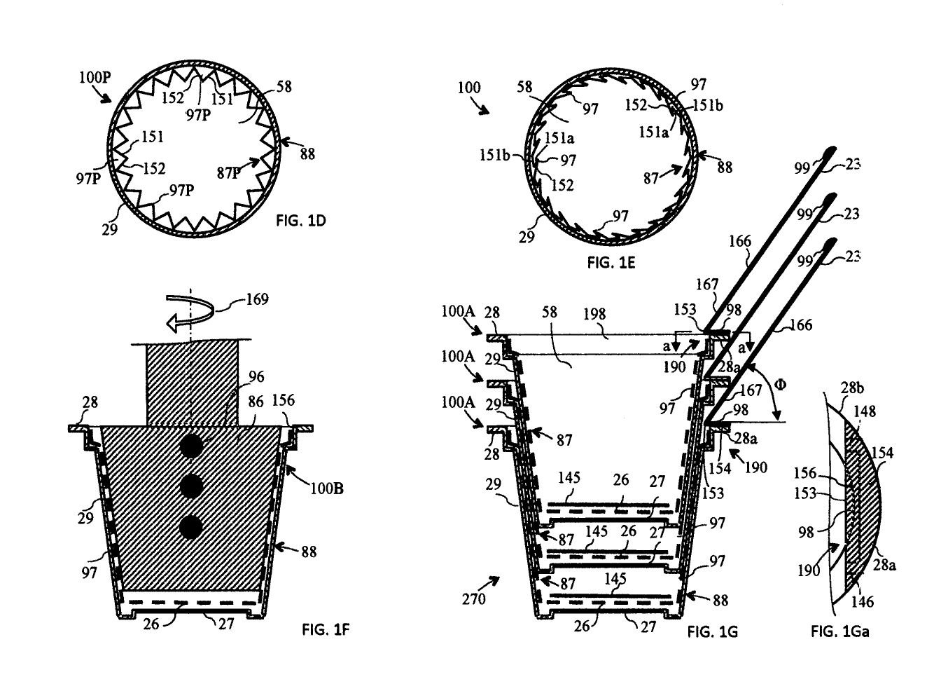

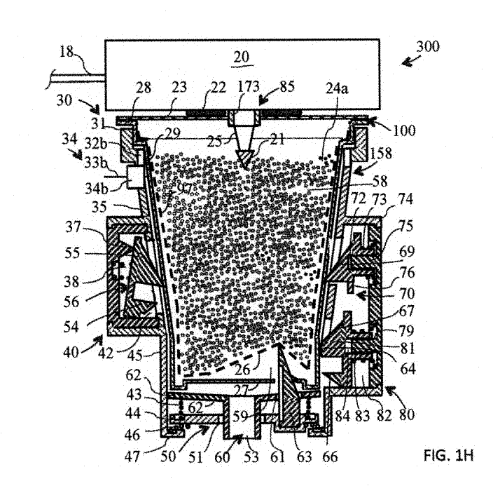

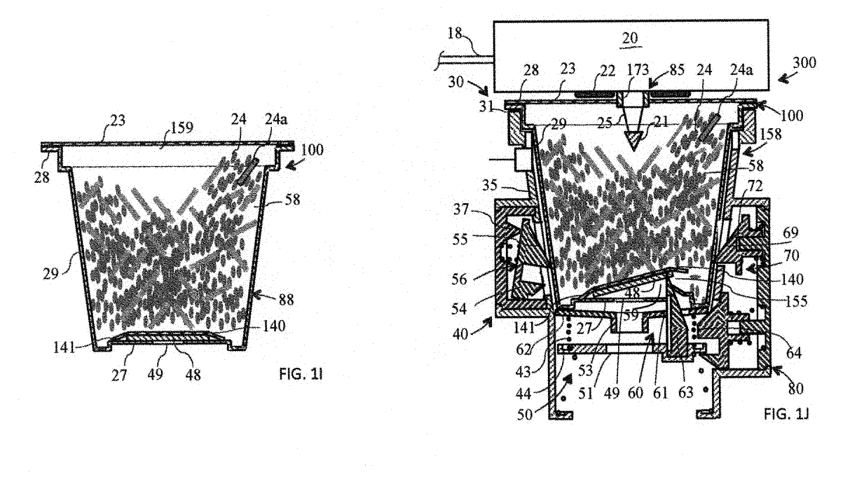

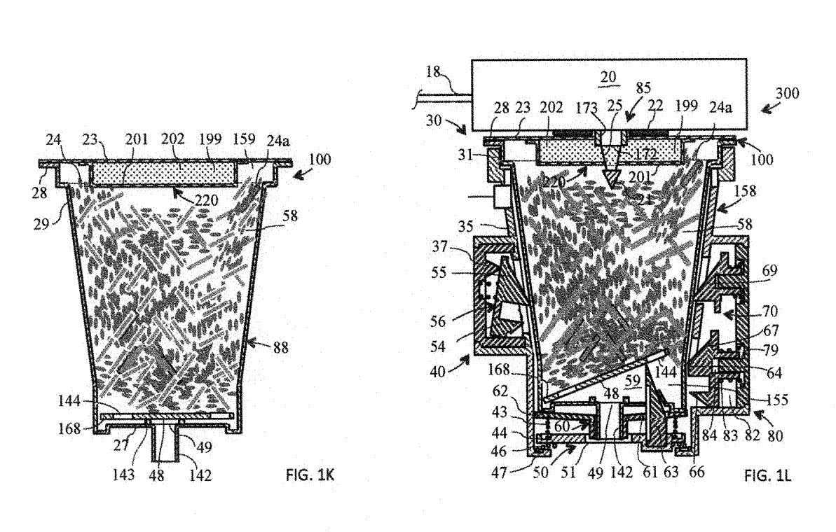

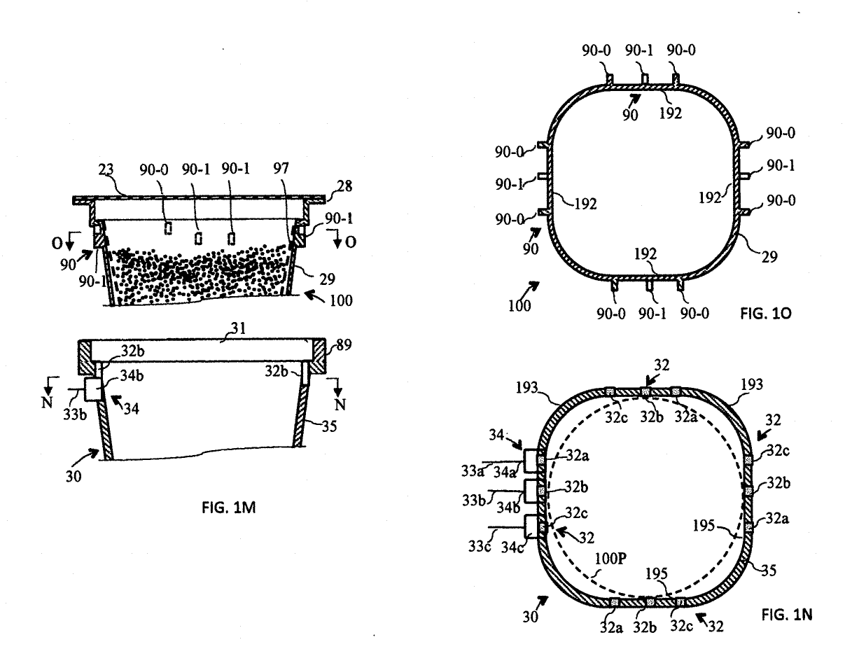

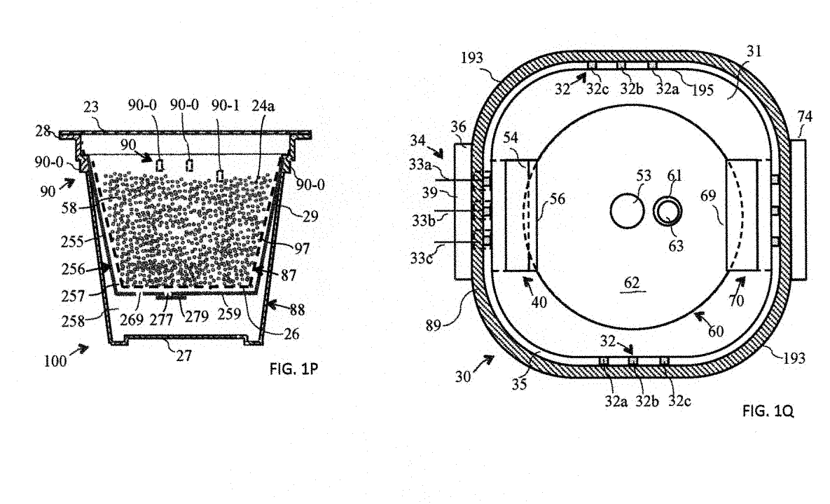

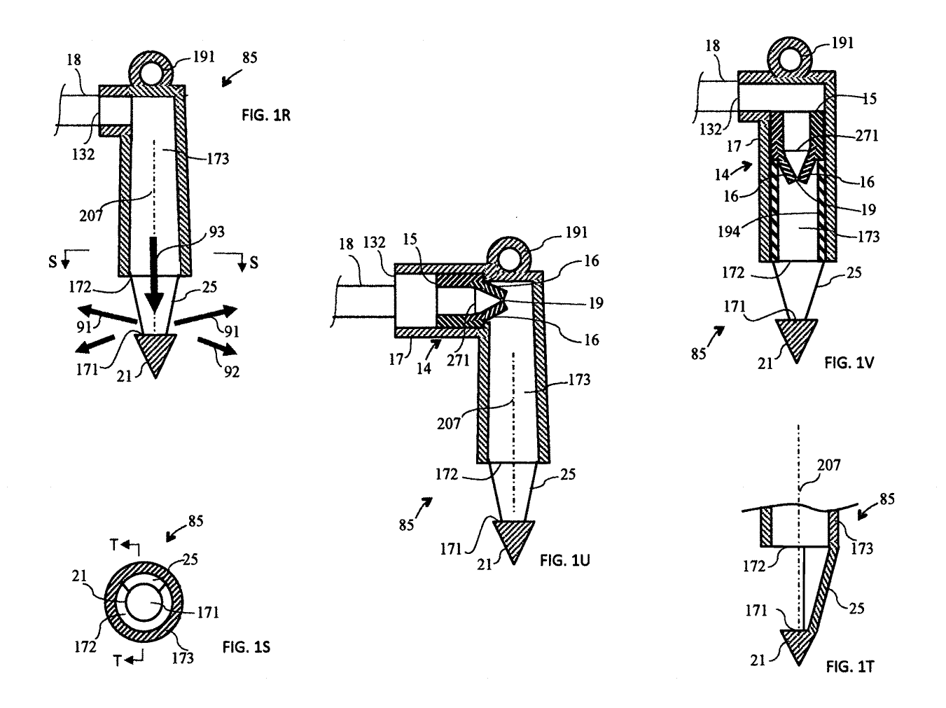

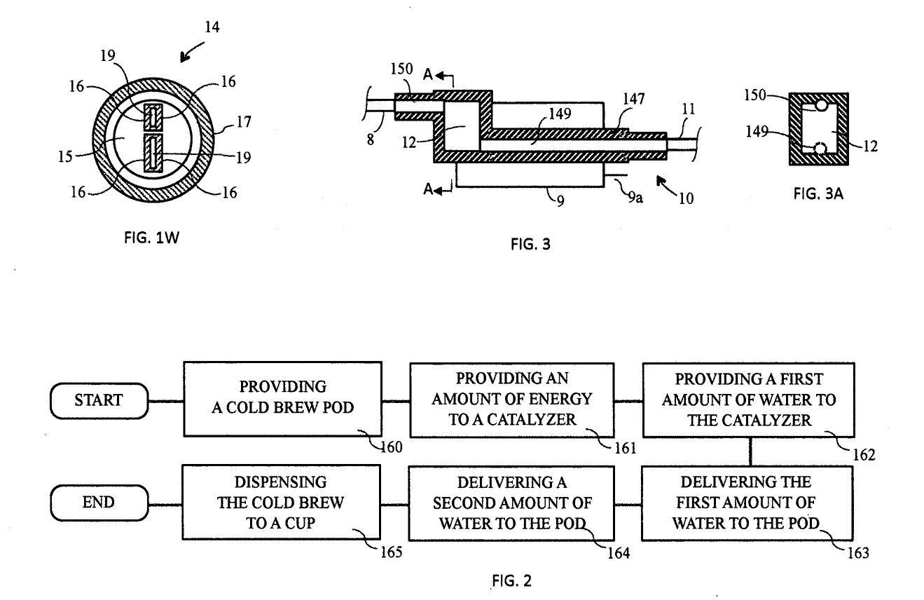

With reference to FIG. 1, an apparatus 1 in accordance with the present invention for brewing a single serve cold or hot brew comprises a water tank 3, a pump 7 connected to a controller 2 by wires 7a, a cold brew catalyzer 10, a self-refreshing metering filter 14, and a brew station 300 including a brew cover 20 and a holder 30. The water tank is adapted to hold a supply of cold water 4 and may be connected to a tap water system or refrigerator. The brew cover has a flow-deflecting needle or inlet 85 and a seal gasket or sealer 22 and is arranged to cooperate with the holder to form a pod chamber 158, as shown in FIGS. 1A, 1H, 1J and 1L, between the seal gasket and a movable bottom wall 44 of the holder to enclose a short or tall pod 100. Water is delivered from the water tank through a distribution chamber 6 formed in a support base 247, a tube 101, the brew catalyzer and metering filter to the pod 100 enclosed by the pod chamber.

The apparatus 1 is of the types described in U.S. Pat. Nos. 6,142,063, 9,149,149, 9,295,357, 8,720,321 and 9,629,493. Various improvements have been made to reduce the brewing time for cold brews from 12 hours with prior art cold brewers to a minute typical of single serve hot brewers. To brew a cold brew, cold water or a mix of ice and water is added into the water tank and introduced to the pod in its cold state. To brew a hot brew, the water in the tank is heated by a heater 5 connected to the controller by wires 5a and is introduced to the pod in its hot state. In all drawings, similar components are identified with the same reference numerals while modified or affiliated components are identified with the same reference numerals plus a suffix such as −1 or P.

The holder 30 has a rim 89 defining an opening 31 for engaging and receiving a pod 100, a sidewall 35, a bit receiver 32, a switch group 34, a shield 60, and a shared outlet 50 having an outlet needle 63. The shield prevents the outlet needle 63 from injuring children and comprises a shield plate 62 supported by a shield spring 43 over the shared outlet, a finger stopper 61 formed on the shield plate, and a dispenser 53 for dispensing the brew into a cup, jar or other receptacle. The finger stopper is a restrictive opening adapted to allow the outlet needle 63 to move in and out but prevent a child's finger from passing through. The shield is adapted to move between a safe, injury-prevention position in which the shield plate is above and covers the outlet needle (FIGS. 1 and 1Q) and a brewing position in which the outlet needle 63 is exposed to pierce the pod bottom 27 (FIGS. 1A, 1H and 1L).

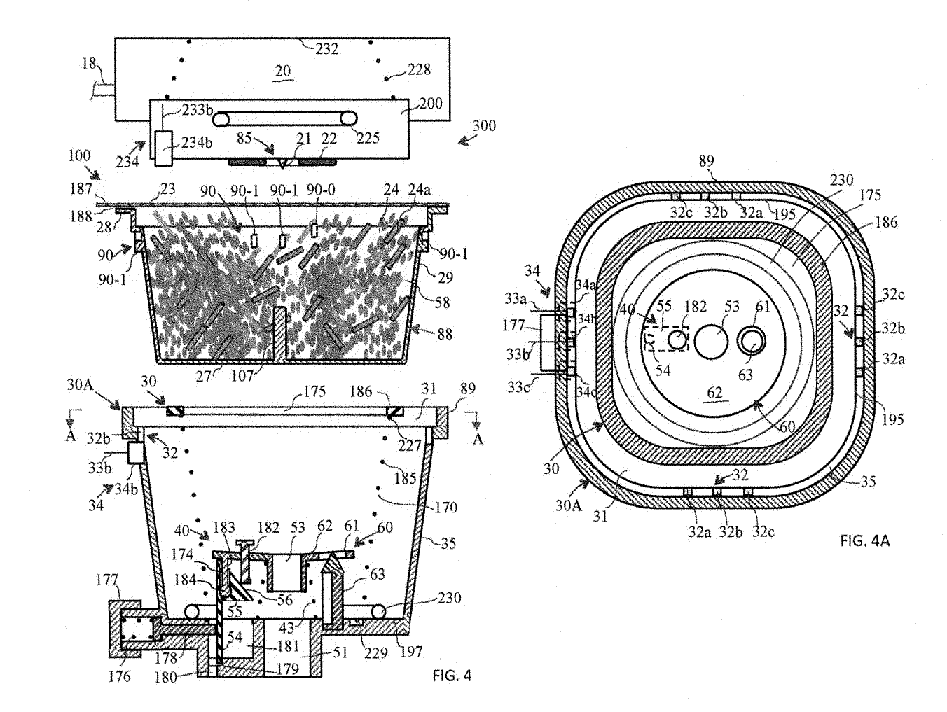

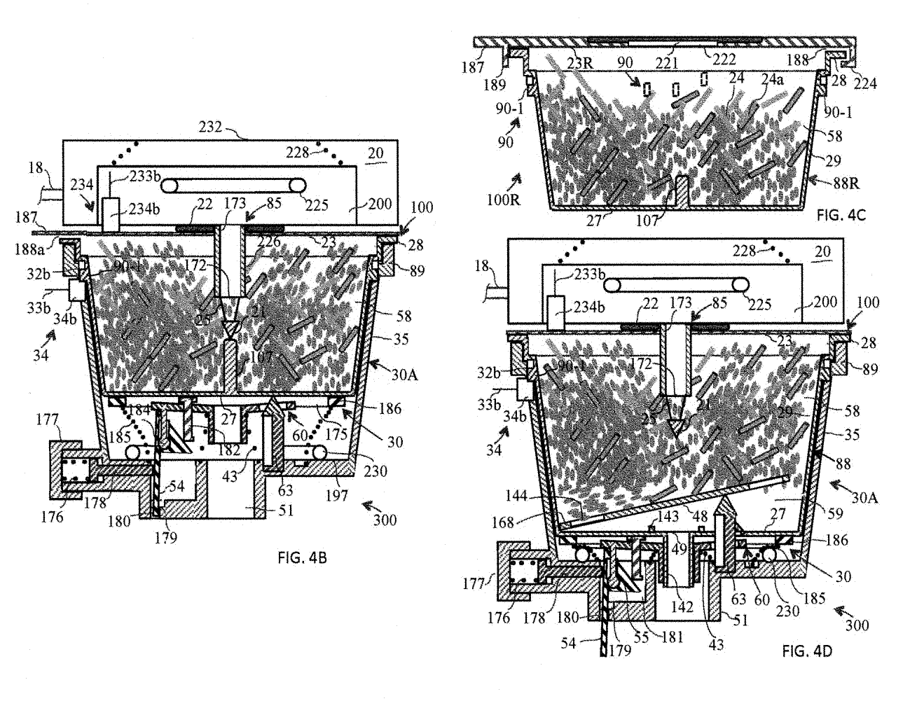

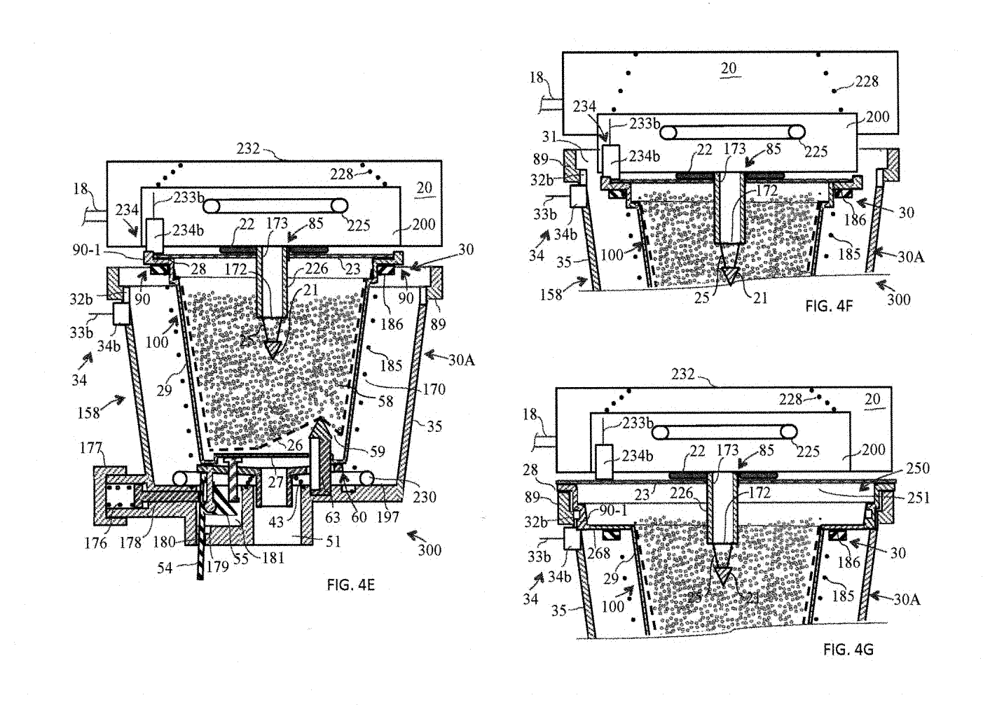

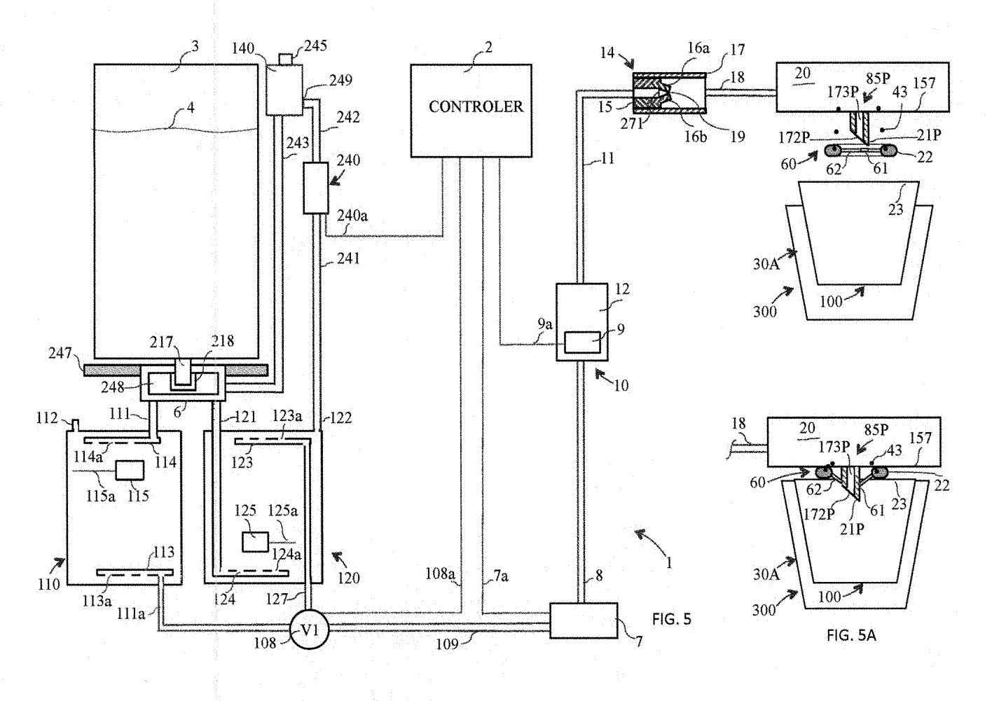

A self-healable film similar to that of FIG. 4C may be attached to the shield plate 62 to cover the finger stopper 61 to further protect children. The self-healable film is adapted to be pierced by the outlet needle and to self-heal and close the pierced opening after the needle moves out. The self-healable film also functions to seal around the needle to prevent the brew from flowing through the pierced opening, thereby causing all brew to be dispensed via the dispenser 53. Alternatively, the shield plate 62 may be a self-healable shield plate made from a self-healable material. After the first use of the holder 30 or shield 60, a substantially closed and expandable opening is formed on the self-healable plate. The substantially closed opening is the finger stopper and is expandable to allow the needle to pass through. It is appreciated that a shield similar to that of FIGS. 5 and 5A may be provided for the inlet needle 85 of the brew cover 20 to prevent injury to children.

A shield locker 40 and a pod centralizer 70 may be provided to prevent a child from compressing the shield spring 43 by hand and to center the pod. Alternatively, the shield spring may be made sufficiently strong to prevent a child from moving the shield plate. The locker comprises a latch 54 below the shield plate 62, a trigger 55 connected to the latch via a body 41 received in a chamber 42, an opening 57 on the sidewall 35 to receive the latch, and a spring 38 for pushing the latch out of the opening 57 to catch the shield plate 62, thereby preventing the shield plate from being pushed down by hand (FIGS. 1 and 1Q). The spring 38 is loaded between the body 41 and a wall 39, which is secured to the sidewall 35 by walls 36. A protrusion 37 on the wall 39 pivots the body 41 when the pod pushes the trigger (FIG. 1A). The left wall 39 and chamber 42 adapt a generally square shape when viewed from the left of the holder in FIG. 1. The pod centralizer 70 (FIGS. 1, 1A and 1Q) is located on the holder sidewall 35 opposing or farther away from the shield locker 40 for proper unlocking of the shield locker and releasing of the shield. It has a downwardly sloped surface 69, an opening 71 on sidewall 35, a spring 73 for pushing the sloped surface 69 through the opening 71 and a stop wall 76 for keeping the sloped surface at a predetermined position prior to pod insertion.

A beam 75 is received in a hole 72 of the pod centralizer to guide the movement of the sloped surface 69 in the opening 71. The beam 75 is formed on a wall 77 secured to the sidewall 35 by walls 74. When a pod 100 is provided into the holder, the sloped surface 69 directs the pod towards the shield locker to cause the pod bottom to push the trigger 55 to cause the latch 54 to move away from the shield plate 62, thus unlocking and enabling the shield 60 to move downward. In the meantime, the trigger 55 and latch 54 are pushed into the chamber 42 and the pod centralizer 70 is pushed into a chamber 82 by the pod sidewall 29. As the pod bottom 27 pushes the shield plate 62 downward, the outlet needle 63 is moved out of the finger stopper 61 and pierces the pod bottom.

The shared outlet 50 enables the holder 30 to properly pierce both short and tall pods, as shown in FIGS. 1A, 1H, 1J and 1L, with one outlet needle 63, thereby preventing the use of additional outlet needle that is potentially hazardous to children in hotel rooms or families as taught in U.S. Pat. Nos. 9,149,149 and 9,295,357. The shared outlet comprises a base or bottom wall 44 movable up and down relative to the opening 31, outlet needle 63 connected to the bottom wall, an outlet spring 46 having an upper end connected to the movable bottom wall and a lower end connected to an inward bottom rim 47 of the holder, a brew outlet 51 formed on the bottom wall 44 for receiving the dispenser 53 of the shield 60, and an outlet locker 80 for locking the shared outlet in position. The outlet locker has a latch 66, an outlet trigger 64 connected to the latch, an opening 68 on the sidewall 35 for receiving the latch and trigger, a spring 83 for pushing the latch out of the opening 68 to catch the bottom wall, and a stop wall 78 for keeping the latch at a predetermined position to lock the bottom wall 44 (FIG. 1). A beam 79 on the wall 77 is received in a hole 84 to guide the movement of the latch and trigger in the opening 68. The bottom wall 44 is in its first position to form a short pod chamber 158 when no pod or a short pod is provided into the holder (FIGS. 1, 1A and 1J) and is moved to its second position to form a tall pod chamber when a tall pod is provided into the holder (FIG. 1H). The first position is locked in place by the outlet locker 80 and the second position is locked in place by the inward bottom rim 47 to ensure the piercing of the pod bottom 27 by the outlet needle 63. The distance between the first and second positions is about equal to the difference in height between the short and tall pods.

The pod 100 in FIG. 1 comprises an impermeable cup-shaped container 88 having a pod rim 28, impermeable pod sidewall 29 and impermeable pod bottom 27, an impermeable film lid 23 sealed to the pod rim, and a cup-shaped filter 87. The cup-shaped filter has a filter bottom 26 positioned sufficiently close to the pod bottom 27 to allow at least the center of the filter bottom to contact the pod bottom when water is introduced under pressure as a water stream 93 (FIG. 1C) to a supply of brew material 24a in a brew chamber 58 between the filter bottom 26 and film lid 23. In another word, the distance between the filter bottom and pod bottom is sufficiently small that the center of the filter bottom 26 can be pushed to contact the pod bottom 27 by a finger. The impermeable pod bottom 27 prevents the water stream 93 from channeling through the filter bottom and deflects the water stream 93 upwards as upward streams 95 back into the brew chamber 58 to extract the brew material therein, thus ensuing the full extraction of the brew material to provide a strong brew.

In comparison, the cup-shaped filter 87P in the pod 100P taught by Sylvan, Beaulieu et al in the U.S. Pat. Nos. 5,325,765, 5,840,189, 6,079,315, 6,182,554 and 9,295,357 has a filter bottom 26P that is sufficiently far above the pod bottom 27 to prevent the outlet needle 63 from contacting the filter (FIG. 1B). As a result, much of the water stream 93 channels through the brew chamber 58 and filter bottom 26P as a stream 94 into an extract chamber 59P and out of the outlet needle 63 without fully contacting or extracting the materials 24. Such channeling of the water stream 93 is at least partly responsible for the weak coffee brewed from the prior-art pods. When 8 ounces are brewed from the prior-art pods under Green Mountain® and RealCup® brands in Keurig® brewer models 250 and 575, the hot coffee has typical strength of 0.6 to 0.9% in total dissolved solids (TDS) measured by a VST LAB Coffee III Refractometer.

When 8 ounces are brewed from the cold brew coffee pods 100, which are of the same size as the prior-art pod 100P, in the apparatus 1 of the present invention, the cold brewed coffee has a typical strength of 1.1 to 1.3% in TDS measured by the same VST Refractometer. When 8 ounces are brewed from the hot brew coffee pods 100 in the apparatus 1 and Keurig® brewers, the hot coffee has a typical strength of 1.2 to 1.7% in TDS. Such different strengths of the coffee brewed from the prior-art pods and the pod 100 are expected in light of the channeling discussion above. It is worth mentioning that both the cold and hot brews from the cold and hot brew coffee pods 100 have strength similar to the coffee in premium coffee shops, and meet Golden Cup Standard, which has strength of 1.15 to 1.35% in TDS, according to the Specialty Coffee Association.

The major difference between the pod 100 and prior-art pod 100P is a transient chamber 59. The pod 100P taught by Sylvan, Beaulieu et al has an extract chamber 59P sufficiently tall or large to prevent the outlet needle 63 from contacting the filter bottom 26P (FIG. 1B). In contrast, the pod 100 of FIG. 1 has an extract chamber sufficiently small to allow the outlet needle to contact the filter bottom 26 after the outlet needle 63 pierces the pod bottom 27.

The transient chamber 59 is formed when the outlet needle pushes up a part of the filter bottom 26. FIG. 1A shows the transient chamber 59 right after it was formed but before water is introduced into the brew chamber 58. The transient chamber shrinks in size as the water is introduced into the brew chamber to brew the materials 24 (FIG. 1C). At the completion of brewing, the transient chamber may completely vanish, especially when the ground coffee is fine, e.g. has an average grind size of 100 to 400 micrometers.

A first issue with the transient chamber 59 is that the outlet needle 63 tends to pierce rather than pushes up the filter bottom 26, thereby preventing the transient chamber from being formed. To address the filter piercing issue, strong and piercing-resistant Nylon, polypropylene filter webs are used to form the cup-shaped filter 87. To further resolve the filter piercing issue, the filter fibers in the filter web are adapted to have sufficiently low coefficient of friction, preferably lower than 0.3, and most preferably lower than 0.2 when measured between the plastic and steel. It is believed that the low coefficient of friction allows the outlet needle 63 to slide easily below the filter bottom 26 when the needle contacts the filter bottom, thereby facilitating the pushing up of the filter bottom by the outlet needle to form the transient chamber.

A second issue with the transient chamber is the occasional leaking of grinds 24a from the brew chamber 58 into the transient chamber and the cup of coffee brewed from the pod, rendering the coffee unpleasant to drink. The cause for the second or grinds-leaking issue has not yet been understood. For the pods with the grinds-leaking issue, a pierced opening by the outlet needle 63 was noticed on the filter bottom 26 at the end of the brewing. However, such pierced opening on the filter bottom may not be the cause of the grinds-leaking issue. In fact, the coffee from vast majority of pods that had developed such pierced opening after the brewing was free of coffee grinds. When the coffee brewed from the pods was free of grinds, it was found that the pierced opening was actually positively correlated to the strength or TDS of the brew as measured by the VST LAB Coffee III Refractometer. In another word, the coffee brewed from the pods that had developed such pierced opening on the filter bottom was significantly richer than the coffee brewed from the pods that did not have such pierced opening. The probability for the grinds-leaking issue to occur seems to depend on the grind size, size distribution, nature and quantity of the materials 24, the temperature, pressure and volume of the brew, and the design and materials for the filter. The grinds-leaking issue may be mostly prevented by the use of coarse grinds in the pod, but coarse grinds result in incomplete extraction and weak coffee.

The grinds-leaking or second issue may be resolved by multiple tandem pleats 97 for the cup-shaped filter 87, as shown in FIGS. 1C and 1E. A tandem pleat is a double-pleated pleat formed on the filter sidewall by tandem pleating an elongated primary pleat 97P similar to that of the prior-art pod 100P of FIGS. 1B and 1D. Each primary pleat has first and second elongated primary pleat walls 151 and 152. When one of the elongated primary pleat walls, e.g. the primary pleat wall 151, is folded or pleated into two elongated tandem pleat walls 151a and 151b, an elongated tandem pleat 97 is formed. This tandem pleat 97 comprises one primary pleat wall 152 and two tandem pleat walls 151a and 151b. A tandem pleat wall has a length similar to that of the primary pleat wall but has only about half the width of the primary pleat wall. To produce a pod 100 with tandem pleats, a cup-shaped filter 87P with a filter bottom 26 and multiple elongated primary pleats 97P similar to those of the prior-art pod 100P (FIG. 1D) is first produced and placed into a cup-shaped container 88. The container has an impermeable bottom 27, an impermeable sidewall 29, a rim 28, and an access opening 198 surrounded by the rim for receiving the filter. The top end of the cup-shaped 87P filter is sealed to the top end of the sidewall 29 of the container. A tandem pleater 86, which adopts the shape of the container 88, is inserted into the cup-shaped filter with sufficient pleating force to pleat a primary pleat wall into two tandem pleat walls to form a tandem pleat 97, thereby forming a pre-assembled empty pod 100B (FIG. 1F). The clockwise rotation of the tandem pleater 86, shown by an arrow 169, causes the first primary pleat walls 151 to be preferably folded or pleated into first and second tandem pleats 151a and 151b. The horizontal cross-section of the pre-assembled empty pod 100B is the same as that of FIG. 1E of the pod 100. The tandem pleater 86 is heated to a predetermined temperature by a heater 96 to cause the primary pleat wall 152 and tandem pleat walls 151a and 151b to partially cling or adhere to each other to prevent the tandem-pleats from de-pleating.

A lid 23 is partially pre-attached to the rim 28 of the pre-assembled empty pod 100B to produce a pre-assembled empty pod 100A shown in FIG. 1G. The lid is impermeable and comprises first, second and third lid portions 98, 167 and 166, respectively. The lid is sized to cover the access opening 198 and further has a sealant 99 adapted to heat seal to the rim 28 to form an impermeable brew chamber 58 for storing and preserving a supply of brew material. The third lid portion 166 is pierceable to receive an injection of fluid into the brew chamber and the filter 87 controls the flow and interaction of the fluid and brew material to form a brew. The rim 28 comprises first and second rim portions 28a and 28b, shown in FIG. 1Ga. The pre-assembled empty pod 100A further comprises a pod hinge 190 for connecting the impermeable lid 23 to the container 88. The pod hinge cooperates with the rim and impermeable lid to prevent leakage of air and fluid through the brew chamber during the storage of the brew material and during the injection of the fluid into the container. The pod hinge comprises the first lid portion, the first rim portion, and an elongated fold 153 formed between the first and second lid portions 98 and 167. The first lid portion 98 is partially sealed to the first rim portion 28a by a heat seal 154 between the dotted lines and the outer perimeter of the first rim portion. The elongated fold 153 is preferably positioned and formed between first and second ends 146 and 148 of the heat seal 154. To prevent any air or fluid leakage between the rim 28 and lid 23 during the storage or brewing of the brew material in the brew chamber 58 of a pod formed from the pre-assembled empty pod 100A, the first and second ends 146 and 148 of the heat seal are substantially narrower than the width of the rim 28 as shown in FIG. 1Ga.

To facilitate the filling operation of an empty pod, a plurality of pre-assembled empty pods 100A are stacked into one another in a stack 270 as shown in FIG. 1G. The access opening 198 is larger than the impermeable bottom 27 to allow the cup-shaped filter 87 to receive part of another pre-assembled empty pod. To prevent damage to the pod hinge 190 and the leakage of air and fluid during the storage or brewing of the brew material in the brew chamber 58 of a pod formed from a pre-assembled empty pod 100A, the elongated fold 153 is sufficiently short so that the distance between the middle of the elongated fold and the inner perimeter 156 of the access opening 198 at the radial or horizontal direction is smaller than fifteen percent, preferably smaller than 7 percent, of the diameter or maximum span for the access opening. For example, when the diameter of the access opening is 45 mm, the fold-to-inner perimeter distance should be smaller than 6.75 mm, preferably smaller than 3 mm. Also to prevent the leakage of air and fluid during the storage or brewing of the brew material in the brew chamber 58 of a pod formed from a pre-assembled empty pod 100A, the elongated fold 153 is so constructed that there is a sufficiently rounded transition between the first and second lid portions 98 and 167. The radius for the rounded transition is larger than 0.15 mm, preferably larger than 0.3 mm. The angle D between the first and second lid portions is smaller 90 degrees. The third lid portion 166 may be sufficiently flexible to bend towards and partially wrap the rims 28 of the pre-assembled empty pods 100A in the stack 270, thereby making the angle between the first and third lid portions 98 and 166 larger than the angle between the first and second lid portions 98 and 167. Besides saving transportation and storage space, such partial wrapping of the third lid portions 166 around the rims 26 in the stack facilitates the closing of the impermeable lid 23 and improves the seal between the impermeable lid 23 and rim 28 for the pod formed from the pre-assembled empty pod 100A.

The stack of pre-assembled empty pod 100A with tandem pleats 97 may also be produced by—1) Forming a pre-assembled empty pod with just primary pleats 97P by sealing the top end of a cup-shaped filter 87P to the top end of the sidewall 29 of a cup-shaped container 88 and partially pre-attaching a lid 23 to the rim 28 of the container as described above, 2) Stacking a plurality of such pre-assembled empty pods with just the primary pleats into one another to form a stack in a way similar to that of FIG. 1G, and 3) Applying a sufficiently large pleating force to the top pre-assembled empty pod in the stack to cause the primary pleat walls 151 or 152 of the primary pleats for all the pre-assembled empty pods below to be pleated into tandem pleat walls 151a and 151b or 152a and 152b, thereby forming the tandem pleats 97 for the pre-assembled empty pods. In this case, the cup-shaped container 88 of the pre-assembled pod functions as the tandem pleater 86 to pleat the primary pleat wall 151 into the tandem pleat walls 151a and 151b or the primary pleat wall 152 into the tandem pleat walls 152a and 152b. Without the rotation of the tandem pleater, the first and second primary pleat walls 151 and 152 have equal chance to be pleated into their respective tandem pleat walls. The tandem pleats 97 for a pre-assembled pod formed in this method tend to de-pleat after removal from the stack. It was found that such de-pleating could be prevented by keeping the stack in a container such as a cardboard box for at least 3 days in the stack form after the application of the sufficiently large force to the top pre-assembled empty pod in the stack. The step 3 above may be performed by inserting the tandem pleater 86 at the predetermined temperature with the sufficiently large force into the cup-shaped filter 87P of the top pre-assembled empty pod in the stack. After the removal of the tandem pleater from the stack, the stack is stored in a box to stabilize the tandem pleats for all the pre-assembled empty pods for at least 3 days before the stack is used in a filling operation.

Due to the complexity in forming, pleating and sealing the filter, it is difficult for a local roaster to offer pods with fresh beans roasted locally. As a result, consumers often have to drink coffee from pods manufactured 6 or 12 months ago by large firms. The stack of pre-assembled empty pods 100A makes it simple for local roasters to fill pods with fresh beans roasted locally. After removing a pre-assembled empty pod from the stack 270 and filling the pod with a predetermined amount of freshly roasted and ground beans via the access opening 198 by an automatic filler or manually, the second and third portions 167 and 166 of the lid are turned around the elongated fold 153 of the pod hinge 190 to cover the access opening by a closer such as rod or bar and sealed to the second portion 28b of the rim by a heat sealer. The filled pod may be located in a cavity on a conveyor so that the pod hinge 190 is about 0.5 to 10 mm, preferably 1 to 5 mm, below the closer and is adapted to see or reach the closer before the second and third portions 167 and 166 of the lid contacts the closer when the conveyor moves the filled pod towards the closer.

To facilitate recycling and be eco-friendly, the cup-shaped container 88, filter 87 and lid 23 are all made from #5 recyclable polypropylene. The sealant 99 of the lid is made from a polypropylene co-polymer or polypropylene having a softening temperature substantially lower, preferably at least 20 degrees Fahrenheit lower, than the polypropylene used in the rest of the lid. The sealant may be a film sufficiently thick, preferably thicker than 35 micrometers, laminated to the lid to achieve sufficient seal to the rim 28.

The grinds-leaking or second issue may also be resolved by a filter mate 145 located on the top of the filter bottom 26 (FIG. 1G). The filter mate was initially intended to increase the flow resistance to the water stream 93 from the inlet needle 85 through the filter bottom to reduce the channeling flow 94 shown in FIG. 1B. It was discovered that the filter mate prevented the filter bottom of the pod 100 and prior-art pod 100P from being pierced by the outlet needle 63 when the pods 100 and 100P were brewed in the apparatus 1 and Keurig® brewers. The filter mate 145 is located above the filter bottom 26 or 26P, which differs from the teachings by Beaulieu et al in U.S. Pat. No. 9,271,602 that taught a filter guard located below the filter bottom to prevent the filter from being pierced by an outlet needle. The filter mate may be a disc or sheet of impermeable film or permeable filter. To prevent loss, the filter mate may be attached to the filter bottom 26 partially to allow partial movement of the filter mate relative to the filter bottom.

The grinds-leaking issue may be further resolved by the use of a specially designed filter web for the cup-shaped filter 87. A first such specially designed filter web comprises fibers that are so loosely bound to each other that the binding force between fibers is low enough to allow the fibers to be partially pushed or pulled out of the filter 87 by the outlet needle 63 before the fibers are broken. A second such specially designed filter web is capable of being stretched more than 50%, preferably more than 75%, before the web is broken at the brewing temperature for the pods 100. It is noticed that such stretching prevent the outlet needle from breaking or cutting the fibers in the filter when the transient chamber is diminished or reduced in size during the brewing process to regulate the flow and interaction of the fluid and the brew material. A third such specially designed filter web is the melt-blown polypropylene webs or spunbond polypropylene nonwovens. The melt-blown and spunbond polypropylene nonwovens may also be combined in a structure like spunbond nonwoven/melt-blown nonwoven web/spunbond nonwoven web or melt-blown nonwovens/spunbond nonwovens. A final such specially designed filter web is a composite filter made from or comprising fine and coarse fibers. The diameter or cross section area for the coarse fibers is preferably at least twice as large as that for the fine fibers in the composite filter. By mixing the coarse and fine fibers in the same filter web, it is noticed that some of the fibers become very resistant to breaking or cutting by the needle and that the ends of a coarse fiber broken by the outlet needle 63 actually press against the needle very tightly to prevent the coffee grinds from passing through the broken coarse fiber.

Several of the above solutions may be incorporated into a pod 100 to ensure grinds-free brew. For example, the cup-shaped filter 87 may be made from a melt-blown polypropylene web, comprise loosely bound fibers that are capable of stretching at least 75% before breaking, and be tandem-pleated by stacking the pre-assembled empty pods into each other to form tandem pleats 97.

FIG. 1H shows a tall pod 100 in the holder 30. When the tall pod is provided into the holder, it interacts with the pod centralizer 70, shield 60 and outlet needle 63 and forms the transient chamber 59 in the same way as the standard or short pod 100 of FIGS. 1 and 1A. As the pod is inserted more into the holder and pushes the shield plate 62 down, the outlet needle pushes the filter bottom 26 upwards even more to expand the transient chamber. As the shield plate moves down, it pushes a sloped surface 67 of the trigger 64 and causes the trigger and latch 66 to move into chamber 82, thereby unlocking the movable bottom wall 44 of the shared outlet 50. This allows the compressed shield spring 43 to compress the spring 46 of the shared outlet 50 and move the movable bottom wall 44 and needle 63 downward. As a result, the transient chamber 59 contracts and then expands as the pod continues to be pushed down to its final position (FIG. 1H). During the brewing, the transient chamber 59 contracts or shrink significantly in size. At the end of the brewing, the transient chamber may become essentially vanished and disappeared like that in FIG. 1C. When the brew cover 20 is opened, the springs 43 and 46 push the movable bottom wall 44, shield plate 62 and the spent pod 100 upwards, causing the latch 66 to re-lock the movable bottom wall and the latch 54 to re-lock the shield plate. It is discovered that the tall pod 100 also works and forms the transient chamber 59 to regulate the interaction between the ground coffee 24a and water in the brew chamber 58 even if the pod bottom 27 and sidewall 29 are removed. In this case, the holder sidewall 35 becomes the sidewall 27 for the pod and shield plate 62 becomes the pod bottom 27 for the pod, i.e. part of the holder 30 becomes part of the pod 100.

FIG. 1I shows a short pod 100 that contains a supply of brew material, including soluble and insoluble brew materials 24 and 24a, required to brew a cup or bowl of soup, healthy drink or meal. It is more convenient and uses less packaging, thus more eco-friendly, than the soup pod taught by Estabrook et al in U.S. Pat. No. 8,834,948. The insoluble brew material 24a may be 1) Clam chowder, chicken dices, noodles, meats, vegetables, spices, garlic, seafood, seaweed or the like for soups, 2) Oatmeal, baby formula, cereals, grains or the like for breakfast or baby meals, and 3) Ground and cut vegetables, ground and cut fruits, chaga, super food, matcha, syrup, concentrates, jelly-forming materials, gel beans, Turkish coffee or the like for healthy drinks. The soluble brew material 24 may be as any material such as soluble sugar, salt and beverage powder that can be dissolved. The insoluble brew material 24a may be any material that cannot be dissolved completely and includes extractable materials such as tea and coffee grinds.

Certain nutrients such as vitamins have undesirable taste that can make soda, sparkling fruit juices, tea, coffee and other drinks taste bad if present in sufficient quantity. Such nutrients may be imbedded or infused in gel beans or beads 24a and the imbedded gel beads may be provided in baby formula, soda, sparkling juices, tea and coffee to prevent the undesirable taste from being sensed by one's tongue or nose. The nutrients or vitamin-imbedded gel beads may be made sufficiently small to prevent one from being able to chew the gel beads, thereby further minimizing the undesirable taste of such nutrients or vitamins. The gel beads may be positioned in the upper part of the brew chamber 58 and adapted to quickly expand in size by hot steam or water from the inlet needle 85. The expanded imbedded gel beads are then dispensed with a predetermined amount of baby formula, sparkling juice, tea, coffee or soda brewed in the brew chamber through an outlet opening 49, which is to be described below.

The pod 100 has a cup-shaped container 88 comprising an impermeable bottom 27, an impermeable sidewall 29 extending upwardly from the impermeable bottom, a rim 28 near the upper end of the impermeable sidewall, and an opening 159 surrounded and defined by the rim for receiving the soluble and insoluble brew material 24 and 24a. A impermeable, pierceable film lid 23 closes the opening 159 and is joined in a sealed relationship to the rim to cooperate with the container in forming an impermeable pod. An outlet opening 49 is pre-formed on the impermeable bottom 27 of the container for discharging the brew including the insoluble brew material 24a formed in the pod, and is sufficiently large to prevent clogging by the insoluble brew material. A regulator plate 48 is received in the container and positioned above the impermeable bottom to cover the outlet opening. A flexible impermeable film 140 is provided above the regulator plate and the perimeter area of the film is sealed or joined to the pod bottom 27 or sidewall 29 to form a perimeter seal or joint 141. The joint between the impermeable bottom and flexible film is breakable to allow at least part of the regulator plate to be pushed up relative to the outlet opening 49 and moved away from the bottom by the outlet needle 63, as shown in FIG. 1J.

The regulator plate 48 is movable relative to the outlet opening 49 between a first position, as shown in FIGS. 1I and 1K, in which it cooperates with the impermeable bottom 27, sidewall 29 and lid 23 in forming an impermeable brew chamber 58 to store and preserve the soluble and insoluble brew materials 24 and 24a, and a second position, shown in FIGS. 1J, 1L and 4D, in which it forms a transient chamber 59 above the pod bottom 27 and regulates or controls the flowing of the insoluble brew material 24a and the brew formed in the brew chamber 58 into the transient chamber when the liquid is introduced into the brew chamber via the inlet needle 85 to interact with the brew material 24 and 24a therein. The lid 23 is pierced by the inlet needle 85 and the bottom 27 is pierced by the outlet needle 63 in the same way as the pod 100 of FIG. 1. After piercing the bottom, the outlet needle pushes the regulator plate 48 upwards and causes part of the perimeter joint 141 to break. The regulator plate is sufficiently rigid to facilitate the breakage of the joint or seal 141. The unbroken part of the perimeter seal acts as a hinge for the regulator plate 48 to turn as the outlet needle pushes the regulator plate up to form a transient chamber 59 and a chamber inlet 155 sufficiently large to allow the insoluble brew material 24a to pass through. The regulator plate is sufficiently large to prevent premature discharging of the brew material in the brew chamber 58 prior to the brewing and to contact the outlet needle 63 that pierces the bottom 27 at any one of multiple locations on the bottom. The transient chamber is adapted to be sufficiently large to receive the insoluble brew material 24a from the brew chamber 58 via the chamber inlet 155. When the pod is removed from the holder at the end of the brewing, the regulator plate falls to the pod bottom 27 to close the outlet opening 49 and eliminate the transient chamber 59.

By controlling the size of the chamber inlet 155 and transient chamber 59, the regulator plate 48 regulates both how the brew and insoluble brew material 24a flow into the transient chamber 59 and how the brew material interact with the fluid from the inlet needle 85 in the brew chamber 58 for a particular given holder and pod size. The outlet opening 49 becomes the outlet for the transient chamber and discharges the brew and insoluble brew material 24a to the dispenser 53 or directly into a cup or receptacle. The outlet opening may have smaller size, e.g. 0.2 or 0.5 inches in diameter, when the brew material includes nutrient-imbedded gel beads, Turkish coffee, baby formula, matcha, syrup, juice concentrates, ground fruits or vegetable, or powder, but may have much larger size, e.g. 1 or 1.5 inches in diameter, when the brew material include large items such as meat balls, noodles, chicken cubes and vegetables to prevent clogging.

For extra large insoluble brew material, the outlet opening 49 may be larger than the regulator plate 48 and be covered and sealed by the impermeable flexible film 140 rather than the regulator plate. The regulator plate is permanently attached to the either side of the flexible film to allow the outlet needle 63 to directly push and move the regulator plate to its second position to form the transient chamber 59 without contacting or piercing the pod bottom 27. In this case, the regulator plate may be moved by a beam, a pin or any protruded body on the holder 30 that is capable of acting on and moving the regulator plate from the first to second position, thereby avoiding the use of a sharp needle that is hazardous to children.

It is appreciated that the impermeable film 140 may be heat-sealed to the lower surface of the bottom 27 to seal the outlet opening 49 and may be attached to the lower surface of the regulator plate 48 through the outlet opening to limit the movement of the regulator plate on the bottom. The flexible film directly below the outlet opening may be broken when the outlet needle 63 pushes the regulator plate away from the bottom 27. The flexible film 140 may also be adapted to be sufficiently weak to be broken by the pressure in the brew chamber to ensure the outlet opening 49 is not blocked by the film.

It is also appreciated that the outlet opening 49 may be formed on the lid 23, rather than on the bottom 27 of the container 88. In this case, the regulator plate 48 may be connected to the lid by a flexible film 140 in one of the ways described above or may be sealed directly to the lid by a heat or adhesive seal in a way similar to that of FIG. 1K. The outlet opening 49 and regulator plate 48 may be positioned or arranged to allow the inlet needle 85 to push the regulator plate away from the outlet opening to form a transient chamber 59 between the regulator plate and lid 23 when the inlet needle pierces the lid to introduce fluid into the brew chamber 58 to form a brew, thereby preventing the need for an outlet needle 63 and saving cost and risk associated with the outlet needle. Alternatively, the bottom 27 of the container 88 may be arranged to be pierced by the inlet needle 85 to introduce the fluid into the brew chamber 58 to form the brew and the lid 23 is arranged to be pierced by the outlet needle 63 to push the regulator plate to form the transient chamber. In another word, the pod 100 may be used in an upside-down way in the holder 30.

FIG. 1K shows a tall pod 100 containing soluble and insoluble brew materials 24 and 24a for brewing soup, breakfast oat meal, baby formula, spackling natural fruit juices, etc. An adhesive or heat seal 143 is formed around the outlet opening 49 between the regulator plate 48 and pod bottom 27. Regulating openings 144 may be formed on the regulator plate to facilitate the flowing of the insoluble brew materials 24a in the brew chamber 58 into the transient chamber 59 and to facilitate the discharging of the insoluble brew material through the outlet opening 49 into a bowl or cup below the holder. It was found that chunky or sticky brew material 24a tends to clog the chamber inlet 155 if the regulator opening 144 is not present, thereby making the regulating opening essential for these pods containing insoluble brew material 24a that is difficult to be discharged out of the pod. The regulating opening is at least 20%, preferably at least 50%, larger than the insoluble brew material and positioned at a location that is away from the outlet opening 49 and not reachable by the needle 63 after the needle pierced the pod bottom 27. A skirt or sidewall may be formed at the perimeter of the regulator plate to regulate the interaction of the brew material with the fluid from the needle 85.

A hygiene tube 142 is connected to the outlet opening 49 and receivable in the dispenser 53 to prevent the soup, baby formula, and other drinkables brewed in the brew chamber 58 from contacting the holder 30, thereby preventing the cross-contamination of the brewed baby formula and other drinkables by drinks like coffee and improving food safety. By dispensing the brew from the transient chamber 59 of the pod 100 directly into a receptacle such as a cup or bowl, the hygiene tube 142 also prevents the possibility of dispensing any spoiled brew left in the pod holder days ago into one's drink. It is appreciated that the hygiene tube may be added to other pods including soda, coffee or tea pods.

A pouch 220 is attached to the film lid 23 and adapted to be pierced by the inlet needle 85. The pouch comprises a barrier film 201 sealed to the film lid to form a pouch chamber 199 either below or above the film lid 23 for containing a second supply of brew material 202 such as oil, sauce, spice or other essentials for the brew material 24 and 24a. The pouch chamber 199 must be sufficiently thin to allow the cutter 21 of the inlet needle 85 to pierce both the film lid and barrier film 201 and the lower film of the pouch must be sufficiently away from a outlet port 172 of the needle 85, thereby allowing the materials 202 in the pouch chamber to be carried out by the water from the outlet port of the needle. To facilitate production, the periphery area of the barrier film 201 may be sealed to the rim 28 or sidewall 29, rather than to the film lid 23, to form a pouch chamber 199 in the upper part of the brew chamber 58 after the insoluble and/or soluble brew material is filled into the brew chamber. The second supply of brew material 202 is then filled into the pouch chamber 199. The pod is finally sealed around the rim by the lid film. The brew chamber of FIGS. 1I and 1K may be filled with a supply of a viscous liquid such as concentrates or syrup to brew a fruit beverage and soda. It is appreciated that a permeable filter, rather than a barrier film 201, may be sealed to the rim 28 or sidewall 29 to form a filter pouch chamber 199 and at least the center for the bottom of the filter is sufficiently deep to prevent the inlet needle from piercing the filter. A supply of extractable brew material such as ground coffee and cocoa beans may be placed into the filter pouch chamber and the pod is then covered and sealed by the lid film.

For viscous, oily, or other brew material 202 that are difficult to be carried out of the pouch chamber 199 by the water from the inlet needle 85, the pouch 200 may be attached to the upper surface of the film lid 23. Such positioning allows the brew cover 20 to squeeze the viscous brew material 202 out of the pouch chamber into the brew chamber 58 when the brew cover is lowered to the holder 30 to cause the inlet needle to pierce the pouch and the film lid. To enable the proper fabrication of such a pod, a supply of the viscous brew material 202 is first sealed between two sheets of barrier film 201 to form a pouch 220. The resulting pouch is then sealed or attached to the pod above the film lid 23.

For local farmers and small producers to fill and sell the pods of FIGS. 1I and 1K with fresh ingredients grown or produced locally, a stack of pre-assembled empty pods similar to that of FIG. 1G may be used. Each pre-assembled empty pod has a regulator plate 48 pre-sealed to the impermeable bottom 27 of a container 88 to cover the outlet opening 49 and a lid 23 partially pre-attached to the rim 28 in a way similar to that of FIG. 1G. Multiple such pre-assembled empty pods may be stacked into each other for easy filling operation and space-saving storage. When a local farmer or producer receives a purchase order or desires to sell a certain quantity of fresh juice or soup pods, he or she may quickly fill the desired quantity of pre-assembled empty pods with suitable brew material such as freshly ground fruits, vegetables or meat. Since the stacks of pre-assembled empty pods make the production of the pods so quick and easy, there is no need for the farmer or producers to keep any inventories for the various types of pods they sell. As a result, they may produce the fresh perishable vegetable, fruit and meat pods on demand, thereby not only preventing the spoilage loss but also delivering the freshest pods to consumers for brewing juices, soups and meals.

When the tall pod of FIG. 1K is provided into the pod holder 30, it interacts with the pod centralizer 70, shield 60, outlet needle 63 and shared outlet 50 to form a transient chamber 59 in a similar or same way as the pod 100 of FIG. 1J and the tall pod 100 of FIG. 1H. After piercing the pod bottom 27, the outlet needle pushes the regulator plate 48 upward and causes the seal 143 to be broken. As the needle 63 pierces and moves more into the pod, the regulator plate 48 turns upward around a distal edge 168 of the regulator plate and expands the transient chamber 59 (FIG. 1L). It is appreciated that as the regulator plate 48 turns upward, the distal edge 168 may move on the pod bottom until it is stopped by the pod sidewall 29. The regulator plate should be large enough to stay in contact with the outlet needle during the turning of the regulator plate around the distal edge. As the regulator plate moves, it may cause some brew material to fall into the transient chamber 59 through the regulating openings 144. As a result, the regulating opening should be positioned sufficiently away from the outlet opening 49 to prevent premature dispense of raw or un-brewed material 24 or 24a.

To facilitate the return of the shield 60 to its safe, injury-prevention position, the shield plate 62 may comprise a vertical peripheral wall having a height of 1 to 20 mm, preferably 2 to 10 mm, above and around at least part of its perimeter to receive the pod bottom 27, thus preventing the outlet locker 80 from contacting and trapping the lower end of the pod 100. The shield plate may also have a sufficiently small size or a recessed section near the outlet locker 80 to prevent the edge of the shield plate from contacting the outlet locker during the return of the shield 60 to its safety position. It is appreciated that the latch 54 may be moved away from the shield plate 62 by a trigger capable of being activated by the downward motion of the brew cover 20.

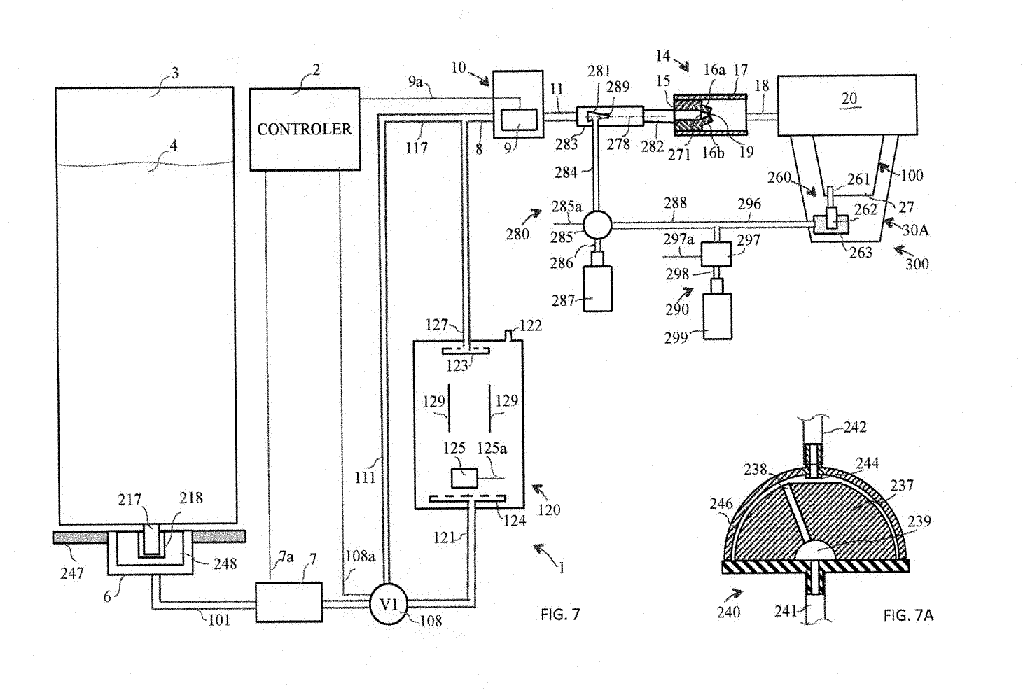

Different brewing conditions are required to properly brew different pods. Incorrect brewing conditions for beverage, baby formulae, soup, meal and dessert pods, which are to be brewed in the apparatus 1 of FIG. 7, could produce a brew, e.g. too hot or cold, to consume. The barcode, RFID or spectral systems taught in U.S. Pat. No. 9,320,385 and U.S. Pat. Publication No. 20170027374 may be used to meet this need partially. Such systems, however, require costly scanning and processing hardware that make the single serve brewers unaffordable by some consumers.

FIG. 1M shows the top parts of the cold brew coffee pod 100 and holder 30 of FIG. 1 to focus on a bit group 90, bit receiver 32 and bit group reader 34 that are essential for the proper brewing of the pod. In this exemplar embodiment, the bit group comprises three bits. Each bit may be in one of two states, e.g. “up” and “down” states. A bit in the “up” or “down” state is called an “up bit” or “down bit”, respectively. The up bit is an upper dot or upper protrusion 90-0 and the down bit is a lower dot or lower protrusion 90-1 formed on the sidewall 29 of the pod. The lower dot 90-1 is positioned lower than the upper dot 90-0 on the pod sidewall. The upper and lower dots may also be formed on the rim 28 or lid 23, as shown in FIG. 4E. The up bit may be given a digital value of “0” and the down bit a value of “1”. The bit group 90 is thus inherently compatible with the controller 2, which comprises a digital processor or CPU, to prevent the need for costly scanning and sensing hardware and make the apparatus 1 affordable to more consumers.

The bit group reader 34 may comprise a scanner or a plurality of object readers 34a, 34b and 34c. Each object reader is adapted to read one bit in the bit group and provide a value “1” or “0” for each bit depending on the state of the bit. To prevent complexity, the bit group reader may be a simple switch group comprising a plurality of mini or micro electrical switches 34a, 34b and 34c in the holder 30 (FIGS. 1M and 1N) or brew cover 20 (FIGS. 4 and 4E). Each particular bit in the bit group 90 for a particular pod 100 is designated to contact a particular switch in the switch group 34. When the pod is provided into the holder 30 and the brew cover 20 is closed, a down bit 90-1 in the bit group may be adapted to be sufficiently close to its designated switch to press or activate the switch and provide a value 1 to the controller 2 via wires 33a, 33b or 33c. An up bit 90-0 in the bit group may be adapted to be sufficiently far away from its designated switch to prevent it from pressing or activating the switch and provide a value 0 to the controller. The value and place from each of the bits in the bit group for the exemplar cold brew coffee pod of FIG. 1 is 011, which is called the switch states for the bit group and is associated with a predetermined set of brewing conditions stored in the controller 2.

The bit receiver 32 comprises bit openings 32a, 32b and 32c to distribute the bits in the bit group 90 to their pre-designated switches in the switch group 34, a bit surface 192 on the pod 100, and a counter-bit surface 195 on the holder sidewall 35 adapted to automatically turn the pod to find the best matching between the bit and counter-bit surfaces. Both the bit and counter-bit surfaces should be sufficiently large to facilitate the automatic turning and finding of the best matching between the two surfaces. The bit group 90 has a fixed, predetermined spatial relationship with the bit surface 192 to cause each bit in the bit group to find its pre-designated switch in the switch group 34 when the bit surface 192 finds its best matching position with the counter-bit surface 195 in the holder. To prevent any need to reposition the pod, one switch group 34 may be provided in the holder 30 and a plurality of identical bit groups may be formed on the pod (FIGS. 1M and 1O). Alternatively, a plurality of switch groups 34 may be provided on the holder and one bit group may be provided on the pod.

The bit group 90 on the cold brew coffee pod of FIG. 1 presses the switch group 34 on the holder 30 and provides the switch states of 011 to the controller 2 when the pod is provided into the holder and the cover 20 is closed (FIG. 1A). Similarly, the bit group for a short large meal pod of FIG. 4 or a tall large soup pod of FIG. 4D presses the switch group and provides the switch states of 110 or 010, respectively, to the controller. Each bit group or its switch states is associated with a set of brewing or cooking conditions, to be described in FIGS. 4 to 7. The conditions include the amount of catalyzing energy, the temperature of water or steam, pump time, and pump pressure. The pressure by the pump 7, which may be an electrical pump or any device capable of delivering a liquid, may be adjusted by adjusting the voltage or current applied to the pump. Hot and cold brew espresso pods, to be described in FIG. 1P, require higher pump pressure than other pods.

For the apparatus that are already installed in homes, offices or other locations, the bit group 90 allows one to add or upload a new set of brewing conditions for a new type of pods via Internet to the apparatus, which has predetermined empty space or slots in its controller 2, by entering the switch states for the bit group. This enables a consumer having an old apparatus 1 to enjoy new drinks and meals from new types of pods developed after they purchased the apparatus. The bit group also makes it possible to change the brewing conditions for an existing pod, e.g. coffee, soup or hamburger pod via Internet by entering the switch states. Therefore, in cold winter one may change the set of brewing conditions for one's coffee, soup or sandwich pods to the winter version so that a hotter cup of coffee, bowl of soup or sandwich is brewed. In hot summer, one may change the set of brewing conditions to the summer version to brew a cooler drink and meal. It is appreciated that the brewing conditions for an existing type of pods may be improved over time or may be customized for the customers in a particular city, state or country by the drink or meal manufacturers. To allow the customers with old apparatus 1 to enjoy such improvements or customization, the bit group or its switch states allows a customer to change the set of brewing conditions online or via Internet after the customer receives a notice for such improvement or customization. The notice may be sent online to a screen of the apparatus.

In addition to the 3-bit bit groups for the pod 100, a bit group 90 may have 4, 5, 6, or more or fewer bits. For example, the 5-bit bit group, i.e. the bit group having 5 bits, for the cold brew coffee pod may be expressed by three upper and two lower dots 90-0, 90-0, 90-0, 90-1 and 90-1 on the pod and has switch states of 00011. Besides being a dot or protrusion, the bit in the bit group 90 may also be a beam, opening, recess, spot, print or any other objects formed on the sidewall 29, rim 28 or lid 23 of the pod as long as the objects can be differently positioned, sized, shaped, colored, magnetized, composed or differentiated in any other manner to have two different states to provide two different values such as 1 and 0 or on and off. The bit group reader or switch group 34 comprises a plurality of object readers or switches capable of distinguishing the two states for such objects on the pod. It is appreciated that the assignment of a bit group to a certain pod here is for the purpose of describing the invention and that a different bit group may be assigned in a commercial product. It is also appreciated that the value 0 is arbitrarily assigned to the up bit and the value 1 is arbitrarily assigned to the down bit. It is obviously possible for the up bit to be assigned 1 and the down bit to be assigned 0. It is also appreciated that each bit in the bit group 90 may be in one of three states, e.g. up, middle and down and may be provided with one of three values, e.g. 0, ½, and 1, readable by the bit group reader or switch group 34.

FIG. 1P shows a cold brew espresso pod comprising a bit group 90 having two up bits 90-0 in the first two places and one down bit 90-1 in the third place of the bit group formed on the pod sidewall 27, a first container 88 having a first impermeable bottom 27, a first impermeable sidewall 29 connected to the bottom, a rim 28 for the sidewall, and an access opening surrounded by the rim, and a second container 256 having a second impermeable bottom 259 and a second impermeable sidewall 255 sealed to the rim or sidewall of the first container 88 to form a first or foaming chamber 258 between the first and second bottoms 27 and 259. The pod also comprises a cup-shaped filter 87 having a filter bottom 26 and multiple tandem pleats 97 sealed to the sidewall 29 and/or the sidewall 255 to form a thin second chamber 257 between the filter 87 and second bottom 259. The pod also comprises an impermeable lid 23 sealed to the rim 28 to form a third or brew chamber 58 between the cup-shaped filter 87 and lid to store a supply of espresso coffee grinds. The lid is pierceable by the inlet needle 85 to receive an injection of fluid into the brew chamber 58 for interaction with the brew material to form a brew. The filter separates the second and third chambers so that the brew formed in the brew chamber must flow through the filter to pass to the second chamber 257. A foaming orifice 269 is formed on the second bottom 259 for forming a foamed brew in the first chamber. The second container 256 is sealed to the first container 88 so that the brew in the second chamber 257 must flow through the foaming orifice to pass to the first chamber 258 unless the foaming orifice malfunctions or is clogged. The second bottom 259 is sufficiently flexible to cause the second chamber 257 to expand substantially to receive the brew from the third chamber 58 when the inlet needle 85 injects hot water through the lid into the third or brew chamber. The foaming orifice is sufficiently small to emulsify and produce fine foam for the brew as the brew passes through the filter, second chamber and foaming orifice into the first chamber. The first bottom 27 is pierceable to form an outlet to discharge the brew and fine foam in the foaming chamber 258 into a receptacle or cup.

The espresso pod further comprises a standby orifice 277 sufficiently small to emulsify and produce foam for the brew formed in the third chamber as the brew passes through the filter, the second chamber and the standby orifice into the first chamber. The standby orifice is normally sealed or closed by an impermeable film 279 that is heat-sealed to the bottom 259. The film 279 becomes broken or the heat seal is unsealed to open the standby orifice when the foaming orifice 269 malfunctions or is clogged. The pod may further comprise a second supply of brew material, e.g. milk or chocolate concentrate or powder, in the first chamber. The milk or chocolate significantly improved the foaming of the espresso at low pump pressure, and allows the brewing of latte, cappuccino, mocha or the like drink having a thick foam head with a low-pressure pump 7 capable of producing only 1 to 3 bars or 15 to 45 psi of pressure to improve the safety of the apparatus. To prevent the contents, especially liquid, in the foaming chamber from reaching the coffee grinds in the brew chamber 58, the foaming opening 269 may be a weakened area on the second impermeable bottom wall 259 or covered by a film similar to the film 279. The weakened area is pushed open to form the foaming opening 269 when a sufficient amount of espresso brew is delivered into the second chamber 257 to expand the chamber. It is appreciated that the first chamber 258 may also be used to froth milk from a milk container 299, to be described in FIG. 7.

FIG. 1R, along with FIGS. 1 and 1A, shows the flow-deflecting inlet needle 85 comprising a hinge 191 connected to a handle (not shown) of the brew cover to cause the needle to retract into the brew cover when the cover is opened and to extend out of the cover to pierce the lid 23 when cover is closed. It further comprises a needle inlet 132 connected to the metering filter 14 via the inlet tube 18, a needle outlet 172 for issuing a water stream 93, a fluid passageway channel 173 between the needle inlet and needle outlet, a cutter such as a stab or spear 21 positioned a predetermined distance away from the needle outlet 172 and adapted to pierce the lid to introduce fluid into the supply of brew material 24, and a connector 25 to connect the cutter to the needle outlet. The cutter has a deflecting surface or deflector 171 to deflect and redistribute the water stream 93 into upward streams 91 and downward streams 92. As a result, the cutter 21 prevents the channeling of the needle 85P for prior-art brewers shown in FIG. 1B. The upward streams 91 cause any brew material that floats in the brew chamber 58 to be fully dissolved or extracted, thereby further improving the brew strength and reducing waste. By positioning the cutter 21 directly below the center of the needle outlet 172, the cutter also prevents the brew material such as coffee grinds, bread or spaghetti from being pushed into the needle outlet 172 and fluid passageway channel 173 during the insertion of the needle into the brew material. The center of the needle out is on the axis line 207 for the fluid passageway channel.

The needle outlet 172 of the inlet needle 85 may have a diameter larger than the diameter of the needle inlet and the tube 18 that connect the inlet needle to the metering filter to prevent the clogging of the fluid passageway 173 between the tube 18 and needle inlet by the brew materials 24 and 24a. To prevent the clogging of the inlet needle itself by the brew material, the needle outlet is sufficiently larger than the needle inlet 132. The distance between the needle outlet 172 and cutter 21 or the length of the connector 25 is sufficiently long, e.g. 2 to 16 mm, preferably 4 to 10 mm long, to prevent the clogging of the needle outlet 172. Such long or tall connector 25 is also crucial to pierce through the pouch 220 of FIG. 1K and allow the water from the needle outlet to carry out the brew material 202 in the pouch chamber 199. If the connector 25 is sufficiently long that part of the connector remains in the brew cover 20 after the cover is closed, the lower opening of the seal gasket 22 on the brew cover essentially becomes the outlet 172 for the inlet needle 85.

Besides introducing various liquid or gaseous fluids into a supply of brew material, the flow-deflecting needle 85 may also be used to introduce fluids into various soft objects. The brew materials include sandwich, meat, bread and pizza, coffee grinds, baby formula, syrup, beverage mix, soup mix, cereal, oatmeal, grains, dessert, and spaghetti. The soft objects include animal skin, human skin, plant, soil and any other soft object that may be cut, penetrated or inserted into by the cutter 21. Due to its high tolerance to solids, it is possible for the flow-deflecting needle to deliver fluids that contain suspended solids or are very viscous or gel-like into the brew material of soft objects.

In FIGS. 1, 1U, 1V and 1W, a self-refreshing filter 14 is positioned upstream of the inlet needle 85 and intended to resolve the short life issue for prior-art brewers under Keurig® and iCoffee® taught in U.S. Pat. Nos. 6,142,063, 6,079,315, 9,149,149, 9,295,357 and 9,307,860. The life issue is possibly caused by the grinds sucked into the inlet needle, pump and other parts of the brewer by the vacuum produced in the brew path as the brewer cools down after each brewing. The self-refreshing filter 14 of FIGS. 1 and 1W comprises a filtration chamber 17 in fluid communication with the water tank 3 and brew cover 20, a filter base 15 secured to and in the filtration chamber, movable lips 16 connected to the filter base, and elongated expandable openings 19. Two opposing lips 16, which are also seen in FIGS. 1U and 1V, are adapted to form a first opening 271 on the filter base 15 and a second opening 19 positioned substantially away from the filter base. The first opening is substantially fixed in size and the second opening is a rectangular opening. The second opening 19 may also adopt a round, oval or other suitable shape and be formed on an elastomer sheet. The movable lips 16 may be made from metal, ceramic, plastics or elastomer.

The second opening 19 in its normal state is substantially smaller than the first opening and is adapted to change in size in response to a change in the differential pressure acting on the movable lips 16 to modulate the flow resistance and passage of solids through the self-refreshing filter 14. As a result, the second opening is also referred to as expandable opening. When vacuum is formed upstream of the filter after brewing, the differential pressure acts on the movable lips for the expandable opening 19 and causes the lips to move towards each other to close the expandable opening and significantly increase the flow resistance, thereby preventing the solids 24 in holder 30 from passing through filter 14 into the brewer and protecting the brewer. When the pump 7 is on, the pressure upstream of the filter pushes the two opposing movable lips apart to expand the expandable opening to significantly reduce the flow resistance, thereby allowing the water from the pump to flush away any grinds or solids on or near the filter and to refresh the filter. It is discovered that the expandable opening 19 of the filter 14 remain functional when only one of its two opposing lips 16 is movable and the other is immobilized or fixed in position.

FIG. 1U shows a self-refreshing metering filter 14 imbedded in the fluid passageway channel 173 near the needle inlet 132 of the inlet needle 85. The filter base 15 is secured to the needle inlet, which becomes the filtration chamber 17. To fit into the inlet needle, only one expandable opening 19 is formed on the filter base by two opposing movable lips 16. The expandable opening shown is normally closed when there is no pressure upstream. When the pump 7 delivers water to the inlet needle, the pressure upstream pushes the lips and expands the expandable opening 19 to inject water into the fluid passageway channel 173. The water from the expandable opening splashes against the sidewall of fluid passageway channel and then changes flow direction to wash away any brew material such as bread, grinds or meat in the channel.

In FIG. 1V, the self-refreshing filter 14 it is located inside to the fluid passageway channel 173 directly above the deflecting surface or deflector 171 of the cutter 21 to cause the water to issue from the expandable opening 19 as a speedy jet to impinge and splash against the deflector. This arrangement significantly improves the brew quality and is noticed to emulsify the fluid when the speed of the jet is sufficiently high. The expandable opening is positioned sufficiently close to the needle outlet 172 to prevent any significant accumulation of brew material in the fluid passageway channel 173, but sufficiently away from needle outlet to prevent any damage to the expandable opening 19 or lips 16. A cylindrical sleeve 194 is positioned below the filter base 15 to prevent the pump pressure from pushing the filter out of the fluid passageway channel 173. The speedy jet from the expandable opening is highly effective in flushing away the brew material, including hard-to-remove bread and noodle, if present, out of the fluid passageway channel when brewing a sandwich or meal (FIGS. 4 to 7).

It is appreciated that the inlet needle 85, outlet needle 63, and fluid needle 261, which is to be described in FIG. 7, may be any suitable solid object having a sharp or pointed tip at its end capable of piercing into or through another object. The needle may even have a dull tip at its end to make the needle safe to touch. The fluid passageway channel 173 may be replaced by a plurality of channels, cutouts, indents or other irregularities formed on the outer surface of the needle. It is also appreciated that the expandable opening 19 in the fluid passageway channel 173 may be replaced by other suitable expandable opening.

The self-refreshing filters 14 of FIGS. 1U and 1V were also noticed to cause nearly constant brewing speed when different types of pods containing different brew materials were used. Such metering effect of the self-refreshing filter is more obvious when the expandable opening 19 remains sufficiently small in its expanded state and the lips 16 are sufficiently strong to resist the pump pressure. This enables to the apparatus 1 of the present invention to achieve a metered brew volume, which is equal to the brewing speed times the brewing time. As a result, the self-refreshing filter 14 has provided a simpler alternative to meter the brew volume than the devices taught by Streeter, Beaulieu, et al in U.S. Pat. Nos. 7,523,695, 7,398,726, 6,142,063 and 6,082,247.

Considering its unique ability to meter the brew volume, the self-refreshing filter 14 is also called a self-refreshing metering filter or metering filter. In a preferred embodiment, the metering filter 14 comprises two opposing movable lips 16 to form one elongated expandable opening 19 similar to the opening 19 in FIG. 1W. In its non-expanded state, the elongated opening has an opening width of 0 to 1, preferably 0 to 0.5, millimeters or mm and an opening length of 1 to 15 mm, preferably 2 to 7 mm, to achieve the flow rate suitable for the brewing. Larger openings may be used for the expandable opening of a metering filter to be used industrial applications. When the pump 7 is turned on to produce a pressure upstream, the expandable opening 19, which is for example 0.1 mm wide and 2.5 mm long in its non-expanded state, may be expanded to a larger size, e.g. 0.5 mm wide and 2.7 mm long, depending on the pump pressure. When vacuum is produced upstream, the opening 19 is reduced in size or even closed.

The degree of expansion or the size of the opening 19 in its expanded state, which determines the flow rate or brewing speed, may be controlled by the strength, rigidity and dimensions of the lips 16 or by the force applied to the one or both the lips 16 of the expandable opening with a spring or an elastic plate (not shown). Various flow rates, such as 2, 3, 5 or 12 millimeters or ml per second, may be achieved for the brewing. For the metering filter to achieve a flow rate substantially independent of the brew material, the flow resistance for the fluid to flow through the expandable opening 19 in its expanded state is adapted to be sufficiently higher, preferably at least 50% higher, most preferably at least 75% higher, than the flow resistance for the fluid to flow through the brew material in the holder. To achieve the high flow resistance as well as a long service life, which is to be described below, the lips 16 may be made sufficiently long, e.g. 15 mm or 25 mm, and the average lip distance is sufficiently small, e.g. 0.5 or 1 mm. The average lip distance is half of the sum of the two distances between the lips at the base 15 and at the expandable opening 19 when the opening is in its non-expanded state.

Though hard water scales, formed during the heating of water, are able to pass through the expandable opening 19 and captured by the filter 87 of the pod, the metering filter 14 could still become clogged after extended services. To achieve an acceptable service life, e.g. 3 years, the expandable opening 19 is adapted to be expanded to a sufficiently large size, which is between 3 and 20, preferably between 5 and 10, square millimeters, under normal operation pressure for the metering filter 14. For a rectangular or oval shape opening 19 used in brewing, the length of the opening may be 1 to 10, preferably 2 to 7, millimeters and the width of the opening may be 0.3 to 4, preferably 0.5 to 2, millimeters when the opening is in its expanded state or under the normal operation pressure. It is appreciated that controller 2 may cause the pump 7 to produce a revival pressure sufficiently higher than the normal operation pressure to push the opposing lips 16 for the expandable opening 19 father apart than the normal operation pressure to allow the fluid to flush away any extra large solids caught in the metering filter 14 during normal operations, thereby revitalizing the apparatus 1. The revival pressure may be produced by applying a voltage or current that is higher than that used during the normal operation to the pump. It is also appreciated that the controller 2 may comprise a dedicated controller, which may be a chip, CPU or just a simple manual switch, for one or more components of the apparatus.

When the metering filter 14 in FIG. 1 is mounted at the reverse direction, i.e. the metering filter is so mounted that the expandable opening 19 is positioned upstream of the first opening 271, it becomes a constant flow valve. Substantially the same flow rate may be achieved when the pump pressure upstream varies 30% or more. The flow rate becomes substantially constant when the average lip distance between the two opposing lips 16 is sufficiently small, e.g. 1 millimeters, and the lips are sufficiently long, e.g. 20 millimeters. At such reversely mounted position, the distance between the two lips of the expandable opening 19 is reduced when the pump pressure upstream is increased since the increased differential pressure acting on the outer surface of the two lips 16 pushes the lips closer to each other. The reduced distance between the lips 16 increase the flow resistance to balances the effect of the increased pump pressure, thereby causing the flow rate to stay the same. When the expandable opening 19 is clogged, the flow through the metering filter 14 may be reversed to flush away the solids and clean the metering filter. Alternatively, the base 15 containing the two opposing lips 16 may be fit in a through opening or a cylindrical opening through a movable body such as a ball adapted to fit into the filtration chamber 17 and to rotate by a knob to switch the positions of the first and second openings 271 and 19 therein. The through-opening is co-axial with the filtration chamber. The second opening 19 is upstream of the first opening 271 during normal operation of the metering filter. To clean, the ball is rotated 180 degrees within the filtration chamber 17 by the knob to move the second opening 19 downstream of the first opening to allow the pump pressure upstream to expand the second opening to flush away any solids.

Besides its use in the brew station 300, the metering filter 14 may be useful in other applications such as delivering liquid or gaseous fluids to utilization stations in chemical and pharmaceutical processing, aquariums, mining, water treatment, swimming pools, homes, salt water and semiconductor industry. When the tank 3 is connected to a plumbing or piping system, it may be a chamber adapted to receive fluid from the plumbing system and allow the pump 7 to deliver the fluid therein to the brew station or other utilization stations. The tank 3 may also be a chamber or a section of pipe fluidly sealed to allow the pressure of the plumbing system to deliver the fluid through the metering filter 14 to the brew station or other fluid utilization stations.

A cold brew catalyzer 10 is provided in the apparatus of FIG. 1 for brewing a cold brew with a cold brew coffee pod 100 in a minute. The word “catalyzer” means that the brew catalyzer drastically increases the speed of cold brewing and may not imply chemical reactions. The brew catalyzer comprises a catalyzation chamber 12, which is fluidly connected to the water tank 3 and brew cover 20, and a heater 9 electrically connected to the controller 2 via wires 9a. The catalyzation chamber has a sufficiently low heat capacity, which is typically between 5 to 100 calories per degree Celsius, preferably between 5 to 50 calories per degree Celsius, to ensure that the cold brew received in a serving cup is below the ambient or room temperature and the catalyzer 10 can be activated properly. To activate the brew catalyzer, the controller 2 causes a small amount of catalyzing energy, which is typically 1 to 8, preferably 2 to 4, watt-hours to be supplied to the catalyzer prior to the brewing of the coffee grinds in the pod. Such low need of energy to activate the catalyzer makes it possible for the apparatus to brew 8 to 12 ounces, i.e. 200 to 360 ml, of cold brew with a car cigarette lighter, a laptop computer or other low wattage power source.

An adapter such as a USB connector is provided to plug into a laptop or a cigarette lighter. A cold brew coffee pod 100 of FIG. 1, which has the same size as a K-Cup® pod and contains 13.5 grams of light, medium or dark roast, is provided into the holder 30. Unlike like the prior-art cold brewers that require coarse grinds with an average grind size of 1,000 micrometers or larger, the cold brew pod 100 requires sufficiently fine grinds with an average grind size smaller than 475, preferably smaller than 300, micrometers for at least one dimension of the fine grinds to facilitate the interaction with the water in the cold state to achieve proper cold brew strength. When the cover 20 is closed (FIG. 1A), the bit group 90 presses the switch group 34, thereby causing the controller 2 to select the cold brewing condition per the switch states 011 and the catalyzer to be charged with a small amount of catalyzing energy, e.g. 2.4 watt-hours, by the cigarette lighter or laptop. Upon pressing a start button, the controller causes the pump and catalyzer to provide 8 ounces of water in its first or cold state from the tank 3 to the brew chamber 58 of the pod. In a minute, about 8 ounces of cold brew coffee is dispensed into a cup below the holder.

The temperature of the resulting 8-ounce cold brew was 15-30 degrees Celsius depending on the temperature of the cold water in the tank 3. The strength of the 8-ounce cold brew was 1.14% in total dissolved solids or TDS measured by a VST LAB Coffee III refractometer. The cold brew almost meets the Golden Cup Standard of 1.15 to 1.35 in TDS defined by the Specialty Coffee Association, and is much stronger than an 8-ounce hot coffee brewed from standard K-Cup® pods, which has a typical brew strength of 0.6 to 0.9 in TDS measured by the same refractometer.

The catalyzer, therefore, makes it possible to brew a fresh cup during one's camping or driving trips with a cigarette lighter or on airplanes with a laptop. Though it is not well understood how the brew catalyzer catalyzes the cold brewing, it was discovered that part of the catalyzing energy was transferred to the cold water delivered to the cold brew pod 100, which increased the temperature of the resulting cold brew by 7 to 10 degrees Celsius. It is also discovered that the heat capacity of the catalyzation chamber 12 should be sufficiently low to achieve the proper activation of the cold brew catalyzer and to prevent the temperature of the resulting cold brew from being significantly above the ambient or room temperature.

FIG. 2 shows a method of brewing cold brew when the apparatus 1 is plugged into an outlet in a home, office or store. Two cups of cold or iced water are added to the tank 3. The tank may be connected to a tap water system, a refrigerator or another storage tank. After providing a cold brew coffee pod 100 containing the properly ground beans as described above into the holder and closing the brew cover as shown in FIG. 1A, the bit group presses the switch group 34 in the holder and causes the cold brew catalyzer 10 to be charged with a small amount of catalyzing energy, e.g. 3 watt-hours, in seconds. After pressing a start button, the controller causes the pump and catalyzer to provide a first amount of water, e.g. 50 milliliters, and a second amount of water, e.g. 170 ml, in its first or cold water state through the ground coffee to interact with the ground coffee in the pod. Part of the catalyzing energy may transfer to the iced or cold water, which may increase the temperature of the resulting cold brew by about 8 to 11 degrees Celsius. If most of the catalyzing energy is transferred to the first amount, e.g. 50 ml, of iced or cold water, the temperature for the first 50 ml may be increased by about 50 degrees Celsius. In this case, the second amount of water delivered through the coffee grinds to interact with the coffee grinds is at the temperature of the iced or cold water and has a much larger volume, e.g. 170 ml, than the first amount. The first and second amounts may be delivered in a continuous stream or in two separate streams through the ground coffee to interact with ground coffee.

In 60 seconds or so, 8 ounces of cold brew formed as a result of the interaction between the coffee grinds and cold water in the brew chamber is dispensed into a cup below the holder. The resulting cold brew had a temperature of 15 to 20 degrees Celsius and brew strength of 1.15 to 1.27% in total dissolved solids or TDS measured by a VST LAB Coffee II Refractometer. The cold brew meets the Golden Cup Standard of 1.15 to 1.35 in TDS and is much stronger than an 8-ounce hot coffee brewed from standard K-Cup® pods, which has a typical brew strength of 0.6 to 0.9 in TDS measured by the same refractometer. For faster or richer brewing, the controller may cause the average flow rate for the second amount of water, which is the second amount divided by the residual time for the second amount of water in the brew chamber 58, to be higher than that for the first amount, which is the first amount divided by the residual time for the first amount in the brew chamber.

To brew a cup of hot coffee, two cups of water are added to the tank 3. It takes about 4 minutes to heat the water to the optimum brewing temperature of 195 to 205 degrees Fahrenheit and about 1 minute to pump a cup of water in its second or hot water state through the hot brew pod in the holder to brew a cup. The wait time for a cup is thus 5 minutes. To reduce the wait time, the controller 2 is adapted to cause the heater 5 to heat the water in the water tank only to a convection-preventing temperature, which is to be described below, in 2 minutes. The controller then causes the pump 7 to pump a cup of water at the convection-preventing temperature and causes the heater 9 of the catalyzer to heat the water from the convection-preventing temperature to its second or hot water state at the optimum brewing temperature through the pod in a minute. The wait time is now reduced to 3 minutes. If the controller is adapted to cause the heater 5 to pre-heat the water in the tank 3 and to maintain the water therein at the convection-preventing temperature, the wait time for brewing a cup of hot coffee is further reduced to just the pumping time or a minute.

The convection-preventing temperature is the water temperature right before a heater causes significant convective flow in the water around the heater during the heating. It is typically between 100 and 170, preferably 120 and 150, degrees Fahrenheit depending on the surface condition, wattage, position, area and shape of the heater in the tank, the impurities and additives in the water, and the water pressure. Partly due to the lack of convective flow, it was found that it took 300% to 1,000% less energy to maintain the water at the convection-preventing temperature than to maintain the water at the optimum brewing temperature of 195 to 205 degrees Fahrenheit in the tank 3. By maintaining water at the energy-saving convection-preventing temperature in the tank 3, the apparatus can stay ready to brew a cup all the time and the wait time is merely a minute. Other advantages of the convection-preventing temperature are to be discussed in FIGS. 5-7.

To make the apparatus 1 safe for children in a hotel room and home, the controller 2 is adapted to cause the heater 5 to maintain the water in the tank 3 at a child-safe temperature below 138, preferably below 128, degrees Fahrenheit, which is within the range for the convection-preventing temperature to save energy. The controller also causes the heater 9 of the brew catalyzer 10 to heat the water from the child-safe temperature to the optimum brewing temperature, thereby providing the water in its second or hot water state to the pod to brew a hot cup quickly in a minute. If a child accidently turns the child-safe brewer over or spills the hot water in the tank 3 that is maintained at the child-safe temperature, the hot water is relatively safe to the child.

FIG. 3 shows an alternative catalyzer 10 having an elongated chamber 149 in a tube 147 downstream of the catalyzation chamber 12 to expand the use of the cold brew catalyzer to other uses, to be described below. The catalyzation chamber has an inlet 150 connected to the pump via tube 8. The elongated chamber 149 is connected to the metering filter 14 via tube 11. The catalyzation chamber may hold a volume of water to reduce the temperature of the catalyzer when being charged with the predetermined amount of catalyzing energy for catalyzing the cold brewing. However, the volume of the catalyzation chamber should be sufficiently small, e.g. be 1 to 50 ml, preferably 1 to 10 ml, to prevent deactivation of the catalyzer.

Besides catalyzing the cold brewing and providing water in its second or hot water state to reduce the wait time, the brew catalyzer 10 may also provide water in its third or steam state to cook meals, improve espresso quality and dry the spent pods, to be described in FIGS. 4 to 7. To provide the water in its third state, the controller 2 causes the catalyzer to be heated to a steam-generating temperature higher than 220 degrees Fahrenheit and causes the pump to deliver a steam unit of water to the catalyzation chamber at a sufficiently slow flow rate of 0.25 to 0.75 milliliters per second to ensure dry steam. One steam unit is about equal to the volume of the catalyzation chamber 12. When more steam is needed, another steam unit is delivered to the catalyzer. To control the flow rate accurately for steam generation, a second metering filter similar to the metering filter 14 of FIG. 1 may be provided between the catalyzer 10 and pump 7.

FIGS. 4 and 4A show an improved brew station 300 for the apparatus 1 of FIG. 1. The improved brew station comprises first and second holders 30 and 30A adapted to accept pods of different heights, sizes and shapes, and a brew cover 20 having a movable head 200 adapted to move into and out of the brew cover. The pod may be cup, bowl, plate or pouch-shaped. The head 200 comprises a second switch group 234 having switches 234a, 234b and 234c connected to the controller 2 via wires 233a, 233b and 233c for contacting the bit group 90 on the pod rim (FIGS. 4E and 4F), a retractable flow-deflecting needle 85 having a cutter 21 for piercing the film lid 23, a seal gasket 22 for sealing the film lid around the pierced opening, a first energy emitter 225 for cooking the brew material in the pod, and a loaded spring 228 between the head and a top wall 232 of the brew cover. The loaded spring is adapted to allow the head to move relative to the top wall 232 so that the first and second holders 30 and 30A are able to accept pods of different heights. The brew cover is movable relative to the first and second holders between an open position in which the holders are exposed to receive a pod, and a closed position in which the brew cover are arranged to cooperate with the first and second holders to form a short or tall pod chamber 158 between the seal gasket 22 and a bottom wall 197 of the second holder to enclose a short or tall pod 100, respectively, as shown in FIGS. 4E and 4F.

The first holder 30 comprises a first rim 186, a first opening 175 defined by the first rim for receiving and engaging with a small pod, and a first sidewall 170 comprising a support spring 185 having an upper spring end 227 connected to the first rim and a lower spring end 229 connected to the bottom wall 197. The support ring is compressible by the brew cover 20 or a pod 100. When a pod is sufficiently small to be receivable into the first opening 175, the first opening is movable up and down relative to the bottom wall 197 between a first position, as shown in FIG. 4E, in which the sufficiently small pod 100 is tall and received by the first opening and a second position, as shown in FIG. 4F, in which the sufficiently small pod is short and received by the first opening. The second position is closer to the bottom wall 197 or lower than the first position. The first opening 175 has a substantially square cross-section with sufficiently rounded corners (FIG. 4A) to enable the first holder 30 to receive both square and round pods. When the pod has a similar square cross-section, the first opening 175 enables the accurate positioning of the bit group 90 to press the second switch group 234 on the brew cover 20 properly. The loaded spring 228 is adapted to compress the support spring and cause the outlet needle 63 to pierce the pod bottom when a short and small pod is provided into the first holder 30.

The second holder 30A comprises a second rim 89, a second opening 31 defined by the second rim for receiving and engaging with a large pod 100, a switch group 34 similar to that of FIG. 1M, a second sidewall 35 between the second rim and bottom wall 197 for enclosing the first holder 30, and a second energy emitter 230 at the bottom wall. The first opening 175 is positioned within the second opening 31 and movable to different positions to provide pod chambers of different heights between the first and second openings to accept pods of different heights that are too large to be received by the first opening. When a pod is sufficiently large to prevent it from being received into the first opening, the first opening is movable between a first position, as shown in FIG. 4B, in which the sufficiently large pod is short and sits on the first rim 186 and a second position, as shown FIG. 4D, in which the sufficiently large pod is tall and sits on the first rim. Again, the second position is closer to the bottom wall or lower than the first position, though in both the first and second positions the first opening 175 is spaced significantly apart from or below the first opening 31 to allow the second opening to accept the short and tall sufficiently large pods.

The first and second energy emitters work together to bake, toast or roast the brew material such as sandwich, pizza and meat from the top and bottom surfaces of the pod to cause the cooking from the outside to the inside. Such outside-in cooking cooperates with the inside-out cooking by the hot fluid from the brew catalyzer to achieve fine cooking, which is to be described below. The emitters may be an infrared or microwave emitter, electric heater, gas heater, or other suitable heating devices for the pod and brew station 300. To prevent safety issues caused by a large hot cooked pod falling off when the brew cover 20 is open, the first opening 175 may be positioned a predetermined distance below the second opening or the support spring 185 is sufficiently compressible to cause the weight of the pod to move the first opening a predetermined distance downward, thereby causing the second opening to at least partially confine the large cooked pod when the cover is open.

The first and second holders 30 and 30A share a shield 60 and a shield locker 40. The shield is similar to that of FIG. 1 and comprises a shield plate 62, finger stopper 61 and dispenser 53. The shield locker comprises a latch 54, trigger 55, an upper trigger 182 adapted to move up and down relative to the shield plate and to act on the sloped surface 56 of the trigger 55, and a first beam 183 connected to the shield plate 62 and received in an opening 174 in the trigger 55. The first beam has a ball end 184 to prevent the trigger 55 from separating from the shield plate. The shield locker further has a second beam 178 adapted to push the latch 54 into a locking position above a step 179 above a latch opening 180 at the bottom 197. The second beam is pushed towards the latch by a compress spring 176 secured in position by a cap 177.

The first and second holders also share the inlet needle 85 for piercing the film lid 23 to provide an inlet to introduce fluid into the pod and share the outlet needle 63 on the bottom wall 197 for possibly piercing the pod bottom 27 to provide an outlet for the brew. The inlet and outlet needles are similar to those of FIG. 1. The outlet needle 63 may be positioned on a shared outlet 50 similar to that of FIG. 1 to allow the same outlet needle to properly pierce short and tall pods. To provide more space for the second emitter 230, the lower spring end 229 may be made sufficiently large to connect to the second sidewall 35 rather than to the bottom wall 197. The first opening 175 and rim 186 may be supported by a plurality of mini springs rather than the support spring 185 or by a plurality of elastomer members such as beams or strips adapted to allow the first opening to move up and down relative to the bottom wall 197. Though the first and second openings are shown to have a square shape in FIG. 4A, a pentagon, hexagon, heptagon, oval or other polygon shape may be used for the openings to achieve proper positioning of the bit group 90 with the switch groups 34 and 234.

FIG. 4 also shows a short large pod 100 comprising an impermeable bowl-shaped container 88 having an impermeable pod bottom 27, pod sidewall 29 and pod rim 28, insoluble brew material 24a such as spaghetti, sandwich, pizza, grains or herbs, soluble brew material 24 such as salt, sugar or sauces, and a film lid 23 sealed to the pod rim to form a brew chamber 58 to store the brew material and to prevent air, moisture and bacteria from the entering the brew chamber and spoiling the material. The pod bottom is larger than the first opening 173 of the first holder 30 so that the pod may sit on the first rim 186. A weak seal section 188 is formed between the film lid 23 and pod rim 28. The film lid is pierced by the inlet needle 85 to introduce hot steam or hot water into the container when the brew cover 20 is moved to the holders 30 and 30A to enclose the pod and the needle is moved out of the brew cover. When the brew chamber is filled with hot steam or under sufficient pressure, the weak seal section 188 un-seals to form a safety opening or pressure releaser 188a to release the hot steam or pressure in the brew chamber to prevent damage and potential explosion of the pod (FIG. 4B). The pressure releaser also makes it safe to remove or peel off the film lid to serve the cooked brew material or food in the container. It is appreciated that the pierced opening made by the inlet needle on the lid may also function as a pressure releaser 188a. A plurality of channels or ridges along the radial direction of the lid may be formed around the pierced opening to prevent the seal gasket 23 from sealing the pierced opening and to form passage channels for the hot steam or air. A check valve that allows the steam to flow out of but prevents air from entering the pod may also be formed on the lid as a pressure releaser. The check valve may comprise a vent opening on the film lid and a film disc over the vent opening. The film disc forms a weak seal to the film lid to prevent the air outside from entering the brew chamber but may be pushed away from the film lid by pressure in the brew chamber to break the weak seal to open the vent opening. The film lid has a tab or handle 187 to facilitate the removal of the lid from the container 88 after the completion of cooking to serve the cooked sandwich, spaghetti or the like directly in the container.

The pod sidewall 29 is sufficiently short to cause the inlet needle 85 to pierce and insert sufficiently deep into the brew material 24a such as sandwich, meat, bread, spaghetti or other food in the brew chamber 58 to deliver hot fluid, e.g. hot steam, hot water, hot air or any combination of them, into the interior or middle of the brew material (FIG. 4B). The short pod sidewall also prevents the outlet needle 63 from piercing the pod bottom 27. The hot fluid may be injected under pressure into the interior of the brew material and diffuse or flow from the interior to the outer surface of the brew material to heat and cook the brew material or food from the inside to the outside, thereby achieve inside-out cooking. A hot air generator including an air pump or fan and air heater may be connected to the inlet needle 85 to provide hot air. The inside-out cooking is significantly more uniform and efficient than traditional cooking where steam or heat is applied to the outside of the food, thereby saving cooking time and improving the taste. Since the cooking is confined within the small, sealed brew chamber 58 in the pod, energy loss is minimized. The heat insulation due to the enclosure of the pod by the holder and brew cover 20 further minimizes the energy loss and makes the inside-out cooking highly energy efficient.

To achieve optimum inside-out cooking, the optimum delivery location to which the hot fluid is delivered or injected is about one quarter to three quarters of the total thickness of the brew material below the surface of the brew material depending on the nature of the food in the pod. In another word, the inlet needle 85 should pierce through about one quarter to three quarters of the brew material to achieve the optimum inside-out cooking. A brew optimizer 107 is provided on the pod 100 to determine the delivery location for the hot fluid in the interior of the brew material or food. In this exemplar embodiment of the invention, the brew optimizer is a simple protrusion formed on pod bottom 27 to contact the cutter or tip 21 of the inlet needle 85 and prevent further downward movement or insertion of the inlet needle into the brew material. The delivery location for the hot fluid may also be controlled by a delivery location bit in the bit group 90 formed on the pod. The location bit may be positioned within or apart from the rest of the bits in the bit group to control a depth regulator (not shown) in the brew cover 20 mechanically or electrically to move the inlet needle 85 a predetermined distance out of the brew cover depending on the height of the pod sidewall 29 and the nature of the brew material. The depth regulator may comprise a linear actuator such as a step motor or solenoid.

A plurality of channels or cuts may be formed in advance or pre-formed within the brew material such as meat, sandwich, bread and pizza to cause the hot fluid from the inlet needle 85 to flow from the delivery location in the interior through the channels or cuts in the brew material. Each channel or cut may have one end connected to the delivery location where the inlet needle 85 pierces into the brew material and another end located near the outer surface of the brew material. The channels or cuts may be formed on the surface of a pierce of meat or bread and a plurality of such pieces may be stacked over each other in the brew chamber 58. When the needle 85 is pushed or pierced into the brew material, the deflector 171 of the cutter 21 prevents the brew material from being pushed into the fluid passageway channel 173, thereby preventing the clogging of the needle by meat, bread, soup, spaghetti and other brew material. Self-refreshing filter 14 may be provided inside the inlet needle 85, similar to that of FIG. 1U or 1V, to improve the reliability of the apparatus in cooking.

To achieve outside-in cooking in the pod, the first and second emitters 225 and 230 are turned on to toast, bake or roast the meal materials 24 and 24a such as sandwich or meat through both the film lid 23 and pod bottom 27 of the pod. For fast cooking, the first and second emitters are adapted to emit infrared beams having peak spectral power density at a wavelength shorter than 3,000 nanometers, preferably shorter than 1,500 nanometers. The film lid and the pod bottom are made from spectrally transparent materials such as polypropylene or polyethylene terephthalate that do not absorb infrared beams having wavelength less than 3,000 or 1,500 nanometers to prevent the pod bottom and film lid from being melt by the heat. The inside-out and outside-in cooking may be performed simultaneously to further reduce the cooking time and achieve the desired flavor, aroma, color and crispness. Fine cooking for sandwich, pizza, meat, spaghetti, soup and other meals is achieved by precisely controlling the temperature, duration and amount of the hot fluid delivered into the interior of the food by the brew catalyzer 10 and pump 7 and by precisely controlling the intensity and duration of the infrared heat applied to the outer surface of the meal or food in the pod by the first and second emitters 225 and 230.

FIG. 4B shows the use of the short large bowl-shaped pod in the brew station 300. The pod is too large to fit into the first opening 175, so it actually sits on the first rim 186 of the first holder 30. The weight of the pod may compress the support spring 185 to cause the pod to partially enter the second holder 30A. As the brew cover 20 is lowered, the inlet needle 85 is moved out of the head 200 to pierce the film lid 23 and the pod bottom pushes the upper trigger 182 downward. The upper trigger in turn pushes the sloped surface 56 to cause the trigger 55 to turn around the ball end 184 to move the latch 54 out of the step 179 into the latch opening 180, thereby unlocking the shield plate 62. When the pod rim 28 reaches the second rim 89, further movement of the pod is prevented, thereby preventing the outlet needle 63 from piercing the pod bottom 27. As the brewer cover is further lowered, the movable head 200 is pushed into the brew cover 20 by the film lid 23 and pod rim 28 and the bit group 90 presses the switch group 34 to provide the switch states 110 to the controller 2. The controller selects the set of cooking conditions per the switch states and instructs the various parts of the apparatus to prepare and provide the set of cooking conditions, which may include 1) Steaming for 1 minute to soften the meat and noodle, 2) emitting for 1 minute to produce thin crisp skin on the meat, 3) Brewing for 15 seconds with a small amount, e.g. 50 or 100 ml, of hot water to bring out the flavors to the noodles in the pod, and 4) Cooling the pod by introducing a supply of ambient-temperature air flowing between the pod sidewall 29 and the sidewall 35 of the second holder 30A. The air may be introduced into the holder by a fan or air pump. The steam temperature is predetermined for each type of pods and may be 225 to 450 degrees Fahrenheit.

To prepare for the step of steaming, the controller 2 turns on the power to the catalyzer to cause the elongated chamber 149 and catalyzation chamber 12 (FIG. 3) to be heated to the steam-generating temperature. After a brew start button is pressed, the controller causes the pump 7 to deliver water at a sufficiently low flow rate from the tank to the catalyzer 10 while the heater 9 is on to generate and deliver steam via inlet needle 85 into delivery location in the interior of brew material to soften the meat and noodle for 1 minute. At the same time, the first emitter 225 emits infrared heat for 1 minute to produce thin crisp skin for the meat. The controller then causes the pump to quickly deliver 50 ml of hot water to the mix of meat, spice and noodles to brew for 15 seconds to bring out the flavors to the noodles. When the brew cover is opened, the support spring 185 moves the cooked pod up and partially out of the holder 30 and cool air is blown onto the outer surface of the pod to make the pod comfortable to hold for easy and safe removal. The film lid is then peeled off the pod via the tab 187, allowing one to enjoy the flavorful noodle meal with crisp meat directly from the bowl-shaped pod.

FIG. 4C shows a reusable bowl-shaped pod 100R having an impermeable bowl-shaped container 88R and a reusable lid 23R for one to fill and seal the bowl with fresh ingredients 24 and 24a right before the cooking. The bowl 88R comprises an impermeable bottom 27, an impermeable sidewall 29, a rim 28, a brew chamber 58 formed by the bottom 27, sidewall 29 and lid 23R, and a plurality of bit groups 90 having bits 90-1, 90-1 and 90-0. The reusable lid 23R comprises a skirt or sidewall 189 around the perimeter of the lid for receiving the rim 28, an inlet opening 222 sealed by a self-healable film 221, a venting seal 188, a stop wall 224 adapted to prevent the lid from being opened by the pressure in the brew chamber, and a handle 197 for facilitating the removal of the reusable lid from the bowl. The venting seal is adapted to move away from the rim 28 to vent steam when the pressure in the brew chamber reaches above a predetermined value. The self-healable film is pierceable by the inlet needle 85 and is sufficiently thick to automatically heal itself to close the opening pierced by the inlet needle. In a preferred embodiment, the self-healable film is an elastomer film made from silicone rubber, butyl rubber or polyurethane and has a thickness of 0.2 to 6, preferably 0.5 to 3, millimeters. The reusable pod 100R may be cooked in the same way as the pod 100 of FIG. 4B.

FIG. 4D shows a tall large soup pod 100 received in the first holder 30 and sealed by brew cover 20. The tall soup pod comprises a plurality of bit groups 90, a deep impermeable bowl-shaped container 88 having an impermeable bottom 27 larger than the first opening 175, an impermeable sidewall 29 and a rim 28, a film lid 23 sealed the rim 28 to form the brew chamber 58 for the soluble and insoluble materials 24 and 24a, a hygiene tube 142 connected to an outlet opening 49, and a regulator plate 48 sealed to the bottom 27 by an adhesive or heat seal 143 around the outlet opening 49. The pod sidewall 29 is sufficiently tall to enable the outlet needle 63 to pierce the pod bottom 27. The hygiene tube and regulator plate are the same as those in the pod of FIG. 1K. Each bit group in the plurality of the bit groups has the same bits 90-0, 90-1 and 90-0. The bits in each of the plurality of bit groups are so positioned that each bit group will have the same switch states 010 no matter how the pod is provided into the second holder 30A.

Since the tall large soup pod is not receivable into the first opening 175, the pod sits on the first rim 185 and its weight compresses the support spring 185 to cause the pod to partially enter the second holder 30A. As the brew cover 20 is lowered, the inlet needle 85 is moved out of the head 200 to pierce the film lid 23, the head 200 pushes the pod further into the second holder, and the pod bottom pushes the upper trigger 182 downward. The upper trigger in turn pushes the sloped surface 56 to cause the trigger 55 to turn around the ball end 184 to move the latch 54 out of the stop step 179 and into the latch opening 180, thereby unlocking the shield 60 and exposing the outlet needle 63 to pierce the pod bottom 27. The outlet needle breaks the seal 143 and pushes the regulator plate 48 up to produce a transient chamber 59 (FIG. 4D). The regulator plate prevents the raw brew materials from discharging into a receptacle such as a cup or bowl prior to brewing. As the brew cover is further lowered, the head 200 is pushed into the brew cover by the film lid 23, the first holder 30 and shield 60 are pushed to the bottom wall 197, and the bit group 90 presses the switch group 34 to cause the controller to select a set of brewing conditions associated with the bit group. The cooking includes 1) Steaming the materials 24 and 24a for 30 seconds, 2) Delivering an amount, e.g. 300 ml, of water and heating the water from the convection-preventing temperature to a soup-brewing temperature through the catalyzer 10, 3) Delivering the water through the brew chamber 58 and transient chamber 59 to brew and carry both the materials 24 and 24a out of the hygiene tube 142, and 4) Delivering a quick supply of steam to dry the pod.

To prepare for the steps of steaming and brewing, the controller 2 turns on the heater 5 to pre-heat the water 4 in the tank 3 to the convection-preventing temperature and turns on the heater 9 to heat the catalyzer 10 (FIG. 1) to a temperature sufficiently high to generate steam. After a start button is pressed, the controller causes the pump 7 to deliver the hot water at a sufficiently low flow rate to the catalyzer to generate steam to steam the materials in the brew chamber for 30 seconds. It then causes the pump to deliver 300 ml of hot water into the brew chamber in which the steamed brew material are mixed with hot water and regulated through the regulating openings 144 into the transient chamber, and discharged through the hygiene tube 142 directly into a receptacle such as a bowl or cup below the holder in 20 seconds. Finally, the controller causes a sufficient large amount of heat to be supplied to the heater 9 in seconds to evaporate part of the water in the catalyzation chamber into the third or steam state to dry the pod 100. When the brew cover 20 is opened, the shield spring 43 pushes the shield plate 62 above the outlet needle 63, which causes the transient chamber 59 to vanish and the regulator plate 48 to fall to close the hygiene tube 142. The spring 176 and second beam 178 pushes the latch 54 onto the stop step 179 to lock the shield 60. In the meantime, the support spring 185 moves the spent pod up and partially out of the second holder 30A for easy removal of the pod.

FIG. 4E shows a tall small cup-shaped pod received in the first holder 30 and covered by the brew cover. This pod is identical to the tall pod of FIG. 1H, except that the bit group 90 is formed on the rim 28 adapted to press the second switch group 234 in the movable head 200. The tall small pod is receivable in the first opening 175 of the first holder 30. As the brew cover is moved towards the holders, the inlet needle 85 is moved out of the head 200 to pierce the film lid 23 and the head pushes the pod and pod bottom 27 against the upper trigger 182. The upper trigger in turn pushes the sloped surface 56 to cause the trigger 55 to turn around the ball end 184 to move the latch 54 off the step 179 and into the latch opening 180, thereby unlocking the shield 60 to allow the pod bottom to push the shield plate 62 downwards to expose the outlet needle 63 to pierce the pod bottom.

After piercing the pod bottom, the outlet needle pushes the filter bottom 26 upwards to produce the transient chamber 59. The movable brew head 200 is then pushed into the brew cover by the pod rim. Once obtaining the switch states for the bit group 90, the controller selects a set of brewing conditions for the pod, which includes 1) Delivering an amount, e.g. 12 ounces, of hot water, 2) Supplying a predetermined power to the heater 9 to heat the hot water from its convection-preventing temperature to 197 degrees Fahrenheit and 3) Delivering a quick supply of steam to dry the pod. To prepare for the steps of delivering, the controller 2 turns on the heater 5 to pre-heat the water in the tank 3 to the convection-preventing temperature (FIG. 1). After a start button is pressed, the controller 2 causes the pump 7 to deliver a predetermined amount of hot water and causes the heater 9 to heat the hot water from its convection-preventing temperature to 197 degrees Fahrenheit. At the end of brewing, it causes sufficient amount of heat to be supplied to the heater 9 in a plurality of seconds to evaporate at least part of the water in the chamber 12 into its third or steam state to dry the spent pod.

During the brewing, the transient chamber 59 contracts or shrink significantly in size and becomes essentially vanished and appear like that in FIG. 1C at the end of the brewing. When the brew cover is opened, the shield spring 43 pushes the shield plate 62 over the outlet needle 63, thereby causing the needle to move out of the pod and causing the pod to move partially out of the first holder 30 for easy removal. In the meantime, the spring 176 and second beam 178 pushes the latch 54 onto the step 179 to re-lock the shield 60.

Like the bowl-shaped pod of FIG. 4B and reusable bowl of FIG. 4C, the tall pod 100 of FIG. 4E may be converted to a reusable filter cup 100R having a cup-shaped filter. The film lid 23 is replaced by a reusable lid having a center opening sealed by a self-healable film, which is similar to that of FIG. 4C but without the venting seal 188, to allow a user to fill the pod with their own fresh ground coffee beans in advance and keep the coffee fresh. A similar self-healable film may be formed on the pod bottom 27 or sealed to the pod bottom. The self-healable film is pierceable by the outlet needle 63 and is adapted to automatically heal itself to close the pierced opening by the needle. A coffee filling station, which is similar to the filling station 250 and is to be in FIG. 4G, may be provided at the top end of the reusable filter cup 100R to receive the freshly ground coffee beans directly from a coffee grinder and prevent spilling of coffee grinds.

FIG. 4F shows a short small pod received in the first opening 175 and sealed by the gasket 22 of the cover 20. The lower parts of the pod and holders are the same as those of FIG. 4E and are thus omitted for simplicity. The short and small pod is identical to the tall small pod of FIG. 4E except its height. The use of the short pod is also the same as the tall pod of FIG. 4E, except that after the brew cover is closed the movable head 200 remains outside the brew cover and the first rim 186 of the first holder 30 is pushed down by the movable head a predetermined distance into the second holder 30A. The predetermined distance is the difference between the effective depth of the second holder 30A and the height of the short small pod. The effective depth is the internal depth of the second holder minus the height of the shield 60 over the bottom wall 197 when the shield spring 43 is fully compressed. The first holder 30 is capable of accepting small pods as tall as the effective depth of the second holder or as short as the effective depth minus the movable distance of the movable head.

FIG. 4G shows a bolt-head pod having a slim portion similar to the lower part of the tall pod of FIG. 4E and receivable into the first opening 175 and a coffee filling station 250 adapted to sit on the first rim 186. The lower parts of the pod and holders are the same as those of FIG. 4E and are thus omitted for simplicity. The bolt-head pod further has a pod rim 28, a film lid 23 sealed to the pod rim, and bit groups 90 formed on the pod sidewall adapted to press the switch group 34 on the second holder 30A. The coffee filling station 250 has a middle wall 268 to sit on the second rim 89 and an opening 251 sufficiently large to receive a large spoon capable of holding a sufficiently large amount of coffee grinds to brew a cup of coffee or receive a dispensing spout of a coffee grinder to allow the roasted beans to be freshly ground and dispensed directly into the pod.

The method of use for the bolt-head pod is the same as the tall pod of FIG. 4E, except that the pod rim 28 is supported by the second rim 89 and the first rim 186 is pushed down by the coffee filling station 250. The advantage of the bolt-head pod 100 is its ability to accept freshly ground coffee directly from a coffee grinder, thereby allowing coffee shops or homes to freshly fill a bolt-head pod with their coffee grinder right before brewing. The bolt-heat pod may be provided with a reusable lid having a self-healable film similar to that for the bowl-shaped reusable pod of FIG. 4C and the reusable filter cup described above for the tall pod of FIG. 4E.

FIG. 5 shows a first improved version of the apparatus 1 of FIG. 1. The first improved version has a cooling tank 110 and a heating tank 120 below the water tank 3 to minimize the wait time and to enable convenient switch between hot and cold brews. The distribution chamber 6 is located in a support base 247 of the apparatus 1 and is sufficiently large to receive a water filter cartridge 248 having an inlet chamber 218 adapted to removably receive and seal to an outlet 217 of the water tank 3. The support base has a substantially flat upper surface and is sufficiently large to support the water tank. The filter cartridge removes chlorine and other chemicals in the water in the water tank. When the water tank is removed from the support base 247 for refilling water, the distribution chamber 6 and the filter cartridge 248 therein becomes readily accessible by hand, thereby facilitating the replacement of the used water filter cartridge with a new cartridge.

The heating tank 120 has a heater 125 connected to the controller 2 via wires 125a and adapted to heat the water only to the convection-preventing temperature and maintain the water therein at this temperature to save energy. The heating tank further comprises an inlet distributor 124 positioned near the bottom of the tank and connected to the distribution chamber 6 by an inlet tube 121, an outlet distributor 123 positioned near the top of the tank and connected to a path valve 108 by an outlet tube 127, and a second air outlet 122 at the upper end of the tank. The cooling tank 110 comprises a chiller 115 connected to the controller 2 via wires 115a for cooling the water to a predetermined temperature therein, an inlet distributor 114 located in the top part of the tank and connected to the distribution chamber 6 by a cold-water tube 111, an outlet distributor 113 positioned in the lower part of the cooling tank and connected to the path valve by a cold-water tube 111a, and a first air outlet 112 at the top end of the tank. The above positioning of the outlet and inlet distributors 113, 123, 114 and 124 in the heating and cooling tanks prevents the delivery of water of improper temperature to the pod. The chiller 115 is positioned sufficiently close to the top of the cooling tank and the heater 125 is positioned sufficiently close to the bottom of the heating tank to achieve uniform cooling and heating. The openings 113a and 114a for the distributors in the cooling tank face downward. The openings 123a and 124a for distributors in the heating tank face upward to prevent the delivery of water at improper temperature to the pod. Temperature probes (not shown) are provided to the tanks 110 and 120 to control the tank temperature.

An air-water separation chamber 140 sufficiently large to separate the air and water and a vent actuator 240 for breaking any air pocket in the vent tube 241 are provided to facilitate the filling of the cooling and heating tanks. The separation chamber has an inlet 249 connected via a tube 242 to the vent actuator, which is connected to the first and second air outlets 112 and 122 via a vent tube 241, a third air outlet 245 located at or near the chamber top, and a return tube 243 having one end connected to the chamber bottom and another end connected to the distribution chamber 6. The vent actuator may be a fluid moving device such as a fan or pump connected to the controller 2 via wires 240a, and it may turn on for a plurality of seconds when the water tank is refilled or after a brew is made to move a mix of air and water from tanks 110 and 120 into the separation chamber where air is vented via the third air outlet 245 and water is returned to the distribution chamber 6 via the return tube 243. By returning the water into the distribution chamber rather than into the tank 3, the tank can be more conveniently removed from and replaced onto the support base 247 of the apparatus.

The path valve 108 is adapted to form hot and cold brew paths when hot and cold brew pods are provided into the holder 30, respectively. The path valve may be a 3-way valve, a valve assembly with a first valve for controlling the flow out of the cooling tank 110 via the cold-water tube 111a and a second valve for controlling the flow out of the heating tank 120 via the tube 127, or other suitable valve capable of forming hot or cold brew path for the pods. The path valve may be switched by an electrical actuator such as a solenoid connected to the controller 2 via wires 108a or by a manual knob for those who prefer hands-on operation and control.

FIG. 5 also shows a shield 60 for preventing an inlet needle 85P in the brew cover from injuring children in hotel rooms or homes with kids. The needle has one end connected to a base 157 of the brew cover 20, a fluid passageway channel 173P, a needle outlet 172P, and a sharp tip or cutter 21P at the free end of the needle for piercing the film lid 23 or other object. The shield 60 comprises a shield plate 62, a finger stopper 61, a seal gasket 22 connected to the shield plate and adapted to form a watertight seal to both the lid 23 of the pod 100 and the base 157 of the brew cover 20, and a shield spring 43 having an upper or first end connected to the brew cover and a lower or second end connected to the shield plate. The first end of the shield spring is smaller than the second end to facilitate the formation of the watertight seal of the seal gasket to the base 157. The finger stopper includes an expandable opening adapted to expand by the needle to allow the needle to pass through but is sufficiently small to prevent a child's finger from passing through.

It is noted that by making the expandable opening sufficiently smaller than the needle 85P, the needle is cleaned by the shield to be free of brew material from the pod 100. Certain brew material like proteins or fats stuck to the needle may become spoiled and be subsequently introduced into the next pod and brew, which could cause healthy or safety issues. The shield 60 is normally in its first or safe, injury-prevention position in which the shield plate 62 is below and covers the inlet needle 85P, as shown in FIG. 5 when the brew cover is in its open position. It is moved to its second or brewing position in which the shield plate is pushed up to the base 157 of the brew cover 20 by the lid 23, pod or holder 30A to expose the inlet needle 85P to pierce the lid (FIG. 5A). When the brew cover is moved towards the holder to its closed position, the lid or pod pushes the shield plate 62 upwards and compresses the shield spring 43, the needle 85P passes through the finger stopper 61 and pierces the film lid, and finally the seal gasket 22 seals to the base 157 of the brew cover and the lid 23. When the brew cover is moved away from the holder to its open position again, the shield spring pushes the shield plate to a position below and covers the inlet needle, thereby moving the shield to its first or safe position.

The shield plate 62 may be a self-healable plate made from elastomer similar to the self-healable film of FIG. 4C. The finger stopper may not be present prior to the first use of the shield. After the first use, a pierced opening is made by the needle 85P. The pierced opening self-heals and becomes substantially closed after the needle is removed from the shield plate, and the substantially closed opening becomes the finger stopper 61. It is appreciated that the seal plate 62 prevents the movement of the system or the needle 85P on the object to be pierced, thereby preventing potential breaking of the needle in the object due to sudden movement of the object. The seal gasket 22 further prevents the movement of the needle on the object. The lower surface of the shield plate may be sticky or adhesive to the surface of the object to be pierced by the needle. It is appreciated that a needle with the shield 60 may also be used in delivering medicines and delivering and receiving liquid and gaseous fluids into and from an object in locations where child safety is a concern.

When a cold brew pod such as a cold brew coffee pod 100 is provided into the holder of the apparatus of FIG. 5, the bit group 90 presses the switch group 34 (FIGS. 1 and 1M) or 234 (FIG. 4). The controller instructs the path valve 108 to connect the pump 7 to the cold-water outlet distributor 113 and tube 111a, thereby forming the cold brew path that comprises the tank 3, distribution chamber 6, pump 7, cooling tank 110, path valve 108, cold brew catalyzer 10, metering filter 14, inlet needle 85P, and pod 100. According to the set of brewing conditions associated with the switch states 011 for the bit group on the cold brew coffee pod, the controller 2 supplies a predetermined amount of catalyzing energy, e.g. 2.5 watt-hours, to the catalyzer and instructs the pump 7 to deliver the water in the cooling tank through the outlet distributor 113, path valve, catalyzer, cover and pod. In a minute, a rich cup of cold brew coffee or tea is brewed into a cup below the holder 30A.

When a hot brew pod 100, e.g. a hot brew coffee, soup, oatmeal or sandwich pod, is provided into the holder, the bit group 90 on the pod presses the switch group 34 or 234 and the controller 2 instructs the path valve 108 to connect the pump 7 to the hot water outlet distributor 123 and tube 127, thereby forming the hot brew path that comprises the tank 3, distribution chamber 6, heating tank 120, path valve 108, pump 7, catalyzer 10, metering filter 14, cover 20 and pod 100. According to the set of brewing conditions associated with the switch states for the bit group on the pod, the controller 2 instructs the various parts of the apparatus 1 to make a hot brew, e.g. a cup of hot coffee, a bowl of hot soup, a bowl of hot meal or a grilled sandwich, in a minute or so.

To save energy, the water in the heating tank 120 is maintained at a sufficiently low convection-preventing temperature of only 100 to 170 degrees Fahrenheit, preferably 120 to 150 degrees Fahrenheit, instead of at the optimum temperature of 195 to 205 degrees Fahrenheit for brewing coffee. It was discovered that it saves up to 1,000% electricity to keep the water at the 120 to 150 degrees Fahrenheit than to keep at the near boiling temperature. To brew hot coffee, the controller 2 turns on the pump 7 to deliver the water kept at the convection-preventing temperature, e.g. 140 degrees Fahrenheit, from the tank 120 to the catalyzer 10 and supplies sufficient power to the catalyzer to heat the water therein to the optimum brewing temperature for the hot coffee pod. Alternatively, the controller may cause the heater 125 to heat the water in the heating tank 120 from the convection-preventing temperature to the optimum brewing temperature and then turns on the pump 7 to deliver the water at the optimum temperature through the pod. The alternative method, however, may double the amount of time required to brew a cup. The method of cooking meals and brewing soups from respective pods 100 and drying the wet spent pods is the same as that described in FIGS. 4 to 4G, except that here the pump 7 draws the hot water from the heating tank 120 rather than directly from the water tank 3.

In an alternative method to brew a cold brew pod, the controller 2 may cause the path valve 108 to form the hot brew path for a first length of time (t₁) to deliver a first or small amount, e.g. 30 millimeters, of hot water from the heating tank 120 into the brew chamber 58 to interact with the brew material 24, 24a and/or 202 to facilitate or activate the dissolution or extraction of the brew material. It then causes the path valve to form the cold brew path for a second length of time (t₂) to deliver a second or large amount, e.g. 270 millimeters, of cold water from the cooling tank 110 into the brew chamber 58 to interact with the brew material 24, 24a and/or 202 to form a cold drink therein. Certain brew material such as honey, dense syrup, and drink powders containing fat or proteins in the cold brew pod may be difficult to be dissolved or extracted into cold water. The small amount of hot water from the hot brew path makes it possible to include such difficult-to-dissolve brew material in the cold brew pod. In this alternative method, the heating tank 120, vent actuator 240 and path valve 108 together act as the cold brew catalyzer 10, though the brew catalyzer was discovered to produce significantly richer cold brew when the pod is a cold brew coffee pod.

Similarly, in an alternative method to brew a hot brew pod, the controller 2 may cause the path valve to form a cold brew path for a first length of time (t₁) to deliver a first or small amount of cold water and to form a hot brew path for a second length of time (t₂) to deliver a second or large amount of hot water into the brew chamber 58 to interact with the brew material 24, 24a and/or 202 to form a hot drink of desired taste and temperature. The temperature of the resulting hot brew is determined by the first and second lengths of time and may be calculated using equations similar to the Equations 1 and 2 for calculating the baby formulae temperature brewed with the improved version of the apparatus of FIG. 7.

FIG. 5B shows a simplified alternative to the system of FIG. 5 where the storage tank 3 is connected directly to a syringe pump 7 via tube 101. The syringe pump comprises a metering chamber 210, a check valve 102 that allows the fluid 4 in the tank 3 to flow into the metering chamber via tube 101 but prevents any backflow into the tank, an outlet tube 214 adapted to connect to a needle assembly 850, a check valve 105 that allows the fluid in the metering chamber to flow to the assembly via the outlet tube but prevents any backflow into the metering chamber, a piston 216 received in the metering chamber in a sealed relationship to the interior surface of the chamber and adapted to move up and down in the chamber, a knob 212 connected to the piston via a stem 213 and adapted for one to press and deliver the fluid in the metering chamber to the assembly, and a pump spring 215 located between the metering chamber 210 and the knob 212. After the delivery of the fluid in the metering chamber, the pump spring pushes the piston up until the knob meets a graduated stopper 211 to draw an amount of fluid automatically from the tank through check valve 102 into the metering chamber. The stopper may be manually moved up to increase or down to decrease the amount of fluid to be drawn into the metering chamber.

The needle assembly 850 comprises an needle 85P having one end connected to a base 157, another end with a sharp tip or cutter 21P adapted to pierce an object such as skin or film, and a fluid passageway channel 173P adapted to communicate with the outlet tube 214 of the syringe pump 7. The assembly also comprises a shield 60 for preventing the sharp tip 21P from injuring a child. The shield comprises a shield plate 62 for covering the sharp cutter 21P and a shield spring 43 having a top end connected to the base 157 and bottom end connected to a plate rim 203 of the shield plate. The shield plate is pierceable by the sharp tip 21P to allow the needle to pass through to pierce the object. The shield plate may be sufficiently sticky or adhesive to the object to be pierced by the needle to prevent movement of the shield plate on the surface of the object, thereby preventing the needle from being broken into the object due to movement of the object. To use, one moves the shield plate 62 to contact the object and adhere to the surface of the object, thereby limiting the movement of the shield plate relative to the object. One then presses the knob 212 to push the shield plate 62 against the object to compress the shield spring 43 and cause the sharp cutter 21P to pierce the shield plate and the object. One finally presses the knob with a larger force to compress the pump spring 215 to push the piston 216 downward to deliver the fluid, which may contain medicine or nutrient, in the metering chamber 210 through check valve 105, outlet tube 214 and fluid passage channel 173P into the object. The pump spring is sufficiently stronger than the shield spring so that the knob compresses the shield spring to cause the sharp cutter to pierce the shield plate and the object before it can compress the pump spring. After releasing the knob, the pump spring 215 pushes the knob 212 and piston 216 up to refill the metering chamber 210 with a predetermined amount of fluid from the tank 3 and the shield spring 43 pushes the base 157 away from the shield plate 62, thereby pulling the cutter 21P and the needle out of the object to its safe position able and to be covered by the shield plate 62.

It is appreciated that a removable cover may be provided for the shield plate 62 to cover its bottom adhesive surface. It is also appreciated that the shield plate may be a self-healable plate adapted to self-heal and close a pierced opening made by the needle as soon as the needle is removed from the shield plate. It is also appreciated that a locker may be provided to prevent movement of the shield plate. The locker may have a latch to lock the shield plate in position and a trigger to release the latch to allow the shield plate to move relative to the base 157. It is also appreciated that an elastomer stopper such as a rubber disc may be provided at the bottom end of the outlet tube 214 and a second needle may be provided above the base 157. The elastomer stopper is pierceable by the second needle and the second needle is in fluid communication with the fluid passage channel 173P of the needle 85P to allow the fluid in the metering chamber 210 to be delivered into the object via the outlet tube 214, fluid passage channel 173P and needle outlet 172P. It is further appreciated that the syringe pump 7 may be located inside tank 3 to make the apparatus 1 more compact and portable.

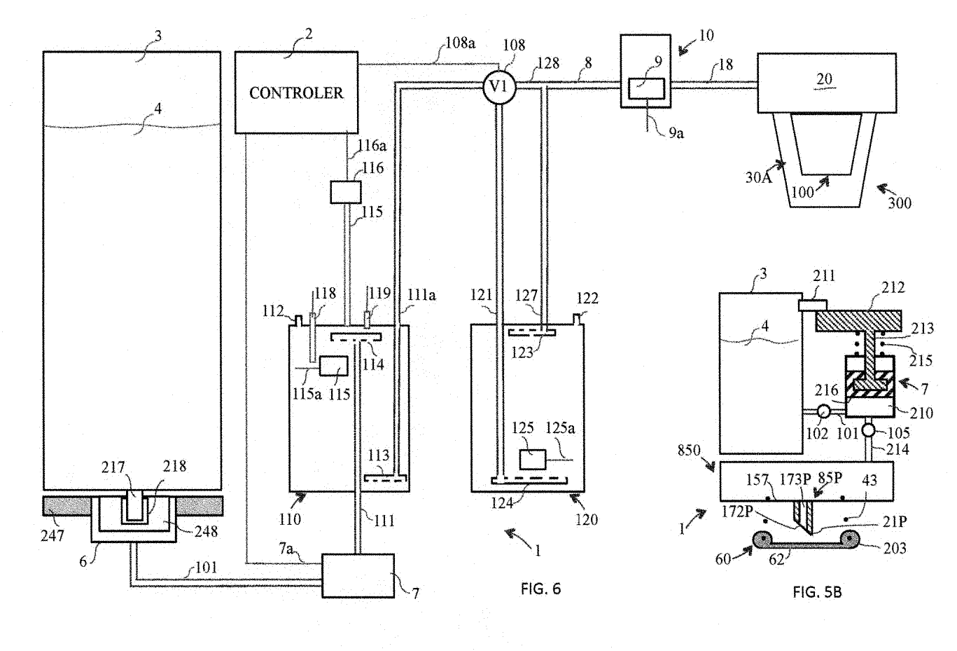

FIG. 6 shows a second improved version of the system 1 of FIG. 1 where the cooling and heating tanks 110 and 120 of FIG. 5 are positioned downstream of the pump 7 to prevent convective warming of the water in the water tank 3 by the hot water in the heating tank to further save energy. Rather than using the metering filter 14 of FIG. 5, the metering for the apparatus 1 of FIG. 6 is accomplished by low and high water level sensors 118 and 119, which are of the type taught by Streeter et al. in U.S. Pat. Nos. 7,523,695 and 7,398,726. The cooling tank 110 is normally filled by water from pump 7 to the low level sensor 118. An air pump 116 is connected to the controller 2 and the top of the cooling tank 110 to pressurize the tank and deliver the volume of water between the outlet distributor 113 and the sensor 118 or 119 out of the tank, thereby achieving the metering.

The air outlets 112 and 122 may be connected to a vent tube 241, vent actuator 240 and air-water separation chamber 140 (not shown) identical to those of FIG. 5, except that the vent actuator here may be an electrical or mechanical valve adapted to close the vent tube when the air pump is on and to open the vent tube when the air pump is off. The path valve 108 is provided to switch and connect the cold-water tube 111a to either a valve tube 128 or the inlet tube 121 for the heating tank to form a cold or hot brew path, respectively. It is appreciated that the water level sensors 118 and 119 may be replaced with a plurality of outlet tubes with outlet ports positioned at different heights in the tank 110 and a plurality of solenoid valves for the outlet tubes, which are of the type taught by Beaulieu et al. in U.S. Pat. Nos. 6,082,247 and 6,142,063.

When a cold brew pod such as a cold brew coffee pod 100 is provided into the holder, the bit group 90 on the pod presses the switch group 34 (FIGS. 1 and 1M) or 234 (FIG. 4). The controller instructs the path valve 108 to connect the cold-water tube 111a to the valve tube 128, thereby forming the cold brew path that comprises the tank 3, distribution chamber 6, pump 7, cooling tank 110, path valve 108, cold brew catalyzer 10, metering filter 14, brew cover 20 and pod 100. The controller 2 supplies a predetermined amount of catalyzing energy, e.g. 2.5 watt-hours, to the catalyzer and turns on the air pump 116 to deliver the water in the cooling tank through the cold brew path. In a minute, cold brew is brewed into a cup below the holder. If the volume of water available in the cooling tank 110 is less than the volume required by the set of brewing conditions associated with the bit group 90 on the pod or than the volume a user selects via a user interface connected to the controller 2, the controller turns on the pump 7 to deliver the cold water from the water tank 3 and distribution chamber 6 to the cooling tank until the water reaches the high level sensor 119 right after the cold brew path is formed.

When a hot brew pod 100, e.g. a hot brew coffee, soup, oatmeal or sandwich pod, is provided, the bit group on the pod presses the switch group 34 or 234 and the controller causes the path valve 108 to connect the cold-water tube 111a to tube 121 and inlet distributor 124 of the heating tank 120, thereby forming the hot brew path that comprises the tank 3, distribution chamber 6, pump 7, cooling tank 110, path valve 108, heating tank 120, catalyzer 10, cover 20 and pod 100. The controller then instructs the various parts of the apparatus 1 to work according to the set of brewing conditions associated with bit group on the pod. When the pod is a hot brew coffee pod, the controller 2 turns on the air pump 116 to pressurize the cooling tank 110 to deliver the cold water therein through the path valve and inlet distributor 124 into the heating tank 120 in which the cold water pushes the hot water, which is maintained at the convection-preventing temperature, e.g. 140 degrees Fahrenheit, upwards into the outlet distributor 123 and catalyzer 10. In the mean time, the controller supplies sufficient power to the catalyzer to heat the water that flows the catalyzer from the convection-preventing temperature to the optimum brewing temperature of 195 to 205 degrees Fahrenheit before the water is delivered to the hot coffee pod. A rich cup of hot coffee is brewed in a minute. If the brewing conditions associated with the bit group 90 on the hot coffee pod require a brew volume or if the user selects a brew volume that is larger than the volume of water currently available in the cooling tank 110, before the controller 2 turns on the air pump it turns on the pump 7 to fill more water from the distribution chamber 6 to the cooling tank until the water reaches the high level sensor 119 so that a larger cup can be delivered.

FIG. 7 shows a third improved version of the system 1 of FIG. 1 and an improvement for FIG. 6 to minimize the energy use by replacing the energy-gorging cooling tank 110 of FIG. 6 with a simple cold-water tube 111. This version is exceptionally useful for the homes where space and affordability are valued and chilled water is available for the tank 3. The metering filter 14 is added back to replace the air pump 116 and level sensors 118 and 119 of FIG. 6 for faster metering of water and steam. The path valve 108 is located in the upstream of the cold-water tube 111 and the tube 121 for the inlet distributor 124 of the heating tank 120 to quickly form cold and hot brew paths. The cold brew path comprises the tank 3, distribution chamber 6, pump 7, path valve 108, cold-water tube 111, cold brew catalyzer 10, first and second natural carbonation chambers 283 and 282, metering filter 14, brew cover 20 and pod 100. The hot brew path is the same as the cold brew path except that the cold-water tube 111 is replaced by heating tank 120. By quickly switching between the cold and hot brew paths and supplying catalyzing energy to the brew catalyzer 10 with the controller 2, one or a plurality of quick shots of hot water, cold water, and/or hot steam can be delivered precisely to a pod 100 to bring out the desired aromas, flavors, and/or mouth feel for fine brewing or cooking. To minimize energy loss, the heating tank 120 is maintained at the convection-preventing temperature of 110 to 160 degrees Fahrenheit, which is significantly cooler than the near-boiling temperature for the hot water kept in prior-art brewers to minimize energy loss.

To remove air and excess water in the heating tank 120, the air outlet 122 is connected to a flow actuator 240, shown in FIG. 7A, or a solenoid valve via the vent tube 241. The flow actuator comprises a semi-spherical actuation chamber 246 having an outlet 244 connected to a separation chamber 140, which is not shown but is identical to that of FIG. 5, via the tube 242 and a semi-spherical sealer 237 adapted to move up and down in the actuation chamber. The sealer has a cavity 239 and a vent channel 238 and is adapted to move up to seal the outlet 244 and close the vent tube 241 when the water flow rate into the actuation chamber is sufficiently fast to balance the weight of the sealer. To facilitate the removal of air and excess water from the heating tank, the sealer 237 has a density substantially higher, preferably at least 2% higher, than the water density. The expandable opening 19 of the metering filter 14 is substantially closed to cause the hot water in the heating tank 120 to flow first through the vent tube 241 at or above the sufficiently fast flow rate, thereby causing the sealer to quickly close the outlet 244 and then direct the hot water towards the pod 100 when the pump 7 is turned on to deliver the water to the brew station 300. By making the opening 19 substantially closed, water dripping at the brew station is also prevented.

A natural carbonator 280 is provided in the cold brew path and comprises the first and second natural carbonation chambers 283 and 282 connected to the tube 11 and metering filter 14, a nozzle 281, a carbonation valve 285 connected to the controller 2 by wires 285a and to the nozzle by a tube 284, and a container 287 connected to the valve 285 by a tube 286 for providing a supply of pressurized carbon dioxide. The nozzle is housed in the first natural carbonation chamber and has an orifice 289 pointed at the direction of the water stream that flows in the first natural carbonation chamber to generate a speedy stream or jet of carbon dioxide within the water stream. As the streams of carbon dioxide and water travel together in the first natural carbonation chamber, the carbon dioxide in the stream of carbon dioxide is quietly and naturally absorbed into the water in the water stream, thereby causing the water to be naturally carbonated or causing natural carbonation. The size or diameter of the speedy stream of carbon dioxide becomes smaller as the natural carbonation continues. The first natural carbonation chamber is sufficiently long to cause the speedy stream of carbon dioxide to become significantly smaller in size or vanish as the stream travels downstream to the exit or right end of the chamber. To speed up or facilitate the natural carbonation, the second opening 19 of the metering filter is made sufficient small and restrictive to the flow of the water stream to cause sufficient backpressure for the carbonation chamber. The orifice 289 of the nozzle is sufficiently small, preferably smaller than 1 or 0.5 millimeters in diameter, to work with the first natural carbonation chamber to convert the high pressure of the carbon dioxide, which can be destructive and damaging to the seals, joints, tubes, sensors and other components of the apparatus, from the container 287 into heat and velocity of the water stream, which is mild and safe to the above components. It was found that without the natural carbonation, the carbon dioxide gas could flow at reverse direction into the cooling tank 110 and heating tank 120 to fill the tanks with gas and damage the seals and tubes. Two or more orifices 289 may be formed on the nozzle 281 to speed up the natural carbonation in the first natural carbonation chamber.

The second natural carbonation chamber 282 may be smaller than the first natural carbonation chamber, and allows remaining carbon dioxide gas in the speedy stream of carbon dioxide to be naturally absorbed into the water stream, thereby completing the natural carbonation. The second natural carbonation chamber 282 is connected to the first natural carbonation chamber, and at least a part of the second chamber adjacent to the first natural carbonation chamber is co-axial or shares an axis, as shown in dotted line 278, with the orifice 289 to facilitate the natural carbonation and prevent potential degassing of the carbonated water. The first and second natural carbonation chambers are sufficiently long to allow sufficient time for the carbon dioxide gas in the speedy stream of carbon dioxide from the orifice 289 to be naturally absorbed into the water stream therein. The resulting carbonated water is mixed or brewed with the brew material such as syrup, fruit juice concentrates, beverage powder or even ground coffee or tea in a pod 100 to form soda, sparkling juice, or other carbonated drink. One may choose the type of drink by choosing the type of pod. The volume of the drink is selected by controlling the brewing time via the controller 2 and the metering filter 14. The carbonation level or the carbon dioxide concentration in the drink is controlled via the carbonation valve 285 and controller 2.

If the apparatus 1 is used to brew only carbonated cold drinks, the pump 7 and heating tank 120 may be removed. The first natural carbonation chamber cooperates with the nozzle 281 to act as a pump to draw cold water from the distribution chamber 6 through the cold-water tube 111 into the carbonation chamber and deliver the naturally carbonated water through the metering filter 14 to the pod 100 to form soda or other sparkling drinks. The position of the metering filter may be reversed so that the second or expandable opening 19 is positioned upstream of the first opening 271 to improve the consistency of the brew volume metered by the metering filter. The cross-section area or diameter of the first natural carbonation chamber 283 should be sufficiently small, i.e. smaller than 0.8 inches in diameter or 0.5 square inches in area, and sufficiently long, i.e. longer than 2 or 4 inches, to cause the speedy stream of carbon dioxide from the orifice 19 to draw water from the water tank 2 into the first natural carbonation chamber, in which the water is naturally carbonated, and deliver the naturally carbonated water to the pod 100 in the brew station 300 to form the carbonated drink.

The holder 30 and cover 20 are similar to those of FIGS. 4 to 4G, except that the holder has an injector 260 connected to a supply tube 296. The supply tube is connected to at least one portioner 290 to provide at least one fluid such as milk, flavoring syrup or whipped cream to the injector. The portioner comprises a metering pump 297 electrically connected to the controller 2 via wires 297a and fluidly connected to a fluid container 299 via a tube 298. The injector comprises a body 262 removably received in a receiver 263 and a fluid needle 261 for piercing the pod bottom 27 to form a pierced opening to introduce the fluid from the supply tube into an interior space of the pod. The fluid is different from the brew to provide different flavor or nutrients to the brew and may be mixed with the brew within the pod or with the brew received in a cup, bowl or other receptacle below the holder. By providing a hygiene tube 142 similar to those of FIGS. 1K and 4D to the pod, both the brew formed in the pod and the fluid introduced into the pod via needle 261 are dispensed into the receptacle without contacting the holder 30 and apparatus, thereby preventing cross-contamination, allergy and safety issues associated with making various brews with one apparatus.

The supply tube is connected to a sterilization tube 288 and controlled by the carbonation valve 285 to provide a supply of germicidal carbon dioxide from the container 287 to the injector 260 to disinfect and dry the supply tube 296, injector 260, foaming chamber and holder 30. Since the container 299 and metering pump 297 cannot be disinfected by the germicidal carbon dioxide, they along with part of the sterilization tube 288 and supply tube 296 close to the metering pump are stored in a chilled chamber or fridge to prevent spoilage of the fluid. It is appreciated that the fluid needle 261 may be adapted to produce a sufficiently large opening on the pod bottom 27 to discharge the brew and fluid, thereby avoiding the need for the outlet needle 63. It is also appreciated that the outlet needle in FIGS. 1 to 7 may be provided with a fluid passageway channel and be connected to the supply tube 296 to introduce a fluid such as milk or flavoring syrup into the pod.

To produce a foamed fluid such as foamed milk for espresso, the fluid needle 261 may have a sufficiently small outlet orifice adapted to convert the fluid from the supply tube 296 into a fluid jet at sufficiently high speed and inject the fluid jet into a foaming chamber to emulsify with the fluid with a volume of air available in the foaming chamber. The foaming chamber may be part of the holder 30 (not shown) or part of the pod as shown in FIG. 1P. In the later case, the fluid needle pierces the pod bottom 27 to make a pierced opening and form at least one air channel between the pierced opening and the fluid needle. The air channel is sufficiently close to the orifice of the fluid needle to cause the fluid jet to draw air into the foaming chamber 258 when the fluid jet jets into the foaming chamber (FIG. 1P). The foamed fluid may be combined with the brew from the brew chamber 58 either in a cup below the holder 30 or in the foaming chamber. The holder may also have an outlet needle 63 for piercing the pod bottom in a way similar to that of FIGS. 1A, 1B, 1C, 1J, 1L, and 4E to discharge the brew and fluid. To prevent clogging, the fluid needle 261 may be made similar to the flow-deflecting needle 85 of FIG. 1V. The orifice for the fluid needle may be normally closed to prevent the entry of the brew material 2 into the needle and be expandable to open by pressure to produce the fluid jet.

To improve the quality of the espresso, the brew catalyzer is adapted to pre-heat the brew cover, pod and holder prior to brewing. To pre-heat, the controller 2 causes the catalyzer 10 to heat to a steam generation temperature and deliver a predetermined amount of water to the catalyzer to generate a predetermined amount of hot steam. The hot steam flows under steam pressure into the brew cover and pod 100 and condenses to release its potent heat to heat the cover, pod and holder to render the brew station and pod ready for brewing espresso. The predetermined amount of hot steam is 0.5 to 7 grams, preferably 1 to 3 grams, for optimum espresso brewing.

The apparatus of FIG. 7 may brew a wide variety of cold brew drinks as a cold brew coffee, espresso, soda, sparkling fruit juices, beer, chewable drink, baby formula or breakfast cereal. When a pod 100 is provided into the holder, the bit group 90 on the pod presses the switch group 34 or 234 (FIG. 1M or 4). Upon receiving the switch states, the controller 2 causes a cold brew path comprising the tank 3, distribution chamber 6, pump 7, path valve 108, cold-water tube 111, cold brew catalyzer 10, first and second natural carbonation chambers 281 and 282, metering filter 14, brew cover 20 and pod 100, to form instantly. For out of home use, the cold-water tube 111 in the apparatus 1 and the resulting cold brew path may be replaced with the cooling tank 110 of FIG. 5 to improve the cold brewing result. Exemplar brewing for several cold brews is described below.

### 1) Cold Brew Coffee

A cold brew coffee pod 100, which is similar to the pod of FIG. 1 or 1A, is provided into the holder 30 in a way similar to that of FIG. 4E or 4F. The controller selects a set of brewing conditions according to the bit group on the pod, causes the cold brew path to form, supplies a small amount of catalyzing energy, e.g. 2.4 watt-hours or 2 kilocalories, to the cold brew catalyzer 10, and instructs the pump 7 to deliver a predetermined amount, e.g. 8 ounces, of cold water through the cold brew path. In a minute, 8 oz cold brew with a temperature of 60-70 degrees Fahrenheit is received into a cup below the holder.

### 2) Cold Brew Espresso

A cold brew espresso pod 100 of FIG. 1P is provided into the holder in a way similar to that of FIG. 4E or 4F. The fluid needle 261 and outlet needle 63 pierce the pod bottom 27. The controller 2 selects a set of brewing conditions according to the bit group on the pod and causes the formation of the cold brew path, the pre-heating of the brew station 300 by 2 grams of hot steam generated by the catalyzer 10, the inputting of a predetermined amount of catalyzing energy, e.g. 2.4 watt-hours, into the catalyzer 10 to catalyze the cold espresso brewing, and the delivering of a predetermined amount, e.g. 2 ounces, of cold water through the cold brew path by the pump 7. The cold brew espresso is dispensed into a 2-oz cup below the holder in 30 seconds.

### 3) Cold Brew Latte, Mocha, and Other Espresso-Based Drinks

To brew a cold brew espresso-based drink such as cold brew latte or mocha, the cold brew espresso may be brewed as described above, but into a 12-oz glass cup rather than a 2-oz cup. The controller then causes the metering pump 297 to deliver a predetermined amount, e.g. 6 ounces, of cold milk from the container 299 to the injector 260. The milk is transformed into foamed milk in the foaming chamber 258 within the pod and dispensed via the outlet needle 63 into the 12-oz cup to combine with the cold brew espresso therein to form latte or mocha. To show the espresso better, the controller may cause the step of delivering the predetermined amount of cold milk to be performed before the step of delivering of a predetermined amount of cold water through the cold brew path, thereby causing the foamed milk to be dispensed into the 12-oz glass cup first.

### 4) Carbonated Drinks Such as Soda, Sparkling Fruit Juice and Beer

A cold brew soda, sparkling apple juice or beer pod 100 is provided into the holder in a way similar to that of FIG. 4E or 4F. The pod comprises a supply of soda syrup, apple juice or beer concentrate 24 in an impermeable cup-shaped container 88 sealed by a film lid 23 and is similar to the pod of FIG. 4E or 4F except that it does not have the cup-shaped filter 87. The controller selects a set of brewing conditions per the bit group, causes the cold brew path to form, causes the pump 7 to deliver a predetermined amount, e.g. 16 ounces, of cold water, and causes the natural carbonator 280 to naturally carbonate the cold water in the cold brew path. The carbonated water is introduced by the inlet needle 85 into the pod to mix with the syrup or concentrate, and the resulting soda, sparkling apple juice or beer is dispensed into a 16 oz cup below the holder in 30 seconds.

5) Chewable Drinks such as Ground Vegetable, Fruit and Bubble Tea

A cold brew chewable drink pod such as a bubble tea, ground vegetable or fruit pod 100 is provided into the holder 30A in a way similar to that of FIG. 4D. The pod may comprise a supply of insoluble brew material 24a such as ground vegetables, fruits, jelly beads and/or fruit cuts and has a design similar to that of FIG. 1I, 1K or 4D. The controller selects a set of brewing conditions per the bit group and causes the cold brew path to form. Per the set of brewing conditions, a predetermined amount, e.g. 12 ounces, of cold water is delivered by pump 7 via the inlet needle 85 into the brew chamber 58 to mix with the brew material therein. The mix is regulated into the transient chamber 59 via the regulator plate 48, and is subsequently dispensed into a cup in a minute.

### 6) Baby Formula, Frappes and Yogurt

A cold brew baby formula, Frappes or yogurt pod 100, which comprises a supply of baby formula, frappes or yogurt mix 24a in the brew chamber 58 and is similar to the pod of FIG. 1I, 1K or 4D, is provided into the holder 30 in a way similar to that of FIG. 4D. The mix may contain nutrient-imbedded gel beads and fruit. The controller chooses a set of brewing conditions per the bit group 90 on the pod and causes the cold brew path to form. A small amount of catalyzing energy, e.g. 2.4 watt-hours, is supplied to the cold brew catalyzer 10 and the pump 7 is turned on to deliver a predetermined amount, e.g. 6 ounces, of cold water via the inlet needle 85 into the brew chamber to mix with the formula powder or yogurt mix 24a and form a viscous gel-like fluid therein. The viscous fluid or gel is regulated into the transient chamber by the regulator plate 48 and is dispensed into a 6 or 8 oz baby feeding bottle or cup below the holder in a minute. The catalyzing energy was found to catalyze the gel formation and allow a bottle or cup of uniform gel-like fluid to be formed within the 1-minute period.

According to an alternative set of brewing conditions for the pod, the controller 2 turns on the pump 7 and causes the path valve 108 to form the hot brew path for a first length of time in order to deliver a hot stream or pulse of water and to form the cold brew path for a second length of time in order to deliver a cold stream or pulse of water through the pod. The volume of water in the hot or cold pulse is equal to the product of the first or second length of time and the flow rate, which is determined by the metering filter 14. The first and second lengths of time are selected so that the temperature of the combined hot and cold pulses of water is 95 degrees Fahrenheit as recommended for babies. For example, if the predetermined or desired formula volume to be brewed from the pod is 180 milliliters, the heating tank 120 is kept at the convection-preventing temperature of 140 degrees, the tank 3 (or cooling tank 110) is 70 degrees Fahrenheit, and the flow rate is 4.5 milliliters per second, the first length of time, i.e. t₁, and second length of time, i.e. t₂, are determined by the following two equations:

4.5*(t₁+t₂)=180 (1)

4.5*t₁*140+4.5*t₂*70=180*95 (2)

The solutions for the above equations are t₁=14.3 seconds for the hot pulse of water and t₂=25.7 seconds for the cold pulse of water. To achieve uniform baby formula temperature in the feeding bottle, a plurality of short alternating hot and cold pulses of water, e.g. a hot pulse of 7.15 seconds plus a cold pulse of 12.85 seconds plus a hot pulse of 7.15 seconds plus a cold pulse of 12.85 seconds, may be delivered to the baby formula pod. Such alternating hot and cold pulses through the hot and cold brew paths may be used to achieve other brew temperatures for other drink or food pods.

### 7) Cereal

A cold brew cereal pod 100 is provided into the holder in a way similar to that of FIG. 4B. The pod has a supply of cereal 24a sealed in a bowl-shaped container 88 by a film lid 23 and is similar to the pod of FIG. 4, except that it further comprises a supply of milk, milk concentrate or powder 202 in a pouch 220 similar to that of FIG. 1K. The controller 2 selects a set of brewing conditions per the bit group 90 on the pod, forms the cold brew path and causes the pump 7 to deliver a predetermined amount, e.g. 8 ounces, of cold water through the cold brew path. The milk, milk concentrate or powder 202 is carried by the cold water to the cereal 24a in the bowl-shaped container 88 in 15 seconds. The controller then causes the natural carbonator 280 to deliver a shot of carbon dioxide via the tube 284 into the pouch 220 to dry the pouch and disinfect the inlet needle 85 and brew station 300. Alternatively, the controller may supply a predetermined amount of heat to the heater 9 to generate and deliver a supply of steam to dry the pouch and disinfect the inlet needle and brew station. After the brew cover is opened, the support spring 185 pushes the pod for easy removal. The film lid 23 and pouch 220 are removed together by pulling the tab 187 to allow one to enjoy the cereal in bowl-shaped container 88.

### 8) Breakfast

A cold brew breakfast pod 100 is provided into the holder in a way similar to that of FIG. 4D. The pod has a supply of breakfast mix 24a in a brew chamber 58 and is similar to the pod of FIG. 1D. The outlet needle 63 and fluid needle 261 of the holder pierce the pod bottom 27. The outlet needle is adapted to push the regulator plate 48 up to form the transient chamber 59 in the pod in a way similar to that of 4D. The fluid needle is adapted to slide though a regulating opening 144 of the regulator 48 into the brew chamber. The controller selects a set of brewing conditions per the bit group on the pod, causes the cold brew path to form, and causes the metering pump 297 of the portioner 290 to deliver a predetermined amount, e.g. 12 ounces, of milk from the fluid container 299 into the brew chamber via the fluid needle 261. The fluid needle atomizes the milk to generate foam to facilitate the flow of the breakfast mix 24a in the brew chamber through the regulator plate 48 into the transient chamber 59. The foamed milk-breakfast mix in the transient chamber is dispensed through the outlet opening 49 and hygiene tube 142 into a receptacle such as a bowl in 30 seconds. The controller then causes the pump 7 to deliver a predetermined amount, e.g. 4 ounces, of cold water through the cold brew path to purge any residual milk and mix out of the pod and causes the valve 285 to open and release a shot of carbon dioxide germicidal gas into the pod via the sterilization tube 288 and fluid needle 261 to disinfect the system.

The apparatus of FIG. 7 may also brew a wide variety of hot brews such as hot coffee, soup, oatmeal, spaghetti, pizza, sandwich, dessert, super food, Chinese herb or espresso drinks. When a hot brew pod 100 is provided into the holder and the brew cover 20 is closed, the bit group 90 on the pod presses the switch group 34 or 234 (FIG. 1M or 4) and the switch states is transmitted to the controller 2. The controller causes a hot brew path comprising the tank 3, distribution chamber 6, pump 7, path valve 108, heating tank 120, catalyzer 10, metering filter 14, brew cover 20 and pod to form. Exemplar brewing for several hot brews is described below.

### 1) Hot Brew Coffee

A hot brew coffee pod is provided into the holder 30 in a way similar to that of FIG. 4E. The controller selects a set of brewing conditions per the bit group on the pod, forms the hot brew path, causes the pump 7 to deliver a predetermined amount, e.g. 8 ounces, of hot water at the convection-preventing temperature through the catalyzer 10, and supplies a predetermined power to the catalyzer to heat the hot water from convection-preventing temperature to the optimum brewing temperature of 195 to 205 degrees Fahrenheit before the hot water is delivered to the pod. In a minute, 8 oz hot coffee is brewed into a cup below the holder.

### 2) Chicken Noodle and Clam Chowder Soup

A hot brew chicken noodle, clam chowder or miso soup pod is provided into the holder in a way similar to that of FIG. 4D. The pod comprises a supply of insoluble brew material 24a, e.g. chicken and noodle, clam and potato, or onion and seaweed, in a brew chamber 58 and is similar to the pod of FIGS. 1I, 1K and 4D. The controller 2 causes the brew catalyzer 10 to generate and deliver a supply, e.g. 10 grams, of hot steam to the pod to quickly cook and infuse moisture into the insoluble brew material 24a in 30 seconds, causes the pump 7 to deliver a predetermined amount, e.g. 15 ounces, of hot water at its convection-preventing temperature through the hot brew path, and supplies predetermined power to the brew catalyzer to heat the hot water from the convection-preventing temperature to a predetermined brewing temperature for the soup per the bit group 90. The brewing water is injected into the brew chamber 58 to blend the soluble and insoluble brew materials 24 and 24a therein. The resulting blend is regulated into the transient chamber 59 via the regulator plate 48 and dispensed via the outlet opening 49 and hygiene tube 142 into a serving bowl below the holder in 30 seconds.

### 3) Hot Oatmeal

A hot brew oatmeal pod 100, which comprises a supply of raisins and oats 24a and brown sugar 24 in a bowl-shaped container 88 and is similar to the pod of FIG. 4, is provided into the holder in a way similar to that of FIG. 4B. The controller 2 selects a set of brewing conditions per the bit group 90, forms the hot brew path, causes the brew catalyzer 10 to generate and deliver a supply, e.g. 7 grams, of hot steam to the pod to quickly cook and infuse moisture into the oats and raisins 24a in 20 seconds, causes the pump 7 to deliver a predetermined amount, e.g. 12 ounces, of hot water through the hot brew path, and supplies a predetermined power to the brew catalyzer to heat the hot water from its convection-preventing temperature to a predetermined brewing temperature per the bit group. The brewing water is injected via the needle 85 into the bowl to blend the brown sugar and steam-cooked oats and raisins for 15 seconds. The pressure releaser 188 opens and releases the pressure in the pod. When the brew cover 20 is opened, the support spring 185 pushes the pod up for easy removal. The controller 2 may turn on a fan or air pump (not shown) to supply ambient air, which flows through the space between the holder 30A and pod sidewall 29, to cool down the pod sidewall prior to pod removal. The film lid 23 is removed via the tab 187 to enjoy the oatmeal cooked in the bowl-shaped container.

### 4) Hot Breakfast

A hot brew breakfast pod, which has insoluble brew material 24a such as oats, grains and/or proteins in a brew chamber similar to that of FIG. 4D, is provided into the holder in a way similar to that of FIG. 4D. The outlet needle 63 and fluid needle 261 of the holder pierce the pod bottom 27. The outlet needle is adapted to push the regulator plate 48 up to form the transient chamber 59. The fluid needle is adapted to slide into a regulating opening 144 of the regulator plate 48 into the brew chamber. The controller selects a set of brewing conditions per the bit group on the pod, causes the hot brew path to form, and causes the brew catalyzer 10 to generate and deliver a supply, e.g. 7 grams, of hot steam via the inlet needle 85 into the brew chamber to quickly cook and infuse moisture into the insoluble brew material for 20 seconds.

The controller 2 then causes the pump 297 of the portioner 290 to deliver a predetermined amount, e.g. 12 ounces, of cold milk from the fluid container 299 to the fluid needle 261, which convert into a high speed fluid jet to atomize and foam the fluid in the brew chamber. In the meantime, the controller causes the brew catalyzer 10 and pump 7 to generate and deliver via inlet needle 85 hot steam into the brew chamber 58 to heat the atomized milk to produce hot foamed milk therein. The hot foamed milk, which has more carrying-power than non-foamed milk, blends with the moisture-infused brew material 24a in the brew chamber and carries the brew material through the regulating openings 144, transient chamber 59, outlet opening 49 and hygiene tube 142 into a cup or bowl below the holder in about 30 seconds. At the end of the brewing, the controller switches the valve 285 to open the sterilization tube 288 for a second to issue a shot of carbon dioxide germicidal gas into the pod via the injector 260 to dry and disinfect the supply tube, injector and brew station.

### 5) Spaghetti Meal

When a hot brew spaghetti meal pod such as a shrimp and tarragon, Mexican taco-bowl, or mushroom and radicchio pod 100 is provided into the holder in a way similar to that of FIG. 4B, the controller 2 selects a set of brewing conditions per a bit group 90 on the pod. The meal pod is similar to that of FIG. 4 and comprises a supply of meal materials 24 and 24a, a plate or bowl-shaped container 88, a film lid 23 to seal the materials in the container, and the bit group to control the cooking conditions to prevent damaging by the energy emitter. The controller causes the brew catalyzer 10 to generate, deliver and inject a supply, e.g. 24 grams, of hot steam deeply into the meal materials through the flow-deflecting needle 85 to quickly cook and infuse moisture into the spaghetti for a minute or two. The controller then causes the first energy emitter 225 to emit 450 watts of infrared light having peak spectral power density around the wavelength of 1,500 nanometers to quickly bake the meal materials to create aroma for 15 seconds and causes the pump 7 and the flow-deflecting needle 85 to inject about 4 ounces of hot water at the convection-preventing temperature deeply inside the meal materials to produce a soup mouth-feel and cool down the meal slightly.

The film lid is adapted to be substantially transparent to infrared within the wavelength range of 1,000 to 3,000 nanometers to prevent heat damaging and is preferably made from green and easily recyclable PP or PET film lid. The steaming and baking may occur simultaneously to save time. The brew cover 20 is then opened to cause the support spring 185 to push the now cooked and hot plate-shaped meal pod up for easy removal. The controller may cause a fan or air pump to introduce air to cool the sidewall 29 of the pod for more comfortable touch prior to its removal. The film lid 23 is removed by pulling the tab 187 to peel the film of the container 88 to cause the aroma to permeate. The spaghetti meal is ready.

### 6) Hot Sandwich

A hot sandwich pod such as a grilled chicken, hamburger or roast beef sandwich pod is similar to the spaghetti meal pod and is also cooked similarly. The sandwich pod comprises a grilled chicken filet, hamburger patty or roast beef that are nestled between two slices of bread 24a, a plate-shaped container 88 having an impermeable pod bottom 27 for receiving the sandwich and a pod rim 28 adapted to sit on the rim 89 of the holder 30, a film lid 23 that seals the sandwich to the container, and a bit group 90 to control the cooking conditions to prevent damaging by the energy emitter. The controller 2 causes the brew catalyzer 10 to generate, deliver and inject via the flow-deflecting needle 85 a supply, e.g. 9 grams, of steam into the space between the two slices of bread to heat and cook the meat therein for a minute. The controller then causes the first energy emitters 225 in the brew cover 20 and the second emitter 230 in the second holder 30A to emit infrared light having the peak spectral power density around the wavelength of 1,400 nanometers to roast the top and bottom slices of bread, respectively, for about 30 seconds until a crispy golden brown-colored crust is formed on both the slices.

Both the plate-shaped container 88 and film lid 23 are substantially transparent to the infrared within the wavelength range of 1,000 to 3,000 nanometers to prevent heat damaging and are preferably made from recyclable polypropylene or polyethylene terephthalate. To achieve optimum cooking, the steaming of the meat between the two slices of bread by the catalyzer 10 by hot steam from the inlet needle 85 and the toasting of the top and bottom slices of bread by the first and second infrared emitters 225 and 230 may occur simultaneously. When the brew cover is opened, the support spring 185 pushes the cooked sandwich pod up for easy removal. The film lid is removed via the tab 187 to cause the aroma to permeate and the color to pop for the sandwich.

### 7) Hot Pizza

A hot brew pizza pod such as a pepperoni, D's taco, veggie, breakfast or calzones pizza pod is similar to the sandwich pod and is also cooked similarly. The pizza pod is comprises a pizza or a slice of pizza 24a, a pouch or plate-shaped container 88 having an impermeable pod bottom 27 for receiving the pizza and a pod rim 28 adapted to sit on the rim 89 of the second holder 30A, a film lid 23 to seal the pizza in the container, and a bit group 90 to control the cooking conditions to prevent damaging by the energy emitter. The controller 2 causes the brew catalyzer 10 to generate, deliver and inject via the flow-deflecting needle 85 a supply, e.g. 5 grams, of hot steam into the pizza to heat and moisturize the pizza for 15 seconds. In the meantime, it causes both the first and second energy emitters to emit infrared light having its peak spectral power density around the wavelength of 1,400 nanometers to toast both the top and bottom surfaces of the pizza for about 45 seconds to bring out aroma and form a crispy light or medium brown-colored crust on both surfaces of the pizza.

Both the container 88 and film lid 23 are substantially transparent to the infrared in the wavelength range of 1,000 to 3,000 nanometers to prevent heat damaging and are preferably made from recyclable PP or PET. The brew cover is opened to cause the support spring 185 to push the pizza pod up for easy removal. The film lid is removed from the container 88 via the tab 187 to cause the aroma to permeate and the color to pop.

### 8) Hot Dessert

A hot brew dessert pod 100 such as crème brulee pod is also cooked in a way similar to that for the sandwich pod. The crème brulee pod is similar to the pod in FIG. 4 and comprises a bowl or ramekin-shaped container 88, a supply of crème brulee 24a, a layer of sugar at least partially crusted to prevent aggregation on the crème brulee, a film lid 23 to seal the crème brulee in the container, and a bit group 90 to control the cooking conditions to prevent the damaging of the film lid. The controller 2 causes the first energy emitter 225 to emit sufficiently powerful infrared light having its peak spectral power density around the wavelength of 1,400 nanometers to melt or at least to cause the layer of sugar on the top of the crème brulee to become crispy and to bring out its characteristic aroma for about a minute. The film lid is transparent to the infrared in the wavelength range of 1,000 to 3,000 nanometers to prevent heat damaging by the first emitter. The brew cover is then opened to cause the support spring 185 to push the dessert pod up for easy removal. The controller may cause the valve 285 to open to introduce a supply of cold carbon dioxide or cold air to the holder to cool the outer surface of the hot brew pod for more comfortable touch prior to opening the cover 20. The film lid is removed via the tab 187 to cause the aroma to permeate and the browned sugar color to pop.

### 9) Hot Super Food and Herb

A hot brew super food or Chinese herb pod, which is identical to the cold brew coffee pod of FIG. 1, is provided into the holder in a way similar to that of FIG. 1A. Chinese herbs and super foods like Chaga are traditionally brewed at near boiling temperature for several hours. By grinding Chaga or other super food to an ultra fine particle size with an average particle size between 150 to 350 micrometers and by grinding the different components in a Chinese herb mix to their respective ultra fine particle sizes with also an average particle size between 100 to 300 micrometers, the Chinese herb and super food pods are able to be brewed in 1 to 5 five minutes with nearly complete extraction. The controller 2 selects a set of brewing conditions according to the bit group on the pod. It then causes the formation of the hot brew path by path valve 108, the creation of extraction pores within the Chinese herb or super food particles by a supply, e.g. 10 grams, of hot steam generated by brew catalyzer 10, the delivering of a first predetermined amount, e.g. 8 ounces, of hot water through the hot brew path by pump 7 in a predetermined time, e.g. 2 minutes, and the supplying of sufficient power to the catalyzer 10 to heat the hot water from its convection-preventing temperature to the optimum brewing temperature for the Chinese herb or super food. The controller 2 may also control the path valve 108 to deliver a second predetermined amount, e.g. 1 ounce, of cold water through the cold brew paths to mix with the first predetermined amount of brew to achieve the desired strength and drink temperature for the Chinese herb or super food.

### 10) Hot Espresso

A hot brew espresso pod 100, which is identical to the cold brew espresso pod of FIG. 1P except its bit group 90, is provided into the holder in a way similar to that of FIG. 4E. The controller 2 selects a set of brewing conditions according to the bit group on the pod. It then causes the formation of the hot brew path by path valve 108, the pre-heating of the brew station 300 by a supply, e.g. 2 grams, of hot steam generated by brew catalyzer 10, the delivering of a predetermined amount, e.g. 2 ounces, of water through the hot brew path by pump 7, and the supplying of sufficient power to the catalyzer to heat the water from its convection-preventing temperature to the optimum hot brewing temperature of 195 to 205 degrees Fahrenheit. The space 257 between the filter 87 and second container 256 is converted to a transient chamber to collect the espresso brewed in the brew chamber 58. The foaming opening 269 transforms the collected espresso into a speedy espresso jet, which becomes foamed in the foaming chamber 258 and is dispensed via the outlet needle 63 into a 2 or 4-oz cup below the holder. The foam rises in the cup to form a golden crema layer on top of the hot brew espresso.

### 11) Hot Latte, Mocha and Other Espresso-Based Drinks

To brew a hot espresso-based drink, the espresso is brewed as the method 10 but dispensed into a large 10 or 12-oz cup. The pod bottom 27 is pierced by both the fluid needle 261 and outlet needle 63. The controller 2 causes pump 297 to deliver a predetermined amount, e.g. 6 ounces, of milk from the container 299 through the injector 260. At the same time it causes the pump 7 and brew catalyzer 10 to generate and deliver hot steam through the inlet needle 85, brew chamber 58 and foaming opening 269 into the foaming chamber 258. The milk is atomized or emulsified by the fluid needle to facilitate the heating by the hot steam and the foaming in the foaming chamber. The heated, foamed milk is dispensed via the outlet needle 63 into the large cup to combine with the hot espresso therein to make a latte or mocha. At the end, the controller causes the valve 285 to open the sterilization tube 288 for seconds to issue a shot of carbon dioxide into the foaming chamber 258 via the injector to disinfect and dry the supply tube 296, injector 260, and brew station 300.

To enable the hot-brew espresso pod to brew a variety of hot espresso-based drinks at various flavors, the bit group 90 on the pod is adapted to determine a set of brewing conditions for brewing hot espresso as described above. Such a bit group may be called a parent bit group. The bit group is also adapted to cooperate with a user interface such as a screen and/or buttons connected to the controller 2 to determine another set of brewing conditions for forming one or more complimentary brews, e.g. foamed milk and foamed flavoring syrup, for the hot espresso. The hot-brew espresso pod, which has the same design as the cold-brew espresso pod of FIG. 1P, is connected to a plurality of containers 299 containing whole milk, skim milk, chocolate milk, vanilla flavored syrup, hazelnut flavored syrup, etc. via the injector 260 and supply tube 296 (FIG. 7). For example, if one selects low-fat, vanilla flavored latte on the screen, the second set of brewing conditions may include delivering 6 ounces of the low-fat milk from a skim milk container 299 through the supply tube 296 and injector 260 into the foaming chamber 258; delivering hot steam at the same time from the brew optimizer 10 through the inlet needle 85, brew chamber 58 and second chamber 257 into the foaming chamber to heat the foamed milk; delivering a shot of the vanilla flavoring syrup through the injector 260 into the foaming chamber; and dispensing the hot foamed milk and foamed vanilla syrup as the two complimentary brews for the hot espresso.

Similarly, a variety of cold brew espresso-based drinks can be brewed with the cold brew espresso pod. The parent bit group 90 determines a set of brewing conditions for the cold brew espresso and cooperates with a screen of the control 2 to determine another set of brewing conditions for forming one or more complimentary brews for the cold brew espresso. A variety of soda-based drinks, oatmeal-based breakfasts, cereal-based breakfasts, soup-based meals, spaghetti-based meals, pizza-based meals, and sandwich-based meals can also be brewed with the respective pods. Their respective parent bit group determines a set of brewing conditions for the base drink or meal, and the bit group cooperates with the screen to determine another set of brewing conditions for forming a complimentary brew for the base drink or meal. As a result, the parent bit group allows one to buy just a base pods to brew a variety of related brews, thereby significantly reducing the need to purchase and store a large variety of pods to minimize waste and increase the freshness of the pods.

To prevent potential misuse of a cold brew pod such as a baby formula pod in a hot K-Cup® brewer, which could brew a bottle of baby formula too hot for babies, the bit surface 192 or at least one bit in the bit group 90 on the cold brew pod is made sufficiently large to prevent the cold brew pod from being inserted fully into the holders of such K-Cup® brewers. To prevent potential misuse of the cold brew pod in the apparatus 1 of the prevent invention, the cold brew pod may comprise a cold brew bit, which may be positioned within or apart from the rest of the bits in the bit group, to prevent the delivery of hot water through the cold brew pod or prevent the formation of the hot brew path. The cold brew bit either mechanically controls the path valve 108 or a cold water switch (not shown) located in the brew cover or holder or electrically controls the path valve to prevent hot water from being delivered to the cold brew pod. To provide users ultimate control, the apparatus 1 of FIGS. 1 to 7 may further comprise a manual switch such as a button or knob adapted for one to control whether cold water or a cold brew path should be used to brew a particular pod.

On the other hand, consumers may desire to brew K-Cup® and other hot coffee pods that may not contain any bit group in the apparatus 1 of FIGS. 1 to 7. Such hot coffee pods have no down or up bits and may be read by the bit group reader 34 to provide values or switch states 000 to the controller 2. To allow the apparatus 1 to accept hot coffee pods both with and without the bit group 90, the bit group for the hot brew coffee pod should consist of only the up bits or the like having values or switch states of 000 if the up bit is assigned a value 0. In addition, the holder 30 is adapted to have sufficiently rounded corners 193, as shown in FIGS. 1N and 1Q, to allow the holder to accept not only the pods having a square cross-section similar to that of FIG. 1O but also the pods having a round cross-section similar to those of FIG. 1D for the prior-art K-Cup® pods.

To allow the apparatus of FIG. 7 to brew another hot brew pod immediately after a first hot brew pod is brewed, the heating tank 120 is adapted to supply hot water at the convection-preventing temperature towards the pod and generate new hot water at the convection-preventing temperature simultaneously. This resolves the cup-to-cup wait time issue for the prior-art brewers such as those under Keurig® and Bunn® MCD brands taught by Beaulieu and Streeter et al. in U.S. Pat. Nos. 6,082,247, 6,142,063, 7,523,695 and 7,398,726. Such elimination of the cup-to-cup wait time is made possible because the convection-preventing temperature prevents the heat-induced convective mixing of water when the heating tank 120 generates the new hot water by heating the cold water introduced into the heating tank to the convection-preventing temperature with the heater 125 during the brewing of the first cup. The inlet and outlet distributors 124 and 123 minimize the flow-induced mixing during the delivery of the cold water into and hot water out of the heating tank. To further prevent the flow-induced mixing, a thin vertical plate 129 is provided between the inlet and outlet distributors as shown in FIG. 7.

As used herein, “brew” refers to any solid or liquid substance in a cup, bowl, plate or container formed when a liquid, steam, gas, heat and/or energy beam interacts with a supply of solid and/or liquid material in the pod or with any component of the pod. The solid and/or liquid material in the pod is called brew material. The apparatus 1 is used to form various brews through such interaction. Terms such as brewing, cooking, extracting, dissolving, filtering, delivering or mixing may be used interchangeably in the description and claims of the invention to describe the interaction of the brew material or other component of the pod with the liquid, steam, gas, heat and/or energy beams from the apparatus. Though some pods may include features that enhance the operation of apparatus 1, the pod may be a single use or reusable pod and may take any suitable form such as those commonly known as a cup, bowl, plate, sachet, pouch, cartridge, capsule, container or other. Certain brew material may be provided in the pod to react with each other or with a liquid to form a new material.

Having thus described several aspects of the various embodiments of this invention, it is to be appreciated various alterations, modifications, and improvements will readily occur to those skilled in the art. Such alterations, modifications, and improvements are intended to be part of this disclosure, including any accompanying claims, abstract, and drawings, and are intended to be within the spirit and scope of the invention. Any element in a claim that does not explicitly state “means for” performing a specified function, or “step for” performing a specific function, is not to be interpreted as a “means” or “step” clause as specified in 35 U.S.C. sctn. 112, paragraph 6. In particular, the use of “step of” in the claims herein is not intended to invoke the provisions of 35 U.S.C. sctn. 112, paragraph 6. Accordingly, the foregoing description and drawings are by way of example only.

What is claimed is:

1. An apparatus for use in forming a brew, said apparatus comprising: a controller; a water tank for providing water used in forming a brew; a pump in electrical communication with the controller and in fluid communication with the water tank; a holder for receiving a supply of brew material; a brew cover arranged to cooperate with the holder to at least partially cover the holder and introduce water to the brew material; and a brew catalyzer for catalyzing interaction between the brew material and water, the brew catalyzer including a catalyzation chamber in fluid communication with the pump and brew cover and a first heater in electric communication with the controller, the catalyzation chamber being constructed and configured to cooperate with the controller and first heater to provide water in at least one of first, second and third states to the brew material, wherein the first, second and third states are cold water, hot water and hot steam, respectively, the brew catalyzer being constructed to be activated by an amount of catalyzing energy to reach an activated state, wherein the brew catalyzer in the activated state cooperates with the pump to deliver sufficient amount of water in the first state to the brew material in the holder and catalyzes the interaction between the brew material and water to form a single serve of cold brew of sufficient brew strength in approximately a minute.

2. The apparatus of claim 1, wherein the brew catalyzer is adapted to receive the amount of catalyzing energy from a car cigarette lighter or battery to reach the activated state to form the single serve of cold brew.

3. The apparatus of claim 1, wherein the predetermined amount of catalyzing energy is less than 8 watt-hours.

4. The apparatus of claim 1, further comprising a second heater connected to the controller for heating the water in the water tank for a hot brew, the second heater being constructed and configured to cooperate with the controller to heat and maintain the water in the water tank at a child-safe temperature to transform the apparatus into a child-safe family or hotel in-room brewer, the child-safe temperature being a temperature of hot water in the water tank that is safe for a child to touch, thereby preventing hot water burning if a child accidently spills the hot water in the water tank, wherein the first heater is constructed and configured to cooperate with the pump to heat the hot water from the child-safe temperature to a brewing temperature for the brew material as the pump delivers the hot water from the water tank through the catalyzation chamber, thereby minimizing wait time for brewing a hot brew.

5. The apparatus of claim 1, wherein the catalyzation chamber has a heat capacity sufficiently small to achieve a sufficiently low temperature for the cold brew.

6. The apparatus of claim 1, wherein the holder is adapted to receive a pod having a container, a supply of brew material in the container, and a lid that seals the container to form a brew chamber for the brew material.

7. The apparatus of claim 1, wherein the controller is adapted to cause the brew catalyzer to provide the water in the third state to pre-heat the brew cover and holder prior to forming a brew.

8. A method of producing a cold brew, said method comprising: a) providing a supply of brew material into a holder; b) closing a brew cover to at least partially cover the holder; c) providing sufficient amount of catalyzing energy to a brew catalyzer to activate the brew catalyzer; d) delivering an amount of water in a cold state to and through the brew material and brew catalyzer in an activated state to catalyze interaction between the brew material and water; and e) dispensing a cold brew resulting from the catalyzed interaction of the brew material and water in the cold state into a cup or other receptacle below the holder, wherein the sufficient amount of catalyzing energy is sufficiently small to cause the resulting cold brew received in the receptacle to be sufficiently cold.

9. The method of claim 8, wherein the steps of providing an amount of water and dispensing a cold brew are completed in approximately a minute.

10. The method of claim 8, wherein the supply of brew material is in a form of sufficiently fine grinds having an average grind size smaller than 475 micrometers for at least one dimension of the sufficiently fine grinds.

11. The method of claim 8, wherein the step of providing a supply of brew material comprises providing a pod having a filter, a lid and a supply of brew material enclosed between the filter and lid.

12. The method of claim 8, wherein the amount of water in the step of providing an amount of water is sufficiently small to produce a cold brew espresso, said method further comprising providing a supply of steam to the brew cover and holder prior to the step of providing an amount of water.

13. The method of claim 8, wherein the step of providing an amount of water comprises providing a first amount of water to the brew material and then providing a second amount of water to and through the brew material, the second amount of water being substantially larger than the first amount of water.

14. The method of claim 13, wherein the first amount of water is provided at an average flow rate substantially slower than the second amount of water.

15. A pod for use in forming a cold brew with a supply of cold water in approximately a minute, said pod comprising: a supply of brew material; a container defining a space having first and second portions, the container having a rim, a sidewall, and an access opening surrounded by the rim; a lid adapted to cover the access opening and produce a brew chamber to store the brew material in the first portion of the space, the lid being adapted to receive an injection of cold water in at least one cold water stream into the first portion of the space; a filter at least partially located in the space for controlling interaction between the brew material and the at least one cold water stream injected into the first portion of the space to form a cold brew, the filter separating the first and second portions of the space so that the cold brew produced in the first portion of the space flows through the filter to pass to the second portion of the space; wherein the brew material is in the form of grinds that are sufficiently fine to have an average grind size smaller than 475 micrometers for at least one dimension of the grinds to facilitate the interaction between the brew material and the at least one cold water stream; wherein the filter is constructed and arranged to withstand the injection of cold water under a pressure that is sufficiently high to force sufficient amount of cold water through the brew material in the brew chamber to form a single serve of cold brew in approximately a minute; and wherein the filter is constructed and arranged to cooperate with the container and supply of brew material to prevent the at least one cold water stream from channeling through the filter into the second portion of the space.

16. The pod of claim 15, wherein the filter is positioned sufficiently close to an impermeable wall that the at least one cold water stream or the pressure of the cold water can push the filter to contact the impermeable wall to prevent the at least one cold water stream from channeling through the filter, thereby achieving sufficient brew strength for the cold brew.

17. A method of using the pod of claim 15, said method comprising providing a first amount of water to the brew material and then providing a second amount of water to and through the brew material in the brew chamber, the second amount of water being substantially larger and colder than the first amount of water.

18. An apparatus for use in forming a brew, said apparatus comprising: a water tank adapted to hold water used in forming a brew; a distribution chamber adapted to connect to the water tank; a holder adapted to receive a supply of brew material; a brew cover arranged to cooperate with the holder to at least partially cover the holder and introduce water to the brew material; a controller; a heating tank having an inlet in fluid communication with the distribution chamber, an outlet in fluid communication with the brew cover and a first heater connected to the controller for heating the water in the heating tank; a cold-water tube in fluid communications with the distribution chamber and brew cover; a pump in electrical communication with the controller and in fluid communication with at least one of the distribution chamber and cold-water tube; and a path valve for forming one of hot and cold brew paths, the hot brew path comprising the path valve, heating tank and brew cover for allowing the pump to deliver an amount of hot water into the holder to interact with the supply of brew material therein to brew a hot brew, the cold brew path comprising the path valve, cold-water tube and brew cover for allowing the pump to deliver an amount of cold water into the holder to interact with the supply of brew material therein to brew a cold brew.

19. The apparatus of claim 18, wherein the path valve is adapted to form the hot brew path to deliver hot water into the holder to interact with the brew material to brew a hot brew for a first length of time and to form the cold brew path to deliver cold water into the holder to interact with the brew material to brew a cold brew for a second length of time, wherein the holder is adapted to dispense the hot and cold brews into a receptacle below the holder, the temperature of the resulting brew being determined by the first and second lengths of time.

20. The apparatus of claim 18, wherein the path valve is adapted to first form the hot brew path to cause the brew material to interact the hot water for a first length of time and then form the cold brew path to cause the brew material to interact the cold water for a second length of time, the second length of time being sufficiently long to form a cold brew of sufficiently cold temperature.

21. The apparatus of claim 18, wherein the holder is adapted to receive a pod comprising a supply of brew material, a filter, and a lid that seals the brew material between the filter and lid, the brew material being coffee beans ground sufficiently fine to have an average grind size smaller than 475 micrometers, the filter being constructed and configured to cooperate with the sufficiently finely ground coffee beans and lid to prevent hot or cold water from channeling through the filter to achieve sufficient brew strength for the hot or cold brew to meet the brew strength requirement of the Golden Cup Standard defined by the Specialty Coffee Association.

22. The apparatus of claim 18, wherein the controller is adapted to cause the first heater to heat the water in the heating tank to a convection-preventing temperature and to maintain the water at the convection-preventing temperature, the convection-preventing temperature being selected to be a water temperature before the first heater causes significant convective flow during the heating, thereby making the apparatus to consume little energy to maintain the water at the convection-preventing temperature in the heating tank.

23. The apparatus of claim 22, wherein the holder is adapted to receive first and second pods at separate times, each of the first and second pods comprising a supply of brew material, wherein the heating tank further has an inlet distributor connected to the inlet and positioned near the bottom of the heating tank, the heating tank being constructed and configured to cooperate with the pump to introduce the water from the water tank into the heating tank via the inlet distributor to force the hot water at the convection-preventing temperature out of the outlet into the first pod held in the holder via the hot brew path and to heat the water from the water tank to the convection-preventing temperature simultaneously, thereby rendering the apparatus ready to brew the second pod immediately after the first pod is brewed, wherein the hot brew path further comprises a second heater to heat the hot water from the convection-preventing temperature to a brewing temperature for the brew material.

24. The apparatus of claim 18, further comprising a support base for housing the distribution chamber and for removably receiving the water tank, wherein the distribution chamber is sufficiently large to receive a water filter cartridge, the distribution chamber being constructed and configured to make the water filter cartridge held by the distribution chamber readily accessible by hand when the water tank is removed from the support base, thereby facilitating the removal and replacement of the water filter cartridge.

25. The apparatus of claim 24, wherein the water filter cartridge comprises an inlet chamber adapted to removably receive a tank outlet of the water tank and to form a watertight seal with the tank outlet.

26. The apparatus of claim 18, further comprising an air-water separation chamber having an inlet port for receiving air and water from the heating tank, an air outlet, and a water return tube having a first end connected to the separation chamber and a second end connected to the distribution chamber, the separation chamber being sufficiently large to separate the air and water from the heating tank and to release the air via the air outlet and return the water into the distribution chamber via the water return tube.

27. The apparatus of claim 18, further comprising a flow actuator for removing air and excess water in the heating tank, the flow actuator comprising a actuation chamber, a chamber inlet connected to a vent outlet of the heating tank, a chamber outlet in fluid communication with the water tank, and a sealer movable up and down in the actuation chamber and adapted, the sealer being adapted to move up to seal the chamber outlet when the water flow into the actuation chamber becomes sufficiently fast to balance the weight of the sealer.

28. The apparatus of claim 18, further comprising a supply tube connected to at least one portioner to provide at least one fluid, wherein the holder comprises a fluid needle connected to the supply tube to introduce the at least one fluid from the supply tube to the brew.

29. The apparatus of claim 28, wherein the holder is adapted to receive a pod having an impermeable bottom, a lid and a brew chamber between the impermeable bottom and lid to receive a supply of brew material, wherein the fluid needle is adapted to pierce the impermeable bottom to introduce the at least one fluid into the pod.

30. The apparatus of claim 28, further comprising a sterilization tube connected to the supply tube to provide a supply of germicidal carbon dioxide gas to the fluid needle to disinfect the supply tube, fluid needle and holder.

31. The apparatus of claim 28, wherein the fluid needle is adapted to convert the fluid from the supply tube into a fluid jet at sufficiently high speed and to introduce the fluid jet into a foaming chamber adapted to emulsify the fluid jet to produce a foamed fluid for the hot or cold brew.

32. The apparatus of claim 28, wherein the fluid needle comprises an expandable opening to introduce the at least one fluid from the supply tube to the hot or cold brew, the expandable opening being substantially closed when there is no pressure upstream to prevent the brew or brew material from clogging the fluid needle.

33. The apparatus of claim 18, further comprising a cooling tank in the cold brew path and having an inlet connected to the cold-water tube, a chiller for cooling an amount of water and maintaining the chilled water at a predetermined temperature in the cooling tank, a tank outlet in fluid communication with the brew cover.

34. The apparatus of claim 33, further comprising an air pump connected fluidly to the cooling tank and electrically to the controller and adapted to pressurize the cooling tank to deliver a metered volume of water therein to the path valve, wherein the path valve is connected to the outlet of the cooling tank, the inlet of the heating tank and a valve tube in communication with the brew cover, the path valve being constructed and configured to cooperate with the controller and air pump to form the cold brew path to brew a metered volume of cold brew by connecting the outlet of the cooling tank to the valve tube and to form the hot brew path to brew a metered volume of hot brew by connecting the outlet of the cooling tank to the inlet of the heating tank.

35. An apparatus having a flow-deflecting needle for delivering an amount of fluid into a supply of brew material or a pierceable object, said flow-deflecting needle comprising: a needle inlet adapted to receive a fluid; a cutter adapted to pierce and penetrate into the supply of brew material or pierceable object; a needle outlet spaced apart from the cutter and positioned a predetermined distance away from the cutter for issuing a stream of fluid into an interior of the supply of brew material or pierceable object; a fluid passageway channel between the needle inlet and the needle outlet; and a connector for connecting the cutter to the needle outlet, wherein the connector being constructed and arranged to cooperate with the cutter to prevent the brew material or pierceable object from being pushed into the needle outlet and fluid passageway channel when the cutter penetrates into the supply of brew material or pierceable object.

36. The apparatus of claim 35, further comprises a holder adapted to receive a supply of brew material, the brew material including at least one of sandwich, pizza, meat, soup, bread, vegetable, spaghetti, oatmeal, grains, and powders; a heater adapted to provide a supply of hot fluid to the needle inlet, the hot fluid including at least one of hot steam, hot air and hot liquid; and a brew cover containing the flow-deflecting needle, wherein the brew cover being constructed and arranged to cooperate with the holder to at least partially cover the holder and to cause the flow-deflecting needle to penetrate into the supply of brew material, wherein the needle outlet introduces the hot fluid under pressure into an interior of the supply of brew material and causes the hot fluid to diffuse or flow from the interior outwards to heat and cook the brew material from the inside to the outside.

37. The apparatus of claim 36, wherein the holder is adapted to receive a pod comprising a supply of brew material.

38. The apparatus of claim 35, wherein the cutter comprises a deflecting surface to deflect or redistribute the stream of fluid from the needle outlet, thereby causing at least part of the stream of fluid to flow at a direction different from the initial direction for the stream of fluid.

39. The apparatus of claim 35, wherein the cutter is positioned below a center of the needle outlet and is sufficiently large to prevent the brew material from being pushed into the needle outlet and fluid passage channel when the cutter penetrates into the supply of brew material or pierceable object.

40. The apparatus of claim 35, wherein the fluid passageway channel increases in size substantially at the direction from the needle inlet to the needle outlet to prevent clogging of the fluid passageway channel.

41. The apparatus of claim 35, further comprising a filter located inside the fluid passageway channel, the filter comprising at least one expandable opening adapted to expand in size by the differential pressure between the upstream and downstream of the at least one expandable opening.

42. The apparatus of claim 35, wherein the flow-deflecting needle further comprises an orifice sufficiently small to convert a liquid from the needle inlet into a liquid jet at a sufficiently high speed, the orifice being positioned directly over the cutter to cause the sufficiently high speed liquid jet to impinge onto the cutter to emulsify the liquid with a gas to produce a foamed liquid.

43. An apparatus for delivering a fluid, said apparatus comprising a liquid tank for holding a supply of liquid, a utilization station, and a self-refreshing filter in fluid communications with the liquid tank and utilization station, said self-refreshing filter comprising: a filtration chamber in fluid communications with the liquid tank and utilization station; a filter base connected to the filtration chamber; and first and second lips connected to the filter base and arranged to cooperate with the base to form first and second openings to control the flow through the self-refreshing filter, at least one of the first and second lips being movable relative to the filter base to cause at least the second opening to change in size to modulate the flow resistance and passage of solids through the self-refreshing filter in response to a change in the pressure upstream of the self-refreshing filter.

44. The apparatus of claim 43, wherein the utilization station comprises a holder adapted to receive a pod and a brew cover in fluid communication with the self-refreshing filter and arranged to cooperate with the holder to at least partially enclose the pod to introduce a fluid into the pod.

45. The apparatus of claim 44, wherein the brew cover has an inlet needle comprising a needle inlet in communication with the liquid tank, a needle outlet for injecting the fluid into the pod, and a fluid passageway channel between the needle inlet and outlet, wherein the self-refreshing filter is located inside the fluid passageway channel of the inlet needle.

46. The apparatus of claim 44, wherein the first and second lips are adapted to cause a first flow resistance, wherein the pod comprises a supply of brew material adapted to cause a second flow resistance, the first flow resistance being sufficiently higher than the second flow resistance so that the flow rate through the pod is substantially constant when the brew material varies.

47. The apparatus of claim 43, wherein the first and second lips are sufficiently long to produce a sufficiently high flow resistance through the self-refreshing filter to cause the self-refreshing filter to provide the liquid at a substantially constant flow rate to the utilization station.

48. The apparatus of claim 43, wherein the first opening is located upstream of the second opening, wherein the at least one of the first and second lips is sufficiently movable so that the second opening becomes sufficiently small to prevent the passage of solids when there is vacuum upstream of the self-refreshing filter and becomes sufficiently large to allow a fluid to flush away any solids in the self-refreshing filter when there is pressure upstream of the self-refreshing filter.

49. The apparatus of claim 48, further comprising a pump in fluid communication with the liquid tank and the self-refreshing filter, the pump being adapted to produce a revival pressure sufficiently higher than a normal operation pressure of the pump to move the at least one of the first and second lips farther apart to cause the fluid to flush away any extra large solids in the self-refreshing filter.

50. The apparatus of claim 43, wherein the second opening is located upstream of the first opening to cause the at least one of the first and second lips to move to reduce the distance between the lips to increase the flow resistance through the self-refreshing filter when the pressure upstream increases, thereby canceling the effect of the pressure increase on the flow rate and keeping the flow rate substantially constant.

51. The apparatus of claim 50, wherein the self-refreshing filter is adapted to allow the second opening to move between a first position in which the second opening is upstream of the first opening to achieve the substantially constant flow rate and a second position in which the second opening is downstream of the first opening to allow the second opening to expand and the liquid to flush away any solids caught in the self-refreshing filter.

52. The apparatus of claim 51, further comprising a movable body having a through-opening for receiving the filter base and first and second lips, the movable body being received in the filtration chamber and adapted to move the second opening between the first and second positions.

53. An apparatus for forming a brew from a pod, said apparatus comprising: a water tank adapted to hold water used in forming a brew; a holder adapted to receive a pod comprising a supply of brew material and a lid that covers and seals the pod; a natural carbonator comprising a first natural carbonation chamber in fluid communication with the water tank and a nozzle in fluid communication with a carbon dioxide container adapted to provide a supply of carbon dioxide under pressure, the nozzle being housed in the first natural carbonation chamber and having an orifice pointed at a direction of a stream of water that flows in the first natural carbonation chamber, wherein the orifice is constructed and configured to form a speedy stream of carbon dioxide within the stream of water, wherein the streams of carbon dioxide and water travel together in the first natural carbonation chamber to cause the carbon dioxide in the speedy stream of carbon dioxide to be absorbed naturally into water in the stream of water, thereby causing water to be naturally carbonated to form a stream of naturally carbonated water, the first natural carbonation chamber being sufficiently long to cause the speedy stream of carbon dioxide to become significantly smaller in size as the speedy stream of carbon dioxide travels downstream inside the stream of water; and a brew cover having a fluid inlet in communication with the first natural carbonation chamber and arranged to cooperate with the holder to at least partially enclose the pod and introduce the naturally carbonated water to the brew material in the pod held by the holder, wherein the fluid inlet is configured to access the pod and charge the pod with the naturally carbonated water so as to mix the naturally carbonated water with the brew material in the pod to form a carbonated brew.

54. The apparatus of claim 53, further comprising a restrictive opening downstream of the first natural carbonation chamber, the opening being sufficiently restrictive to restrict the flow of the stream of water to cause a backpressure to form in the first natural carbonation chamber, wherein the backpressure reduces the size of the stream of carbon dioxide in the stream of water to facilitate formation of the stream of naturally carbonated water, wherein the brew material in the pod includes at least one of ground fruit, ground vegetable, ground grains, fruit cubes, fruit juice concentrate, soda syrup, beer concentrate, alcohol, proteins, beverage powder, jelly beads, tea, and ground coffee for interaction with the naturally carbonated water to form a naturally carbonated drink.

55. The apparatus of claim 53, wherein the natural carbonator further comprises a second natural carbonation chamber connected to the first natural carbonation chamber to further carbonate the naturally carbonated water as the stream of naturally carbonated water and remaining stream of carbon dioxide from the first natural carbonation chamber travel together in the second natural carbonation chamber, at least part of the second natural carbonation chamber being substantially co-axial with the orifice of the nozzle to facilitate further carbonation of the naturally carbonated water.

56. The apparatus of claim 53, wherein the orifice is sufficiently small to cooperate with the first natural carbonation chamber to convert the pressure of the carbon dioxide from the carbon dioxide container into heat and velocity for the stream of water in the first natural carbonation chamber to prevent the pressure from damaging seals and other components of the apparatus.

57. The apparatus of claim 53, further comprising a cooling tank in fluid communication with the water tank and first natural carbonation chamber, wherein the cooling tank is adapted to modify the temperature of the water therein to a predetermined temperature.

58. The apparatus of claim 53, wherein the natural carbonator further comprises a carbonation valve adapted to cause the streams of carbon dioxide and water to form substantially simultaneously in the first natural carbonation chamber, the valve controlling carbonation level in the stream of naturally carbonated water.

59. The apparatus of claim 53, wherein the first natural carbonation chamber has a sufficiently small cross-section area or diameter to cause the speedy stream of carbon dioxide to draw water from the water tank into the first natural carbonation chamber to form a stream of water, to cause the speedy stream of carbon dioxide to travel together and within the stream of water to form a stream of naturally carbonated water, and deliver the naturally carbonated water via the fluid inlet into the pod.

60. The apparatus of claim 53, further comprising a supply tube connected to at least one portioner comprising a fluid container to provide at least one fluid to the naturally carbonated brew, the at least one fluid being substantially different from the naturally carbonated water.

61. The apparatus of claim 60, wherein the holder comprises a fluid needle connected to the supply tube and adapted to pierce the pod to introduce the at least one fluid into an interior of the pod.

62. The apparatus of claim 60, further comprising a sterilization tube in fluid communication with the carbon dioxide container and the supply tube to provide a supply of germicidal carbon dioxide gas to disinfect the supply tube and holder.

63. A method for using the system 53 to make a naturally carbonated drink comprising: providing a pod into a holder; forming a stream of water; forming a stream of carbon dioxide within the stream of water; causing the streams of carbon dioxide and water to travel together for a sufficiently long period of time to cause carbon dioxide to be naturally absorbed into water to form a stream of naturally carbonated water; and introducing the stream of naturally carbonated water into the pod to form the naturally carbonated drink.

64. An apparatus for forming a brew, the apparatus comprising: a liquid tank for holding liquid used in forming a brew; a pump in fluid communication with the liquid tank; a first holder having a first rim and a first opening defined by the first rim and arranged to engage with a pod placed in the first opening; a second holder having a second rim, a second opening defined by the second rim and arranged to engage with a pod placed in the second opening, and a bottom wall; a brew cover in fluid communication with the pump and arranged to cooperate with the first and second holders to at least partially enclose a pod held by one of the first and second holders to introduce a fluid into the pod for interaction with a supply of brew material in the pod to form a brew; wherein the second holder is substantially larger than the first holder and is adapted to at least partially enclose the first holder; and wherein the first opening is movable relative to the bottom wall of the second holder between first and second positions based on a size, height and/or shape of a pod held by the first or second holder, the first and second positions being within a space defined by the second opening and bottom wall of the second holder, the second position being substantially closer to the bottom wall of the second holder than the first position.

65. The apparatus of claim 64, wherein the first opening in the first position is spaced sufficiently apart from the second opening to allow the second opening to receive a first sufficiently large pod that is too large to be received into the first opening.

66. The apparatus of claim 65, wherein the first opening in the second position is spaced sufficiently apart from the second opening to allow the second opening to receive a second sufficiently large pod that is too large to be received by the first opening, the first and second sufficiently large pods being received by the second opening at separate times, the second sufficiently large pod being substantially taller than the first sufficiently large pod.

67. The apparatus of claim 66, further comprising a needle connected to the bottom wall for piercing the second sufficiently large pod, wherein the first position is spaced sufficiently apart from the needle to prevent the first sufficiently large pod from being pierced by the needle.

68. The apparatus of claim 64, wherein the first opening is adapted to be in the first and second positions to receive first and second sufficiently small pods, respectively, at separate times, the first and second pods being sufficiently small to be receivable into the first opening and having substantially different heights.

69. The apparatus of claim 64, further comprising a spring having a first end connected to the first rim of the first holder and a second end connected to the second holder.

70. The apparatus of claim 69, wherein the spring is adapted to be sufficiently compressible to allow the weight of a large pod, which has a size too large to be received into the first opening, to compress the spring and move the first opening a sufficient distance away from the second opening to cause the large pod to enter the second opening sufficiently deeply to prevent the large pod from falling off when the brew cover is open.

71. The apparatus of claim 64, wherein the brew cover comprises a head movable relative to a top wall of the brew cover between a first position when a first pod of a first height is provided and a second position when a second pod of a second height is provided into the first holder, thereby allowing the first holder to accept pods of different heights.

72. The apparatus of claim 64, wherein the bottom wall of the second holder is adapted to be movable relative to the second opening between a first position when a first pod of a first height is provided and a second position when a second pod of a second height is provided into one of the first and second holders, thereby allowing at least one of the first and second holders to accept pods of different heights.

73. The apparatus of claim 64, wherein the second holder further comprises an emitter to adapted to emit energy beams substantially transparent to the bottom of the pod held in the first or second holder to prevent the pod from being damaged or melted, thereby causing the brew material in the pod to be cooked from outside in.

74. The apparatus of claim 64, wherein the brew cover comprises an emitter to adapted to emit energy beams substantially transparent to the lid of the pod held in the first or second holder to prevent the lid from being damaged or melted, thereby causing the brew material in the pod to be cooked from the outside to the inside.

75. A method for using the apparatus of claim 64 to form a brew, said method comprising providing a pod that is too large to be received into a first opening of a first holder onto a first rim of the first holder, and moving the first opening towards a bottom wall of a second holder to one of the first and second positions of the first opening based on a size, height and/or shape of the pod.

76. An apparatus for forming a brew, said apparatus comprising: at least one heater for producing a hot fluid, the hot fluid including at least one of hot steam, hot air, and hot water; a holder for receiving a supply of brew material, the brew material including at least one of a sandwich, pizza, meat, soup, bread, vegetable, spaghetti, oatmeal, grains, powders, and ground coffee; a brew cover having a needle, the needle comprising a needle inlet adapted to receive the hot fluid produced by the at least one heater, a needle outlet adapted to introduce the hot fluid to the brew material, and a fluid passageway channel between the needle inlet and needle outlet, the brew cover being constructed and arranged to cooperate with the holder to at least partially enclose and insulate the brew material in the holder to prevent energy loss; and at least one energy emitter formed in at least one of the holder and brew cover; wherein the needle is sufficiently long to penetrate sufficiently deeply into an interior of the supply of brew material and is constructed and configured to cooperate with the at least one heater and holder to introduce the hot fluid under pressure into the interior of the brew material and to cause the hot fluid in the interior to permeate or flow outwards to cook or brew the supply of the brew material from the inside to the outside, thereby achieving energy efficiency; wherein the at least one energy emitter is constructed and configured to bake, toast or roast an outer surface of the supply of brew material and to cook or brew the supply of brew material from the outside to the inside, thereby achieving desired aroma, color and crispness.

77. An apparatus for forming a brew, said apparatus comprising: a liquid tank adapted to provide liquid used in forming a brew; a pump in fluid communication with the liquid tank; a holder having a rim, an opening defined by the rim and arranged to engage with a pod placed in the opening, and a bottom wall; and a brew cover having a fluid inlet in fluid communication with the pump and arranged to provide a fluid for interaction with a supply of brew material in a pod held by the holder to form a brew and a seal gasket arranged to at least partially seal the pod; wherein at least one of the brew cover and holder is movable relative to each other between an open position in which the holder is exposed for receiving a pod into the opening and a closed position in which the brew cover cooperates with the holder to form a pod chamber between the seal gasket and bottom wall to at least partially enclose a pod for formation of a brew using the pod; wherein the pod chamber is adapted to change in height to form a short or tall pod chamber based on a size, height, and/or shape of a pod held by the holder; and wherein the holder further comprises an outlet for the brew formed in the pod, the outlet being shared by the short and tall pod chambers.

78. The apparatus of claim 77, wherein the outlet includes an outlet needle connected to the bottom wall and adapted to form a brew opening for the brew in the pod to discharge the brew into a receptacle.

79. The apparatus of claim 77, wherein the bottom wall is adapted to be movable relative to the opening between first and second positions to form the short and tall pod chambers when short and tall pods are provided into the holder, respectively.

80. The apparatus of claim 79, wherein the bottom wall is adapted to move up and down relative to the opening, thereby causing the distance between the first and second positions to be substantially equal to the difference in height between the short and tall pods.

81. The apparatus of claim 79, further comprising a locker adapted to lock the position of the bottom wall when the bottom wall is in the first position for brewing a short pod and a trigger adapted to be trigged by a tall pod to unlock the locker and allow the bottom wall to move to the second position for brewing the tall pod.

82. The apparatus of claim 77, wherein the brew cover further comprises a movable head adapted to be movable relative to a top wall of the brew cover between first and second positions to form the short and tall pod chambers when short and tall pods are provided into the holder, respectively.

83. An apparatus for delivering a fluid comprising a needle and a shield for preventing the needle from injuring a child, said needle having one end connected to a base and another end having a sharp tip or cutter adapted to pierce an object, said shield comprising: a shield plate for covering the sharp cutter to prevent the sharp cutter from contacting and injuring a child; a shield spring having a first end connected to the base and a second end connected to the shield plate; wherein the shield plate is adapted to allow at least part of the needle to pass through, the at least part of the needle including the sharp tip or cutter; and wherein the shield plate is adapted to move between a first position in which the shield plate covers the sharp tip or cutter of the needle, thereby preventing the sharp cutter from injuring a child, and a second position in which at least the sharp cutter of the needle is exposed to pierce an object.

84. The apparatus of claim 83, further comprising a liquid tank for providing liquid used in forming a brew; a holder adapted to receive a pod comprising a supply of brew material, a bottom, and a lid that covers and seals the pod; and a brew cover in communication with the liquid tank and arranged to cooperate with the holder to at least partially enclose the pod and introduce a fluid into the pod to cause the fluid to interact with the brew material to form a brew, wherein the shield is provided to at least one of the brew cover and the holder.

85. The apparatus of claim 84, wherein the shield is adapted move to the second position when the brew cover and holder are moved towards each other to a closed position in which the pod pushes the shield plate and compresses the shield spring to cause the at least part of the needle to pass through the shield plate to pierce at least one of the lid and bottom of the pod; wherein the shield is adapted to return to the first position when brew cover and holder are moved away from each other to an open position in which the shield spring to push the shield plate away from the base to cover the needle.

86. The apparatus of claim 83, wherein the shield further comprises a sealer connected to the shield plate, the sealer being adapted to seal to an object to be pierced by the needle.

87. The apparatus of claim 83, further comprising a locker for the shield plate, the locker having a latch to lock the shield plate in position and a trigger to release the latch to allow the shield plate to move from the first to second position.

88. The apparatus of claim 83, wherein at least part of the shield plate is sufficiently sticky or adhesive to an object to be pierced by the needle to prevent movement of the shield plate on the surface of the object, thereby preventing the needle from being broken into the object due to movement of the object.

89. The apparatus of claim 83, further comprising a pump adapted to connect to the needle, the pump having a chamber for receiving and storing a supply of fluid and a piston for delivering at least a portion of the supply of fluid in the chamber into an object.

90. The apparatus of claim 83, wherein the shield further comprises a finger stopper adapted to allow the needle to pass through but prevent a child's finger from passing through.

91. The apparatus of claim 90, wherein the finger stopper includes an expandable opening, the expandable opening being sufficiently smaller than the needle to render the needle free of materials from an object to be pierced by the sharp cutter.

92. The apparatus of claim 83, wherein the shield plate comprises a self-healable plate adapted to be pierced by the sharp cutter to form a pierced opening, the self-healable plate being constructed and configured to cooperate with the needle to substantially close the pierced opening when the needle is removed from the shield plate.

93. A method for using the apparatus of claim 83, said method comprising providing a needle having a shield to an object to be pierced by the needle; contacting the object with a shield plate of the shield to seal the shield plate to the object to limit the movement of the shield plate relative to the object; and pushing the shield plate against the object to compress a shield spring and cause the needle to pass through the shield plate to pierce the object.

94. A pod for use in forming a brew, said pod comprising: a container having an interior space for receiving a supply of brew material, a rim, a bottom, a sidewall connected to the rim and bottom, and an access opening surrounded by the rim; a lid for closing the access opening and sealing the pod; an outlet opening formed on at least one of the lid and the bottom of the container, the outlet opening being sufficiently large to prevent clogging by the brew material; and a regulator plate for regulating the interaction between the brew material and a fluid, the regulator plate being constructed and arranged to cooperate with the outlet opening, the lid, and the bottom and sidewall of the container to form a brew chamber for storing the supply of brew material, the regulator plate being movable relative to the outlet opening between a first position in which the brew chamber is formed and a second position in which a transient chamber is formed; wherein at least one of the lid and bottom is adapted to receive an injection of fluid into the container for interaction with the brew material to form a brew; and wherein the transient chamber cooperates with the outlet opening to regulate the interaction between the brew material and the injection of fluid into the container and to regulate the flow of the brew material and the brew through the outlet opening.

95. The pod of claim 94, further comprising a supply of insoluble brew material preserved in the brew chamber and adapted to be discharged through the outlet opening to form a soup, the brew material including at least one of clam chowder, chicken dices, noodle, ground meat, vegetable, grains, seafood, and seaweed.

96. The pod of claim 94, further comprising a supply of insoluble brew material stored in the brew chamber and adapted to be discharged through the outlet opening to form a meal, the brew material including at least one of cereal, oatmeal, grains, and baby formula.

97. The pod of claim 94, further comprising a supply of insoluble brew material preserved in the brew chamber and adapted to be discharged through the outlet opening to form a healthy drink, the brew material including at least one of ground vegetable, ground fruit, gel beans, matcha, proteins, powders, Turkish coffee and frappes.

98. The pod of claim 94, wherein the supply of brew material comprises gel beads in which at least one nutrient having undesirable taste is imbedded, the gel beads being stored in the brew chamber and sized to be discharged through the outlet opening to form a beverage having the at least one nutrient but without the undesirable taste of the at least one nutrient.

99. The pod of claim 98, wherein the gel beads are sufficiently small to prevent the chewing of the gel beads, thereby further minimizing the undesirable taste of the at least one nutrient.

100. The pod of claim 94, further comprising a film and a seal between the film and at least one of the bottom, lid, sidewall and regulator plate, the film being constructed and arranged to cooperate with the regulator plate to prevent air from passing through the outlet opening into the brew chamber when the regulator plate is in the first position and to allow the seal to break to form the transient chamber when the regulator plate is moved to the second position.

101. The pod of claim 94, further comprising a film sealed to at least one of the bottom and sidewall of the container, wherein the regulator plate is permanently attached to the film, wherein the outlet opening is larger than the regulator plate, and wherein the regulator plate is constructed and arranged to allow a protruded body to move the regulator plate from the first position to the second position to form the transient chamber.

102. The pod of claim 94, wherein the regulator plate is received in the container and positioned above the bottom, wherein the bottom is adapted to be pierced by a needle, wherein the regulator plate is constructed and arranged to cooperate with the bottom to allow the needle that has pierced through the bottom to contact and move the regulator plate from the first position to the second position.

103. The pod of claim 94, wherein the regulator plate seals the outlet opening to form the closed brew chamber when the regulator plate is in the first position, wherein the regulator plate is adapted to be pushed away from the outlet opening to move from the first position to the second position to form the transient chamber.

104. The pod of claim 94, further comprising a seal between the regulator plate and one of the bottom and lid to seal the outlet opening when the regulator plate is in the first position, the seal being breakable to allow the regulator plate to move from the first position to the second position.

105. The pod of claim 94, wherein the regulator plate is substantially larger than the outlet opening, wherein the regulator plate is constructed and arranged to cooperate with the outlet opening to prevent premature discharging of the brew material in the brew chamber through the outlet opening prior to the injection of fluid into the container, thereby preventing mess and wasting of the brew material.

106. The pod of claim 94, further comprising a hygiene tube connected to the outlet opening to dispense the brew directly into a cup or bowl to prevent contamination of a brew by spoiled residual from previous brews.

107. The pod of claim 94, further comprising a pouch that encloses a supply of complementary brew material and is connected to at least one of the lid, rim and sidewall, the pouch being sufficiently thin to cause a needle to pierce through both the pouch and lid to move the supplementary brew material into the brew chamber.

108. The pod of claim 94, further comprising a filter received in the container and a supply of an extractable brew material enclosed between the lid and filter, the filter having a filter bottom and a filter sidewall sealed to at least one of the rim and sidewall of the container, the filter sidewall being sufficiently tall to prevent a needle that pierces the lid for the injection of fluid into the container from piercing the filter bottom.

109. The pod of claim 94, wherein the regulator plate is constructed and arranged to cooperate with the lid and the bottom of the container so that a needle pierces one of the lid and bottom to inject fluid into the container to interact with the brew material to form a brew and pushes the regulator plate away from the outlet opening to open the outlet opening to discharge both the brew material and the brew through the outlet opening.

110. A method of using the pod of claim 94 to brew a soup, healthy drink or meal, said method comprising: providing a pod comprising a supply of brew material in a brew chamber; moving a regulator plate away from one of the bottom and lid to produce a transient chamber and expose an outlet opening on the one of the bottom and lid; introducing fluid into the brew chamber; regulating the interaction of the fluid with the brew material in the brew chamber; regulating the flow of the brew material and the brew formed in the brew chamber into and through the transient chamber; discharging the brew material and brew via the outlet opening into a receptacle to form a soup, healthy drink or meal.

111. A stack for use in forming a brew, said stack comprising a plurality of pre-assembled empty pods that are stacked into one another to facilitate the filling of fresh brew material into a pre-assembled empty pod, said pre-assembled empty pod comprising: a container having a rim, a bottom, a sidewall connected to the rim and bottom, and an access opening surrounded by the rim for receiving brew material, the rim comprising first and second rim portions, the access opening being substantially larger than the bottom to receive another pre-assembled empty pod; a lid adapted to cover the access opening and form an airtight seal to the rim to produce a brew chamber to store a supply of brew material therein, the lid comprising first, second and third lid portions, wherein at least one of the lid and the bottom of the container is pierceable to receive an injection of fluid into the container for interaction with the brew material to form a brew; a flow controller for controlling the interaction of the brew material with the fluid; and a pod hinge connecting the lid to the container, the pod hinge being constructed and arranged to cooperate with the lid and the rim to prevent leakage between the lid and rim during the storage of the brew material and during the injection of the fluid into the brew chamber, the pod hinge comprising the first lid portion, the first rim portion and an elongated fold between the first and second lid portions, wherein the first rim portion is at least partially sealed to the first lid portion, wherein the angle between the first and second lid portions is smaller than 90 degrees.

112. The stack of claim 111, wherein the flow controller comprises an outlet opening and a regulator plate for regulating the interaction between the brew material and the fluid injected into the container, the regulator plate being constructed and arranged to cooperate with the outlet opening and the bottom, sidewall and lid to form the brew chamber, the regulator plate being movable relative to the outlet opening between a first position in which the brew chamber is formed and a second position in which the outlet opening is opened to discharge the brew formed in the container.

113. The stack of claim 112, wherein the outlet opening is formed on the bottom, the regulator plate being constructed and arranged to cooperate with the bottom and outlet opening to form a transient chamber in the second position to regulate the interaction between the fluid injected into the container and the brew material and to regulate the flow of the brew material through the outlet opening.

114. The stack of claim 111, wherein the first rim portion is sufficiently short so that the distance between a middle point of the elongated fold and the inner perimeter of the access opening at the radial direction is smaller than fifteen percent of the maximum span for the access opening.

115. The stack of claim 111, wherein the flow controller comprises a filter having a filter bottom and a filter sidewall attached to the container and constructed to receive at least part of another pre-assembled empty pod, the filter sidewall comprising multiple elongated primary pleats, each said primary pleat comprising first and second primary pleat walls, wherein one of the first and second primary pleat wall is further pleated into first and second tandem pleat walls to form an elongated tandem pleat.

116. The stack of claim 115, wherein the tandem pleat is formed by inserting the another pre-assembled empty pod into the filter through the access opening, the another pre-assembled empty pod remaining in the filter for at least three days to prevent the tandem pleat from de-pleating before a pre-assembled empty pod is removed from the stack for filling with a supply of brew material.

117. The stack of claim 111, wherein the elongated fold is formed between first and second ends of a seal between the first lid portion and the first rim portion, at least one of the first and second ends of the seal being substantially narrower than the width of the rim to facilitate formation of a leak-proof seal between the second rim portion and the second and third lid portions.

118. The stack of claim 111, wherein the elongated fold is so constructed that there is a sufficiently rounded transition between the first and second lid portions to facilitate formation of a leak-proof seal between the second rim portion and the second and third lid portions.

119. The stack of claim 111, wherein the angle between the first and third lid portions is substantially larger than the angle between the first and second lid portions to cause the third lid portions to contact or partially wrap the containers in the stack.

120. The stack of claim 111, wherein the container, filter and lid are all made from recyclable polypropylene, wherein the lid further comprises a layer of sealant for sealing to the first and second rim portions, the sealant being one of a recyclable polypropylene copolymer and low-softening temperature polypropylene having a softening temperature at least 20 degrees Fahrenheit lower than the rest of the lid.

121. The method of using the stack of claim 111 to produce a pod, said method comprising removing a pre-assembled empty pod from the stack; filling a predetermined amount of fresh brew material into the pod through the access opening; moving at least one of a closer and the pod filled with the fresh brew material to cause the closer to turn the second and third lid portions around the elongated fold of the pod hinge to cover the access opening; and sealing the lid to the rim.

122. A pod for use in forming a brew comprising: a container defining an interior space having first and second portions, the container including a bottom, a sidewall, a rim for the sidewall, and an access opening surrounded by the rim; a lid adapted to cover the access opening and form a brew chamber for storing a supply of brew material in the first portion of the interior space, the lid being adapted to receive an injection of fluid in at least one fluid stream into the brew chamber; a filter at least partially located in the interior space for controlling interaction between the brew material and fluid to form a brew, the filter separating the first and second portions of the interior space so that the brew formed in the first portion of the interior space must flow through the filter to pass to the second portion of the interior space; wherein the bottom of the container is pierceable by a needle to allow the needle to extend into the interior space; wherein the filter is positioned sufficiently close to the bottom of the container to make the second portion of the interior space sufficiently thin to allow the needle to directly contact the filter and deform at least part of the filter to form a transient chamber between a deformed part of the filter and the bottom; wherein the filter is constructed to prevent the needle from piercing the filter when the needle directly contacts and deforms the filter to form the transient chamber; and wherein the transient chamber is adapted to become significantly diminished in size to facilitate the interaction between the brew material and fluid as the fluid is injected in the at least one fluid stream into the brew chamber under pressure, thereby improving the strength and richness of the brew.

123. The pod of claim 122, wherein the filter is positioned sufficiently close to the bottom of the container that the at least one fluid stream can push the filter to contact the bottom of the container to prevent the at least one fluid stream from channeling through the filter into the second portion of the interior space.

124. The pod of claim 122, wherein the filter is made from a plastic filter web comprising filter fibers having sufficiently low coefficient of friction measured between the fiber and needle to allow the needle to slide along the filter when the needle contacts the filter, thereby facilitating the formation of the transient chamber.

125. The pod of claim 122, wherein the filter has a filter bottom and a filter sidewall comprising multiple pleats, each of the multiple pleats comprising first and second pleat walls, one of the first and second pleat walls being further pleated into first and second tandem pleat walls to form a tandem pleat to prevent the brew material in the brew chamber from leaking into the transient chamber when the transient chamber is diminished in size to facilitate the interaction between the fluid and brew material.

126. The pod of claim 122, wherein the filter comprises fibers that are sufficiently loosely bound to each other so that the binding force between fibers is sufficiently low to allow at least one of the fibers to be partially pushed or pulled out of the filter by the needle before the at least one of the fibers is broken, thereby preventing the brew material in the brew chamber from leaking into the transient chamber when the transient chamber is diminished in size to facilitate the interaction between the fluid and brew material.

127. The pod of claim 122, wherein the filter is capable of stretching at least 50 percent before the filter is broken at a brewing temperature for the pod to prevent the brew material in the brew chamber from leaking into the transient chamber when the transient chamber is diminished in size to facilitate the interaction between the brew material and fluid.

128. The pod of claim 122, wherein the filter is made from one of the melt-blown and spunbond polypropylene nonwoven webs to prevent the brew material in the brew chamber from leaking into the transient chamber when the transient chamber is diminished in size to facilitate the interaction between the fluid and brew material.

129. The pod of claim 122, wherein the filter is a composite filter comprising coarse and fine fibers to prevent the brew material in the brew chamber from leaking into the transient chamber when the transient chamber is diminished in size to facilitate the interaction between the fluid and brew material.

131. The pod of claim 122, further comprising a filter mate located on the top of the filter to prevent the brew material in the brew chamber from leaking into the transient chamber when the transient chamber is diminished in size to facilitate the interaction between the fluid and brew material.

132. The pod of claim 131, wherein the filter mate comprises a sheet of permeable or impermeable material positioned directly on a bottom of the filter and sized to substantially cover the bottom of the filter.

133. The method of using a pod of the claim 122 to form a brew, said method comprising providing a holder having a needle; providing a pod into the holder, the pod comprising a lid, a filter, and a supply of brew material enclosed in a brew chamber between the lid and filter; directly contacting the filter to the needle so that the needle directly pushes the filter to deform at least part of the filter; producing a transient chamber between a deformed part of the filter and a bottom of the holder and pod; and diminishing or shrinking the transient chamber significantly in size to facilitate the interaction between the brew material and fluid as the fluid is injected in at least one fluid stream into the brew chamber under pressure.

134. A pod for use in forming a brew, said pod comprising: a first container having a rim, a first bottom, a first sidewall connected to the rim and first bottom, and an access opening surrounded by the rim; a second container at least partially located in the first container, the second container having a second bottom above the first bottom of the first container to form a first chamber between the first and second bottoms; a filter at least partially located in the second container and sealed to at least one of the first and second containers to form a second chamber between the second bottom and the filter; a lid sealed to at least one of the first and second containers to form a third chamber between the filter and the lid for storing a first supply of brew material, the lid being adapted to receive an injection of fluid into the third chamber for interaction with the brew material therein to form a brew; at least one foaming orifice formed on the second bottom for producing a foamed brew in the first chamber; wherein the filter separates second and third chambers so that the brew formed in the third chamber must flow through the filter to pass to the second chamber; wherein the first container is sealed to the second container so that the brew in the second chamber must flow through the at least one foaming orifice to pass to the first chamber unless the at least one foaming orifice is clogged; wherein the at least one foaming orifice is sufficiently small to emulsify and produce fine foam for the brew formed in the third chamber as the brew passes through the filter and the at least one foaming orifice into the first chamber.

135. The pod of claim 134, wherein the first bottom is pierceable to form an outlet for discharging the fine foam and brew in the first chamber into a receptacle.

136. The pod of claim 134, further comprising at least one standby orifice sufficiently small to emulsify and produce fine foam for the brew formed in the third chamber as the brew passes through the filter and the standby orifice into the first chamber, wherein the at least one standby orifice is normally closed when the at least one foaming orifice is open and becomes open only when the at least one foaming orifice is clogged.

137. The pod of claim 134, further comprising a second supply of brew material stored in the first chamber, the second supply of brew material being different from the first supply of brew material in the third chamber.

138. The pod of claim 134, wherein the second bottom is sufficiently flexible to cause the second chamber to expand to facilitate the interaction between the first supply of brew material and the injection of fluid received through the lid into the third chamber.

139. A pod for use in forming a brew, said pod comprising: a container having a rim, an impermeable bottom, an impermeable sidewall connected to the rim and impermeable bottom, and an access opening surrounded by the rim for receiving brew material; an impermeable lid that closes the access opening and is removably sealed to the rim, the lid cooperating with the impermeable bottom and sidewall of the container to produce a brew chamber to preserve a supply of brew material; a pressure releaser for preventing damage and explosion of the pod during the use of the pod, the pressure releaser being constructed to cooperate with the impermeable lid, sidewall and bottom to prevent air, moisture and/or bacteria from entering the brew chamber, thereby preventing spoilage of the supply of brew material therein; wherein the pod is at least partially receivable in a holder to cause the supply of brew material to be cooked in the holder; wherein the impermeable lid comprises a tab or handle to facilitate the removal of the impermeable lid from the rim after completion of cooking; wherein the pressure releaser is constructed and configured to release hot fluid in the container held in the holder when the supply of brew material is cooked, thereby preventing pressure from building up in the brew chamber during cooking and preventing injury by hot fluid or pressure during removal of the impermeable lid; and wherein the container is constructed and configured to cooperate with the brew material to serve the brew material in a cooked form directly on the container after the impermeable lid is removed from the container via the tab or handle.

140. The pod of claim 139, wherein the impermeable sidewall is sufficiently short to allow a needle in a brew cover for the holder to pierce the impermeable lid and penetrate sufficiently deeply into the supply of brew material to deliver a hot fluid under pressure into an interior of the supply of brew material, the brew material including at least one of meat, sandwich, pizza, bread, spaghetti, soup, oatmeal, beans, grains and vegetable, the hot fluid under pressure diffusing or flowing from the interior outwards to heat and cook the brew material from the inside to the outside, thereby achieving inside-out cooking to save energy.

141. The pod of claim 140, wherein the brew chamber is constructed and configured to cooperate with the holder and brew cover to be at least partially enclosed by the holder and brew cover to provide at least a partial heat insulation enclosure for the pod, the at least partial heat insulation enclosure cooperating with the inside-out cooking to minimize energy loss and make the cooking in the pod energy efficient.

142. The pod of claim 139, further comprising a brew optimizer to determine a delivery location in the interior of the supply of brew material for a hot fluid, the hot fluid including at least one of hot steam, hot air and hot water, the brew optimizer being constructed and configured to cooperate with at least one of the impermeable lid and the impermeable bottom to accommodate an injection of the hot fluid under pressure to the delivery location, the hot fluid diffusing or flowing under pressure from the delivery location outwards to heat and cook the supply of brew material from the inside to the outside, thereby saving energy and cooking time.

143. The pod of claim 142, wherein the brew optimizer comprises a protrusion formed on the impermeable bottom of the container, the protrusion being constructed and arranged to contact a tip of a needle adapted to provide the injection of the hot fluid under pressure to the delivery location.

144. The pod of claim 142, wherein the brew material comprises at least one elongated channel or cut, the at least one elongated channel or cut being constructed and positioned to be in fluid communication with the delivery location to facilitate the diffusing or flowing of the hot fluid within the brew material.

145. The pod of claim 139, wherein at least one of the impermeable lid and container is constructed and configured to prevent the at least one of the impermeable lid and container from being melt or damaged by an energy emitter, the at least one of the impermeable lid and container being constructed and configured to cooperate with the energy emitter to toast or roast an outer surface of the supply of brew material to cook the supply of brew material from the outside to the inside to produce a desirable aroma, crispness or color.

146. The pod of claim 145, wherein the at least one of the impermeable lid and container is substantially spectrally transparent to infrared light that has wavelength shorter than 3,300 nanometers.

147. The pod of claim 145, wherein at least one of the impermeable lid and container is pierceable to accommodate an injection of hot fluid under pressure sufficiently deeply into an interior of the supply of brew material, wherein the hot fluid under pressure diffuses or flows from the interior outwards to heat and cook the supply of brew material from the inside to the outside, thereby saving energy and cooking time.

148. The pod of claim 147, wherein the supply of brew material is formulated and configured to cooperate with the at least one of the impermeable lid and container to allow the supply of brew material to be cooked from the inside to the outside and from the outside to the inside substantially simultaneously.

149. The pod of claim 139, wherein the pressure releaser comprises at least one channel or ridge formed on the outer surface for at least one of the impermeable lid and impermeable bottom, wherein the at least one of the impermeable lid and impermeable bottom is pierceable by a needle to form a pierced opening, the at least one channel or ridge being positioned sufficiently close to the pierced opening to form a hot fluid passageway to release hot fluid or pressure in the brew chamber.

150. The pod of claim 139, wherein the pressure releaser comprises a weak seal constructed and configured to unseal or open to form a vent to release hot fluid in the brew chamber when the pressure in the brew chamber reaches above a predetermined value.

151. The pod of claim 139, wherein the pressure releaser comprises a vent opening and a sealer adapted to form a weak seal to seal the vent opening, the weak seal being constructed and configured to prevent air outside from entering the brew chamber and to unseal or break to allow hot fluid in the brew chamber to flow out via the vent opening when a pressure develops in the brew chamber.

152. The pod of claim 139, wherein at least one of the impermeable lid and the container is pierceable by a needle to form a pierced opening, wherein the pressure releaser comprises the pierced opening on the at least one of the impermeable lid and impermeable bottom.

153. The pod of claim 139, further comprising a pouch that encloses a supply of complementary brew material, the pouch being connected to at least one of the rim, impermeable sidewall and lid, the pouch being sufficiently thin and constructed to cooperate with the impermeable lid to allow a needle to pierce through both the pouch and lid to move the supplementary brew material from the pouch into the brew chamber.

154. The method of forming a brew using the pod of claim 139, said method comprising piercing one of the impermeable lid and container by a needle having a needle outlet and a cutter spaced apart and positioned a predetermined distance from the needle outlet, inserting the needle sufficiently deep into a supply of brew material in the container, moving the brew material by the cutter to prevent the brew material from being pushed into the needle outlet.

155. The method of cooking a meal using the pod of claim 139, said method comprising providing a pod into a holder; piercing one of the impermeable lid and container with a needle, controlling a pump to provide a fluid; controlling a heater to condition a fluid to a predetermined state and temperature, the predetermined state including a hot steam state and a hot water state; delivering a predetermined amount of hot fluid at the predetermined state and temperature into the supply of brew material preserved in the brew chamber; removing the pod from the holder; removing the impermeable lid from the rim of the container via a tab or handle; serving the brew material, which is now cooked by the hot fluid, directly on the container.

156. The method of cooking a meal using the pod of claim 139, said method comprising providing a pod into a holder; brewing or cooking a supply of brew material in the pod held by the holder; providing a supply of air through a space between a sidewall of the holder and the impermeable sidewall of the pod held in the holder to cool the pod for safe removal and comfortable touch of the pod from the holder.

157. A method for using a pod to form a brew, said pod comprising a lid and a container defining an interior space, the container having a rim, a bottom, a sidewall connected to the rim and bottom, and an access opening surrounded by the rim, the lid being adapted to cover the access opening and form a closed brew chamber for storing a supply of brew material in the interior space, said method comprising: providing a pod into a holder so that at least part of the container is received and held by the holder; forming a liquid inlet for one of the lid and container; forming at least one opening for one of the lid and container; delivering a first amount of a first fluid through the liquid inlet into the brew chamber to interact with the brew material therein to form a brew; delivering a second amount of a second fluid into the interior space through the at least one opening, the second fluid being different from the first fluid; and discharging the brew formed in the brew chamber and the second fluid through the at least one opening into a receptacle below the holder.

158. The method of claim 157, wherein the pod further comprises an outlet opening on one of the lid and container and a regulator plate that seals the outlet opening, wherein the step of forming at least one opening comprises forming a first opening by piercing the one of the lid and container for the step of delivering a second amount of a second fluid and forming a second opening by moving the regulator plate away from the outlet opening to open the outlet opening for the step of discharging the brew.

159. The method of claim 157, further comprising mixing the second amount of the second fluid with the brew inside the interior space of the pod.

160. The method of claim 157, wherein the step of delivering a second amount of a second fluid comprises converting the second fluid into a fluid jet at sufficiently high speed and injecting the fluid jet into the interior space to emulsify the second fluid to producing a foamy layer or head for a brew received in the receptacle.

161. The method of claim 157, wherein the pod further comprises a filter at least partially located in the interior space to separate the interior space into first and second portions, wherein the steps of delivering a first amount of a first fluid comprises controlling interaction between the brew material and first fluid via the filter to form a brew and delivering the brew formed in the first portion of the interior space through the filter to the second portion of the interior space.

162. A reusable pod for one to use one's own freshly prepared brew material to form a brew, said reusable pod comprising: a container having an impermeable bottom, an impermeable sidewall connected to the bottom, a rim for the impermeable sidewall, and an access opening surrounded by the rim for receiving the freshly prepared brew material; an impermeable lid that closes the access opening and is removably sealed to the rim to allow one to open the lid and refill the container with freshly prepared brew material, the impermeable lid being constructed and configured to cooperate with the container to form an impermeable brew chamber to store and preserve a supply of one's own freshly prepared brew material and to prevent air and bacteria from entering the impermeable brew chamber, thereby preserving the freshness of the brew material therein for later use to form a brew; wherein at least one of the impermeable lid and impermeable bottom is pierceable to form a pierced opening to allow fluid to pass through; wherein the impermeable brew chamber is at least partially receivable in a holder to facilitate the piercing of at least one of the impermeable lid and impermeable bottom and to at least partially insulate the pod to facilitate the brewing or cooking of the freshly prepared brew material therein; wherein at least one of the impermeable lid and impermeable bottom comprises a piece of self-healable film constructed and configured to be pierced to form the pierced opening, the self-healable film being constructed and configured to self-heal and close the pierced opening after removal of the pod from the holder, thereby allowing formation of an impermeable brew chamber to store and preserve another supply of freshly prepared brew material for later use to form another brew.

163. The reusable pod of claim 162, wherein the impermeable lid comprises the piece of self-healable film adapted to be pierced by a needle to introduce an injection of hot pressurized fluid into the brew chamber to interact with the freshly prepared brew material to form a brew.

164. The reusable pod of claim 163, further comprising a brew optimizer to determine a delivery location in the interior of the supply of one's own freshly prepared brew material to which the injection of the hot pressurized fluid is delivered, wherein the pressurized hot fluid flows or diffuses from the delivery location outwards to heat and cook the supply of one's own freshly prepared brew material from the inside to the outside.

165. The reusable pod of claim 162, wherein at least one of the impermeable lid and impermeable bottom is constructed and configured to cause an outer surface of the supply of one's freshly prepared brew material to be toasted, baked or roasted directly in the pod held in the holder by an energy emitter, thereby causing the supply of one's freshly prepared brew material to be cooked from the outside to the inside, and to prevent damaging or melting by an energy emitter.

166. The reusable pod of claim 162, further comprising a filter sealed to the container to form the brew chamber between the filter and the impermeable lid for filtering the supply of one's own freshly prepared brew material.

167. The reusable pod of claim 162, further comprising an outlet opening on at least one of the impermeable lid and impermeable bottom and a regulator plate operative between a first position in which it seals the outlet opening and a second position in which it opens the outlet opening.

168. A pod for use in forming a brew, said pod comprising: a containing chamber having a rim, a bottom, and a sidewall connected to the rim and bottom, an access opening surrounded by the rim; a lid that closes the access opening to form a brew chamber to store a supply of brew material for use in forming a brew, the brew chamber being at least partially receivable in a holder of a brew preparation machine and being at least partially enclosable by a brew cover of the machine and the holder to facilitate the brewing or cooking of the brew material in the brew chamber; and a bit group for determining a first set of brewing or cooking conditions for forming a cold or hot brew from the supply of brew material in the brew chamber, the bit group comprising a plurality of bits, each of the plurality of bits comprising an object formed at a predetermined place on at least one of the containing chamber and lid, the object being in one of a plurality of states adapted to be read by an object reader in a bit group reader in at least one of the holder and brew cover of the machine, each of the plurality of states having a predetermined value, wherein the predetermined values and places of the objects on the at least one of the containing chamber and lid allow the bit group to inform and prepare the machine to provide the first set of brewing or cooking conditions for the supply of brew material in the brew chamber.

169. The pod of claim 168, wherein the bit group is for forming a hot coffee, the bit group being constructed and configured to cooperate with the bit group reader of the machine to allow a pod that does not contain any bit group to be accepted by the machine to form hot coffee.

170. The pod of claim 169, wherein the bit group for forming hot coffee comprises only objects that are adapted to not activate the object readers in the bit group reader.

171. The pod of claim 168, wherein the pod is for use in forming a cold brew, wherein the bit group comprises a cold brew bit for preventing misuse of the pod to form a hot brew in the machine, the cold brew bit being adapted to activate at least one of a path valve and a cold water switch in the holder or brew cover to prevent hot water from being delivered to the brew chamber.

172. The pod of claim 168, wherein the object reader in the bit group reader is a switch, wherein the object in at least one of the plurality of states is adapted to turn on the switch.

173. The pod of claim 172, wherein the object comprises at least one of a protrusion, a recess and an opening adapted to turn on or off the switch.

174. The pod of claim 168, wherein at least one of the objects in the bit group is adapted to activate one of the object readers in the bit group reader.

175. The pod of claim 168, wherein each of the objects formed on the at least one of the containing chamber and lid is designated to a predetermined object reader in the bit group reader.

176. The pod of claim 175, further comprising a bit surface in a predetermined spatial relationship with the bit group to cause each of the objects to find its designated predetermined object reader in the bit group reader when the brew chamber is received in the holder.

177. The pod of claim 168, wherein the predetermined value is one of binary numbers of 0 and 1 to make the bit group inherently compatible with a digital controller or processor in the brew preparation machine, thereby making the machine readily affordable for consumers.

178. The pod of claim 168, wherein the bit group is constructed and configured to cooperate with a user interface of the machine to determine a second set of brewing or cooking conditions for the cold or hot brew.

179. The pod of claim 178, wherein the cold or hot brew includes at least one of espresso, cold brew espresso, hot coffee, cold brew coffee, carbonated drink, juice, tea, herb medicine, alcoholic drink, super food, soup, hot oatmeal breakfast, cold cereal breakfast, bread, spaghetti meal, grain meal, meat meal, vegetable meal, pizza, and sandwich, wherein the second set of brewing or cooking conditions is for forming a complimentary brew includes at least one of milk, creamer, flavoring syrup, whipped cream, spices, sauces, sugar, and chocolate for the cold or hot brew.

180. The pod of claim 168, wherein the bit group is adapted to allow the first set of brewing or cooking conditions to be added via Internet into a controller or processor of a brew preparation machine that is already installed in a home and commercial location, thereby allowing a pod that is developed after the machine is installed and that contains the bit group to be brewed or cooked by the machine.

181. The pod of claim 168, wherein the bit group is adapted to allow the first set of cooking or brewing conditions to be changeable via a user interface or Internet, thereby allowing a consumer to change the first set of brewing or cooking conditions to suit one's personal taste or seasonality.

182. The method of using a pod of claim 168, said method comprising providing a pod having a bit group comprising a plurality of bits, activating at least one of a plurality of switches in a switch group in the holder or brew cover of a brew preparation machine, and determining a first set of brewing or cooking conditions for the pod based on the place or position of the at least one of a plurality of switches activated in the switch group.

183. The method of using a pod of claim 168, said method further comprising determining a first set of brewing or cooking conditions for the pod based on the bit group on the pod and changing at least one brewing or cooking condition in the first set of brewing or cooking conditions.
